(19) United States
(12) Patent Application Publication
(10) Pub. No.: US 2026/0080422 A1
(43) Pub. Date: Mar. 19, 2026

(54) DEMAND FORECASTING SYSTEM

(71) Applicant: Target Brands, Inc., Minneapolis, MN (US)

(72) Inventors: RAJESH REDDY KUNDUR, Minneapolis, MN (US); ASHWIN KRISHNAN, Minneapolis, MN (US); BLAKE ROBINSON, Minneapolis, MN (US); SAIBAL BHATTACHARYA, San Mateo, CA (US); ADAM MORGAN, Berkeley, CA (US); AKSHITA RAINA, San Francisco, CA (US); ALEXANDRE SANTORO, Mountain View, CA (US); SUBRAMANIAN IYER, Sunnyvale, CA (US); PETER KIM, Minneapolis, MN (US); SAAD AHMED, Washington, DC (US); CHRIS GILLIS, Minneapolis, MN (US); MARIO ESCOBEDO, San Diego, CA (US); ADAM RIGGALL, Minneapolis, MN (US)

(21) Appl. No.: 19/172,383

(22) Filed: Apr. 7, 2025

Related U.S. Application Data
(60) Provisional application No. 63/696,417, filed on Sep. 19, 2024.

(51) Int. Cl. G06Q 30/0202; G06Q 30/0201; G06Q 30/0601

(52) U.S. Cl. CPC G06Q 30/0202; G06Q 30/0206; G06Q 30/0603

(57) ABSTRACT

Aspects of the present disclosure relate to a demand forecasting system. The demand forecasting system may include components for developing forecasting models, generating demand forecasts, and handling outputs of demand forecasting models. In some embodiments, the demand forecasting system may include a model training system and one or more components that can be used by the model training system to improve model performance.

### CROSS-REFERENCE TO RELATED APPLICATIONS

The present application claims priority from U.S. Provisional Patent Application No. 63/696,427, filed on Sep. 19, 2024, the disclosure of which is hereby incorporated by reference in its entirety.

### BACKGROUND

Computer models that forecast item demand may face various challenges. For example, there may be a scarce amount of data available for an item for which demand is to be forecasted. As another example, even when available, some training data may be flawed and therefore its use when training a model may not be useful for training forecasting models. As another example, a model or a parameter of a model may be useful when forecasting demand for a first item but not for a second item, and it may be challenging to identify an appropriate model or model parameter for a given item. As another example, it may be challenging to forecast item demand for an enterprise with hundreds or thousands of items, and this challenge may be exacerbated when an item catalog changes. As another example, it may be challenging to forecast item demand across different channels.

### SUMMARY

Aspects of the present disclosure relate to a demand forecasting system. The demand forecasting system may include components for developing forecasting models, generating demand forecasts, and handling outputs of demand forecasting models. In some embodiments, the demand forecasting system may include a model training system and one or more components that can be used by the model training system to improve model performance.

### BRIEF DESCRIPTION OF THE DRAWINGS

FIG. 1 illustrates an example network environment in which aspects of the present disclosure may be implemented.

FIG. 2 illustrates a block diagram of an example architecture of the forecasting system.

FIG. 3 illustrates a schematic representation of aspects of a forecasting model.

FIG. 4 illustrates a schematic diagram of a disaggregation of a demand forecast for an item.

FIG. 5 illustrates a schematic diagram of components that may be used in connection with one or more of the generation or use of synthetic data.

FIG. 6 is a flowchart of an example method according to aspects of the present disclosure.

FIG. 7 is a flowchart of an example method according to aspects of the present disclosure.

FIG. 8 illustrates a block diagram of an example architecture of a feature management system.

FIG. 9 is a flowchart of an example method according to aspects of the present disclosure.

FIG. 10 illustrates a schematic diagram of determining holidays for an example item.

FIG. 11 illustrates a schematic diagram of an example representation of an example technique for identifying feature importance.

FIG. 12 illustrates an example diagram depicting holiday feature importance.

FIG. 13 illustrates an example architecture of the hyperparameter tuning system.

FIG. 14 is a flowchart of an example method according to aspects of the present disclosure.

FIG. 15A illustrates an example table depicting example hyperparameter combinations.

FIG. 15B illustrates an example tree diagram for selecting hyperparameter values.

FIG. 16 illustrates an example architecture of the promotion system.

FIG. 17 is a flowchart of an example method according to aspects of the present disclosure.

FIG. 18 illustrates an example architecture of a similar item data pooling system.

FIG. 19 is a flowchart of an example method according to aspects of the present disclosure.

FIG. 20 illustrate an example architecture that includes a forecasting application programming interface.

FIG. 21 illustrates example aspects of a demand transfer engine.

FIG. 22 illustrates an example graph depicting items and substitutability scores.

FIG. 23 illustrates an example architecture of an artificial intelligence system.

FIG. 24 illustrates an example user interface.

FIG. 25 illustrates a block diagram of an example computing environment.

FIG. 26 illustrates an example user interface according to aspects of the present disclosure.

FIG. 27 illustrates an example user interface according to aspects of the present disclosure.

FIG. 28 illustrates an example user interface according to aspects of the present disclosure.

FIG. 29 illustrates an example user interface according to aspects of the present disclosure.

FIG. 30 illustrates an example network environment in which an inference delivery platform may be implemented.

FIG. 31 is a flowchart of an example method according to aspects of the present disclosure.

FIG. 32 illustrates a schematic diagram of a deployed forecasting model.

FIG. 33 is a flowchart of an example method according to aspects of the present disclosure.

FIG. 34 illustrates example data of an example request and response.

FIG. 35 illustrates an example user interface according to aspects of the present disclosure.

### DETAILED DESCRIPTION

Aspects of the present disclosure relate to a system for forecasting demand, such as item demand over time. In some instances, demand over time is a complex stochastic process dependent on many variables, some of which may be unknown or unknowable. Given this complex stochastic nature of forecasting demand, computer models may be useful. Because computer systems can process, store, and exchange data in ways that go far beyond what humans can perform, computer models may forecast demand using methods that are distinct from any related human methods for forecasting data. That is, modeling complex stochastic processes, such as demand over time, is an endeavor that goes to the core of computer technology. Furthermore, as a result of computers' unique processing capabilities, computer models may ultimately derive much more accurate demand forecasts at much faster speeds than other techniques for forecasting demand. Thus, a demand forecasting system may use computer models; however, the effectiveness of such a forecasting system may depend on various factor, such as the quantity and quality of training data, the features used by the forecasting system, hyperparameters of the forecasting system, responsiveness to user inputs, or other factors.

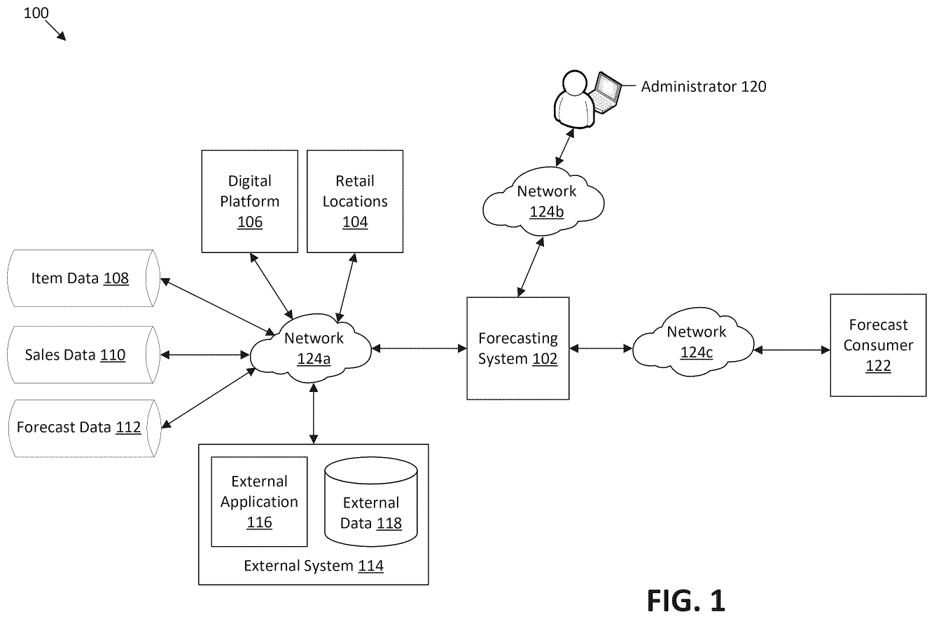

In example aspects, the forecasting system disclosed herein may forecast demand for a plurality of items. For an example item, the forecasting system may forecast the demand for the example item at each of a plurality of locations (e.g., a plurality of individual stores or regions), may forecast the demand for the example item generally (e.g., across all locations), or may forecast demand for the example item across different fulfillment channels (e.g., a digital fulfillment process, a customer pickup fulfillment process, or an in-store fulfillment process). To do so, the forecasting system may apply one or more models that are trained on historical demand data associated with the example item, which may include historical sales for the example item. Accounting for this historical demand data and other considerations, the models may output a demand forecast. Example aspects of the forecasting system are illustrated in connection with FIG. 1.

FIG. 1 illustrates an example network environment 100 in which aspects of the present disclosure may be implemented. In the example shown, the environment 100 includes a forecasting system 102, retail locations 104, a digital platform 106, item data 108, sales data 110, forecast data 112, an external system 114, an administrator 120, a forecast consumer 122, and networks 124a-c. In some embodiments, one or more of the components illustrated in FIG. 1 may be associated with a common entity. For example, one or more of the components illustrated in FIG. 1 may be part of an information system of an organization or may be communicatively coupled with aspects of an information system of an entity. In some embodiments, the entity is a retailer. In some embodiments, the entity may be a manufacturer, logistics organization, software organization, or other type of entity.

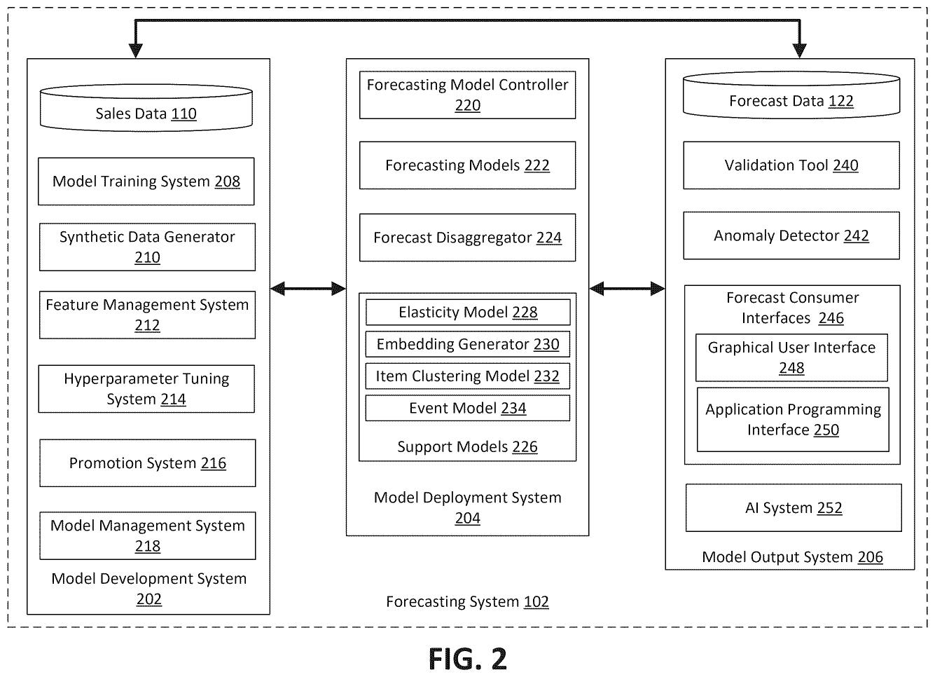

The forecasting system 102 may be a collection of hardware and software configured to forecast demand. In some embodiments, the forecasting system 102 may use computer models to generate demand forecasts for items. In examples, the items are offered for sale by a retailer. In some embodiments, aspects of the forecasting system 102 may be distributed across different computing environments. In some embodiments, the forecasting system 102 may receive data from one or more of the components 104-118, may receive a configuration from the administrator 120 or the forecast consumer 122, and may output demand forecast to the forecast consumer 122. In some embodiments, communications between the forecasting system 102 and other components of FIG. 1 may occur in real time in response to, for example, updates to data of the databases 108-112, inputs from a forecast consumer 122 or the administrator 120, or a timed workflow that triggers data exchanges among components of FIG. 1. An example architecture of the forecasting system 102 is illustrated and described in connection with FIG. 2.

The forecasting system 102 may be used to generate different types of demand forecasts at the item level, class level, or entire retail chain level, and for overall demand, digital demand (e.g., purchases via website or mobile application), or in the store demand. An example of such a modeling approach is described in U.S. Pat. No. 11,373,199, entitled “Method and System for Generating Ensemble Demand Forecasts”, the disclosure of which is hereby incorporated by reference in its entirety. In further examples, the demand forecasting model may be a chain-level model that forecasts overall demand for an item based on item attributes. Such a modeling approach is described in U.S. Pat. No. 11,182,808, entitled “Method and System for Attributes Based Forecasting”, the disclosure of which is hereby incorporated by reference in its entirety.

The retail locations 104 may be one or more physical locations associated with a retailer. In some embodiments, the forecasting system 102 may generate demand forecast for a location or group of locations of the retail locations 104. In some instances, a customer may purchase or pickup an item from a retail location of the retail locations 104, which may be registered as demand for that item from that retail location at the time that the customer purchased or picked up the item. In some instances, an item may be shipped from a retail location of the retail locations 104, which may be registered as demand for that item at the time of purchase or shipment, and may or may not be registered as demand at that location. The retail locations 104 may include stores, warehouses, sortation centers, manufacturing facilities, shipping hubs, offices, or other locations that may be used by an entity associated with components of FIG. 1. When a retail location is a store, the retail location may include distinct physical areas and equipment to facilitate fulfillment of orders according to different fulfillment channels, such as a first area and equipment for shipping items from the store and a second area and equipment for providing items to customers who shop in the store. The store may include equipment, such as cameras, video processing software and hardware, automated scanning devices, robotic processing equipment, and other hardware for registering demand (e.g., item movement, purchases, or shipment) at the store and automatically providing data for that demand to backend systems, such as, for example, the item data 108, sales data 110, or forecasting system 102. In some embodiments, the retail locations 104 may be divided into groups, such as groups based on geography or location type. In some embodiments, the retail locations 104 may include computing systems via which the retail locations 104 may transfer data to and from other components of FIG. 1.

The digital platform 106 may include computer systems that can receive or track demand for items. For example, the digital platform 106 may include one or components that facilitate the purchasing of items. In some embodiments, the digital platform 106 includes a website, such as website of a retailer or a website communicatively coupled with a digital retailer system. In some embodiments, the digital platform 106 may include a mobile application.

The item data 108 may include data related to items associated with a retailer. For example, the items may be sold by the retailer. In some embodiments, the item data 108 may include data for items for which forecasts are generated by the forecasting system 102. In some embodiments, for a given item, the item data may include one or more of the following: an item name; an item description; an item price; an item inventory; an item vendor; one or more item images; one or more item attributes; seasonal characteristics of the item; one or more locations associated with the item; one or more classifications of the item; an indication of whether the item is a new item; or other data associated with the item. In some embodiments, the forecasting system 102 may use data of the item data 108 to forecast item demand and to determine item similarities.

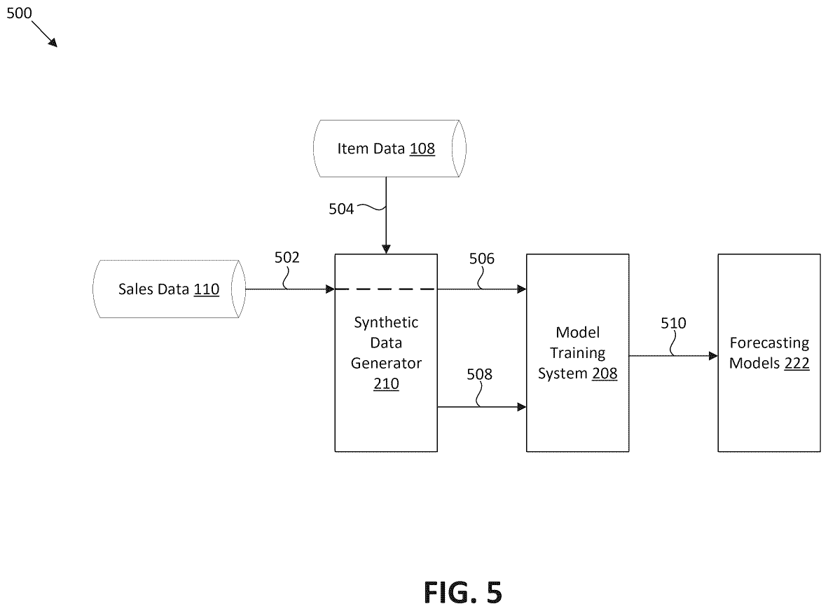

The sales data 110 may include historical sales data for items, such as items of the item data 108. In some embodiments, the historical sales data for an item may correspond with historical demand for the item. However, in some instances, sales data 110 may not always accurately reflect demand. For example, if an item is out of stock during a time period at a location or group of locations, then the sales for that item might be low due to its unavailability, not due to a lack of demand. As another example, the sales data 110, which may be captured by computing systems of store locations or of a digital retail platform, may incorrectly record sales in certain instances. For example, coding errors may improperly attribute sales of one item to another item, or may result in programs or integrations that fail to accurately capture, transfer, or store sales data. As a result, the sales data 110 may be incorrect. As another example, an item may be new or limited and therefore the corresponding sales data may be zero or artificially low. Additional scenarios that render the sales data 110 an imperfect technical representation of demand are likewise possible. As described further in connection with at least the synthetic data generator 210 and FIG. 5-7, aspects of the present disclosure may modify the sales data 110 using synthetically generated sales data to replace data that may be corrupted, incorrect, or otherwise unrepresentative of demand. In some embodiments, the sales data 110 includes separate data that represents actual sales and data that represents demand, which may include synthetically generated sales. In other embodiments, such data may be combined.

In some embodiments, the sales data 110 may include sales data for an item at a particular location or group of locations. In some embodiments, the sales data 110 is time series data. For example, the sales data 110 may include historical sales data for an item at a location over time, and the sales data 110 may also include historical sales data over time for the item across a supply chain. Different granularities of time are possible. For example, the sales data 110 may include sales per day, per week, per month, per quarter, per year, per a combination thereof, or per another time metric. In some embodiments, the sales data 110 may include sales data generated at the digital platform 106, which may include sales at a website. In some embodiments, the sales data 110 may include synthetic data that is derived at least in part from historical sales data. In some embodiments, the sales data 110 is continuously updated as sales are registered at one or more of the retail locations 104 or the digital platform 106. For example, the sales data 110 may be updated in real time. In some embodiments, sales data 110 is provided to the forecasting system 102, and the forecasting system 102 may use the sales data 110 to train a forecasting model. In some embodiments, the sales data 110 is converted into a standardized format. For instance, sales generated at one of the retail locations 104 may have a different format than sales generated at the digital platform 106, and these formats may be standardized in the sales data 110.

The forecast data 112 may include current and past forecasts for items, such as items of the item data 108. In some embodiments, the forecast data 112 is time series data. For example, the forecast data 112 may include demand forecasts for one or more items over time, such as per day, per week, per month, per quarter, per year, per a combination thereof, or per another time metric. The forecast data 112 may be generated by the forecasting system 102. The forecast data 112 may be provided by the forecasting system 102 to the forecast consumer 122. In some embodiments, the forecast data 112 may be compared with the sales data 110 to determine an accuracy of the forecasting system 102. In some embodiments, the forecasting system 102 may check the forecast data 112 for anomalies.

The external system 114 may include data, software, hardware, or infrastructure that may be communicatively coupled with the forecasting system 102. In the example shown, the external system 114 includes an external application 116 and external data 118. The external application 114 may be, for example, a software, platform, or infrastructure service that is useable by the forecasting system 102 to manage or process data. The external data 118 may include a remote data storage service.

The administrator 120 may be a person or system that configures aspects of the forecasting system 102. For example, the administrator 120 may be an engineer that updates the forecasting system 102, deploys the forecasting system 102, updates a parameter of a configuration file of the forecasting system 102, updates a hyperparameter for a model or process of the forecasting system 102, or performs other operations in connection with the forecasting system 102.

The forecast consumer 122 may be a system or person that receives data from the forecasting system 102. For example, the forecast consumer 122 may receive demand forecasts from the forecasting system 102. In some embodiments, the forecast consumer 122 is an application that modifies input values for forecasting models and receives real-time demand forecasts based in part on the modified input values. In some embodiments, the forecast consumer 122 may be part of an inventory management system or a supply chain management system. In some embodiments, the forecast consumer 122 may be part of the digital platform 106 or one or more of the retail locations 104. In some embodiments, the forecast consumer 122 may, in response to receiving a forecast from the forecasting system 102, automatically adjust an inventory level for one or more items based on data of the forecast. For example, the forecast consumer 122 may initiate an inventory transfer after receiving a demand forecast from the forecasting system 102. In some embodiments, the forecasting system 102 provides demand forecasts for items to the forecast consumer 122 in real time, and the forecast consumer 122 may automatically rebalance inventory levels at the retail locations 104 based on the demand forecasts.

In some embodiments, the forecast consumer 122 may be an application that includes a graphical user interface (GUI). The application may be, for example, a web application. The GUI may include visualizations of data received from the forecasting system 102, and the GUI may include selectable input fields for providing data to the forecasting system 102. In some embodiments, a user may query the forecasting system 102 to generate a demand forecast by using components of the GUI. In some embodiments, the forecasting system 102 may, in response to receiving a query from a forecast consumer 122, use an artificial intelligence (AI) to determine an effect of the user's query and generate a recommendation based on the effect. In some embodiments, the forecast consumer 122 may access the item data 108, the sales data 110, or the forecast data 112.

In examples, the forecast consumer 122 may represent a user affiliated with an enterprise associated with the forecasting system 102. For example, the forecast consumer 122 may be an employee, such as a business analyst, data scientists, or the like who is seeking to generate forecasts regarding various types of business operations, such as forecasted demand for goods or services of the enterprise, forecasted supply issues within an enterprise supply chain, and the like.

Although the example of FIG. 1 depicts a single forecast consumer 122, the forecasting system 102 may be coupled with a plurality of forecast consumers, each of which may be a different type of system or may be a common type of system. Furthermore, the forecasting system 102 may simultaneously communicate with a plurality of forecast consumers 122.

FIG. 2 illustrates a block diagram of an example architecture of the forecasting system 102. The forecasting system 102 may include a plurality of subsystems, which may themselves include a plurality of subsystems. Systems and subsystems of the forecasting system 102 are described as having certain features and performing certain operations. However, as will be understood by those having skill in the art, features and operations associated with a first system in a first embodiment may be associated with a different system in a different embodiment. Moreover, such features and operations may overlap across multiple subsystems, and systems in addition to those illustrated in the example of FIG. 2 may be included in the forecasting system 102.

In the example shown, the forecasting system 102 includes a model development system 202, a model deployment system 204, and a model output system 206. Each of these systems may be a grouping of components that may be part of the forecasting system 102. In some embodiments, components of the systems 202-206 may use aspects of a common computing and data storage infrastructure. In some embodiments, components of the systems 202-206 may use different computing or data storage infrastructures. Although a component in FIG. 2 may be depicted as part of one of the systems 202-206, each of components may belong to a different one of the systems 202-206.

In the example shown, the model development system 202, the model deployment system 204, and the model output system 206 may exchange data. For example, the forecasting models 222 may be trained using components of the model development system 202. The forecasting models 222 may be deployed and used in the model deployment system 204. In examples, other components of the model deployment system 204 may be used in connection with the forecasting models 222 as part of generating demand forecast. In some embodiments, the model deployment system 204 may include the inference delivery platform 3002 for providing real-time model inference and demand forecasts to forecast consumers. The demand forecasts may be provided to the model output system 206 for storage, subsequent processing, or output to a forecast consumer. In some embodiments, data received or generated by the model output system 206 may be provided to the model development system 202 for refining the forecasting models 222, for generating new models, or for other purposes.

In some embodiments, components described in connection with FIG. 2 may be software. In some embodiments, one or more of the components may be a combination of software and hardware. Additionally, the data exchanges among components of the forecasting system 102 are not limited to the arrows depicted in the example of FIG. 2. Furthermore, the forecasting system 102 may include more or fewer components than those illustrated in connection with FIG. 1.

In the example shown, the model development system 202 includes the sales data 110, a model training system 208, a synthetic data generator 210, a feature management system 212, a hyperparameter tuning system 214, a promotion system 216, and a model management system 218. Example operations that may be performed by components of the model development system 202 include, but are not limited to, the following: data sourcing; data extraction, cleansing, and creation; data maintenance and updating; data pipeline development; feature development; data exploration and wrangling for model-specific features; model creation; business logic encoding; model evaluation; model selection; and other operations.

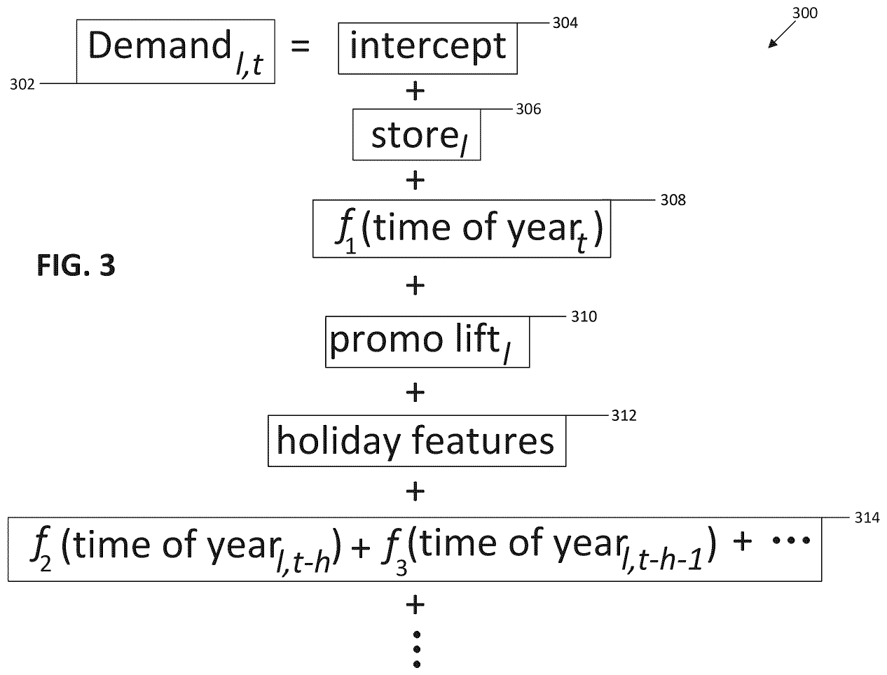

The model training system 208 may train the forecasting models 222. In some embodiments, the forecasting models 222 may be a plurality of models, such as a model for each item of a plurality of items in the item data 108. In such an embodiment, the model training system 208 may train each of the plurality of models. Training the forecasting models 222 may include various steps. For example, the model training system 208 may determine a plurality of features that are to be considered by the forecasting models 222, examples of which are further described below in connection with FIG. 3. In some embodiments, the model training system 208 may use the sales data 110 to train the forecasting models 222. Furthermore, using the sales data 110, the model training system 208 may update weights, parameters, intercepts, random effects, fixed effects, functions, or biases of the forecasting models 222, or any other modifiable aspect of the forecasting models 222, depending on the implementation of the forecasting models 222, as part of training. In some embodiments, the model training system 208 may periodically retrain the forecasting models 222.

In some embodiments, the forecasting models 222 are stored in one or more data storage systems. For instance, an example forecasting model may be represented at least in part by one or more files, such as configuration files and code that represent features, parameters, weights, and operations of the forecasting models. Such files may be stored in a data storage system. When modifying a model, such as by selecting features for a model or training a model, one or more files associated with the model may be accessed and updated. Moreover, when using a model, such as to forecast demand, the one or more files associated with the model may be accessed.

The synthetic data generator 210 may generate data that is used to train the forecasting models 222. For example, the synthetic data generator 210 may generate synthetic sales data. Synthetic sales data may be data corresponding to sales that did not actually occur. In some embodiments, the synthetic sales data may be added to the sales data 110. In some embodiments, to generate synthetic sales data, the synthetic data generator 210 may use data corresponding to actual sales from the sales data 110 and may use item data 108. In some embodiments, the synthetic sales data may be used to supplement flawed historical sales data, such as historical sales data for an item during a time associated with a stockout event. As another example, the synthetic sales data may be used to generate synthetic sales data for new items or items with insufficient historical sales data. Example aspects of the synthetic data generator 210 are described in connection with FIG. 5-7.

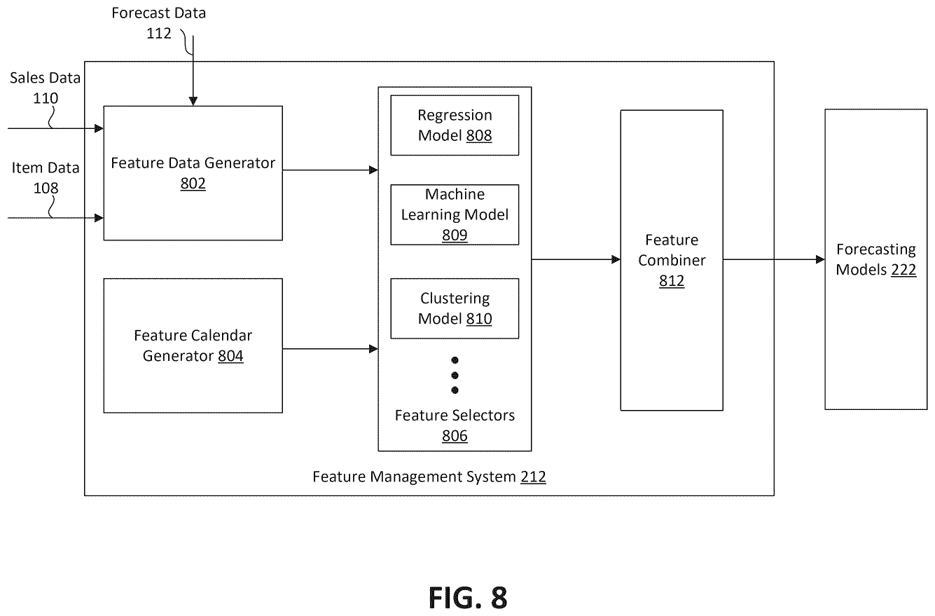

The feature management system 212 may select features that are to be used by the forecasting models 222. For example, the feature management system 212 may select, from a plurality of potential features, a subset of features that are to be used by the forecasting models 222. The feature management system 212 may select different features for different forecasting models of the forecasting models 222. Additionally, the feature management system 212 may, in some embodiments, perform one or more operations associated with the hyperparameter tuning system 214. Example aspects of the feature management system 212 are described in connection with FIG. 8-12.

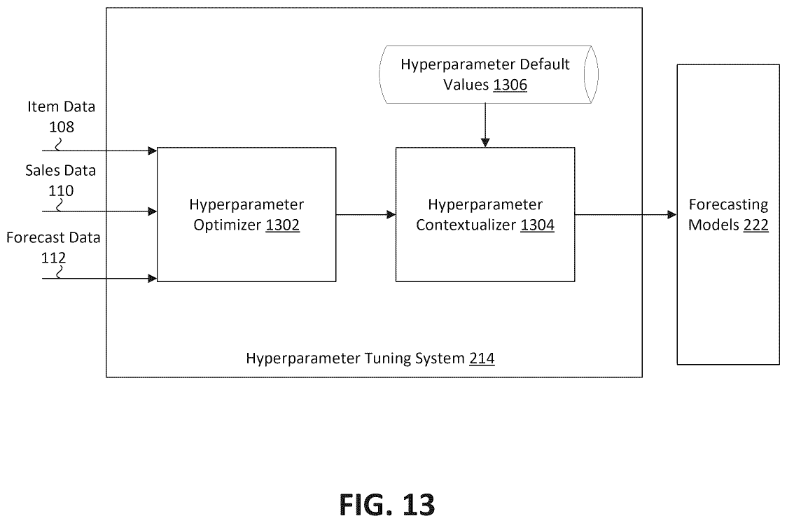

The hyperparameter tuning system 214 may determine hyperparameters and their corresponding values for the forecasting models 222. Example hyperparameters may include a degree to which a feature is weighted in a forecasting model 222. Furthermore, a hyperparameter may include a setting that is used by the model training system 208 when training the forecasting models 222. Example aspects of the hyperparameter tuning system 214 are described in connection with FIG. 13-15.

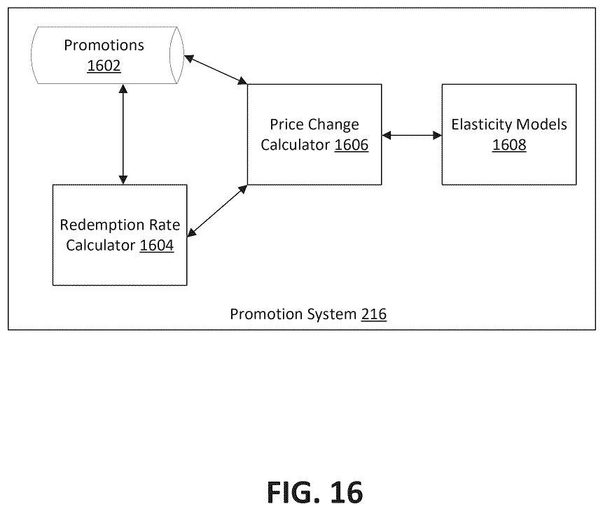

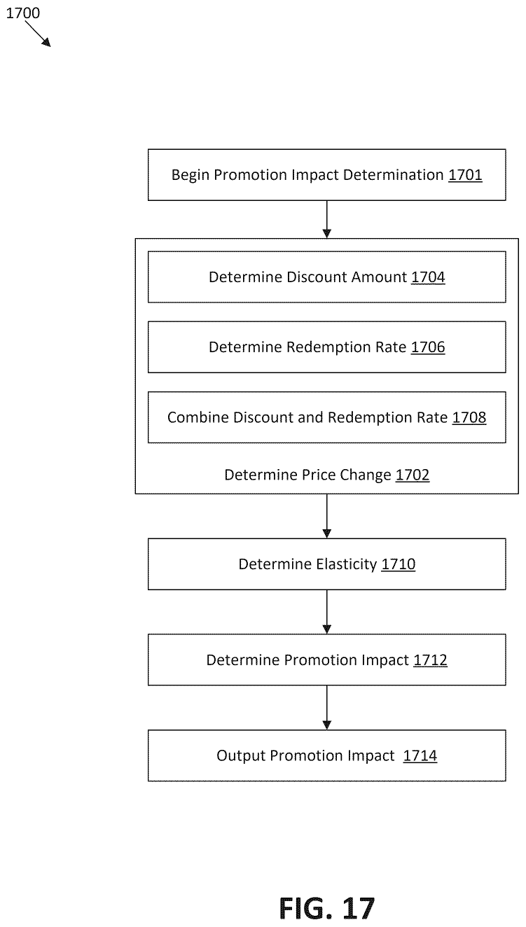

The promotion system 216 may determine the effects of promotions on demand. A promotion may include, for example, a discounted price for an item. As described further herein, there may be different types of promotions, which may have varying degrees of impact on demand forecasts. In some embodiments, the promotion system 216 may determine which promotions are to be considered by the forecasting models 222, and the promotion system 216 may determine the degree to which a promotion effects a demand forecast. In some embodiments, the promotion system 216 may determine a price effect of a promotion, and based on the price effect and an elasticity model, the promotion system 216 may determine an effect on the demand forecast based on the promotion. Example aspects of the promotion system 216 are described in connection with FIG. 16-17.

The model management system 218 may manage the forecasting models 222. For example, the model management system 218 may manage the deployment, storage, updating, versioning, and other aspects of the forecasting models 222.

In the example shown, the model deployment system 204 includes a forecasting model controller 220, forecasting models 222, a forecast disaggregator 224, and support models 226. In addition to performing operations related to model deployment, the model deployment system 204 may perform operations related to operating the forecasting models 222. In some embodiments, components of the model deployment system 204 may perform operations that include, but are not limited to, the following: model performance optimization; model versioning and governance; scoring and training automation; data drift evaluation and retraining; and other operations.

The forecasting model controller 220 may determine a time at which demand forecasts are generated using the forecasting models 222. For example, the forecasting model controller 220 may generate demand forecasts weekly by using the forecasting models 222. In some embodiments, the forecasting model controller 220 executes forecasting models 222 in parallel to simultaneously generate demand forecasts for a plurality of items. In some embodiments, the forecasting model controller 220 may execute, for a given item, one or more passes with a forecasting model of the forecasting models 222 to try to generate a demand forecast. For example, the forecasting model 220 may attempt to execute a forecasting model for the item. If that fails (e.g., due to data sparsity, due to a model timing out, or due to another reason), then the forecasting controller 220 may attempt to execute a forecasting model for a cluster of items, where the cluster of items includes the item. If that fails, then forecasting model controller 220 may attempt to execute a forecasting model of the forecasting models 222 for a supply chain. In some embodiments, the forecasting model controller 220 performs operations associated with the inference delivery platform 3002 for real-time demand forecasting. Other examples of using the forecasting models 222 to generate a demand forecast are likewise possible.

In some embodiments, the forecasting model controller 220 may include a load balancer that distributes computations of components of the forecasting system 102 across different computing systems. In some embodiments the forecasting model controller 220 identifies one or more items or batches of items for which to determine a demand forecast.

The forecasting models 222 may include one or more models for forecasting item demand. In some embodiments, the forecasting models 222 are trained using data generated or output by components of the model development system 202. In some embodiments, one or more of the forecasting models 222 may be a general additive mixed model (GAMM). In some embodiments, one or more of the forecasting models 222 may be a general additive model (GAM) or a different model. In some embodiments, one or more of the forecasting models 222 may be a machine learning model. In some instances, a first item may be associated with a first model type of forecasting models 222 and a second item may be associated with a second model type of the forecasting models 222. In some embodiments, the forecasting models 222 may forecast demand for an item based on a plurality of item features. In examples, the item features may include one or more features from the item data 108. In some embodiments, the forecasting models 222 include location-based and time-based features for forecasting demand for a given item.

In some embodiments, the forecasting models 222 may include a plurality of location-specific models and may include a model for a group of locations (e.g., for a full supply chain). Thus, when forecasting demand for an item, a location-specific model may be executed to forecast item demand at a particular location, and a chain-level model may be applied to determine an overall item demand forecast. In some embodiments, the chain-level model includes an aggregation of location-specific models.

In some embodiments, the forecasting models 222 include item-specific forecasting models. In such an embodiment, an item-specific forecasting model of the forecasting models 222 may be trained using historical demand data for the item. In some embodiments, the forecasting models 222 may be associated with a list of items for which the forecasting models 222 are trained to generate a demand forecast. In some embodiments, the forecasting models 222 may be configured to generate a demand forecast at a particular time or a range of times.

The structures of features may vary within a given model of the forecasting models 222. For example, a forecasting model may include a combination of random effects, fixed effects, linear features, non-linear features, smooth terms, random effects, intercepts, or other types of features. In some embodiments, a fixed effect is a linear term and a smooth term is a non-linear term. In some embodiments, a smooth term models forecasting variability for groups of items. Different features may be modeled using different feature types. For example, a seasonality feature may be modelled as a smooth term, whereas a store feature may be modelled as a random effect, or vice-versa. Additionally, depending on a model type, the features may vary. For example, an item-specific forecasting model that determines item forecasts for a digital or store demand may include different features than a store or chain-level model that determines demand at the store or chain-level.

In some embodiments, a forecasting model of the forecasting models 222 includes an ensemble of forecasting models. For example, for a given item or group of items, the forecasting model may include different models depending on an item, location, or time granularity at which demand forecasts are being generated. Additionally, in some embodiments, the forecasting model may include a first item-specific model and also a plurality of forecasting models for similar items, thereby enabling the forecasting model to perform multiple passes if needed to forecast demand for the item, such as a first pass with the first item-specific forecasting model and a subsequent pass that aggregates and weighs demand forecasts from the plurality of forecasting models for the similar items.

Advantageously, for embodiments in which a GAMM model is used, different features, and different techniques for modelling features, may be altered or retained to improve model accuracy by capturing differences in the training data that are pertinent to each model, while still enabling efficient backend resource utilization, such as code re-use and shared storage, for model features that are common across models. By developing and managing models in this way, model accuracy may be improved without an associated increased demand for computer resources, and in fact, memory storage space and training compute times may be decreased in some instances by re-using components across models.

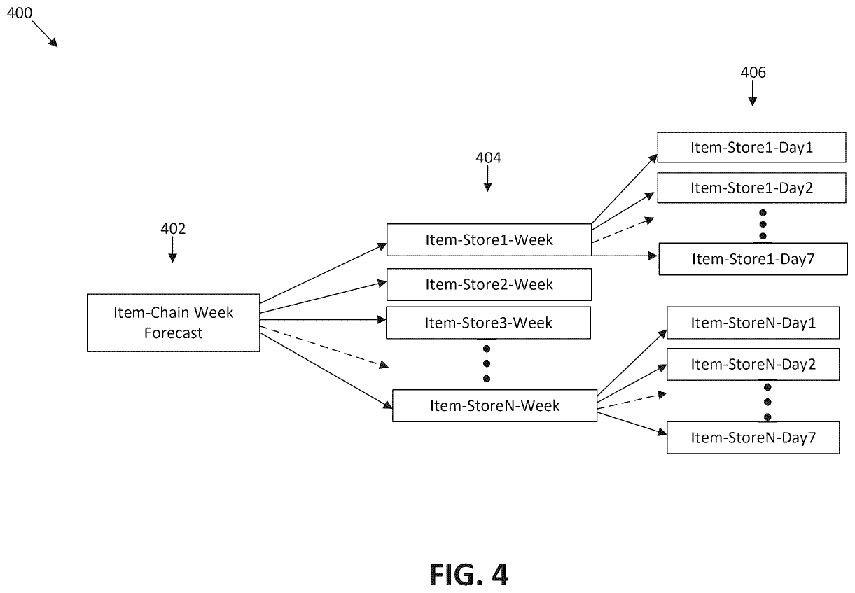

The forecast disaggregator 224 may disaggregate forecasts generated by the forecasting models 222. For example, for a given item, a forecasting model 222 may generate a demand forecast across a plurality of stores (e.g., a full supply chain or a region within a supply chain) during a given week for the item. The forecast disaggregator 224 may, for example, disaggregate this demand forecast into demand forecasts for each store of the plurality of stores. Furthermore, the forecast disaggregator 224 may disaggregate demand forecasts based on time, such as disaggregating a demand forecast from a week forecast to individual days. FIG. 4 illustrates an example of the forecast disaggregator 224 disaggregating a demand forecast.

The support models 226 may include one or more models that are used by one or more of the forecasting models 222, the model training system 208, or another component as part of forecasting demand or training the forecasting models 222. In the example shown, the support models 226 include an elasticity model 228, an embedding generator 230, an item clustering model 232, and an event model 234.

The validation tool 240 may evaluate demand forecasts output by the forecasting models 222. For example, the validation tool 240 may compare demand forecasts of the forecasting models 222 with actual sales data to evaluate a performance of the forecasting models 222. In some embodiments, the model training system 208 may use the validation tool 240 to monitor performance of the forecasting models 222 and evaluate when to retrain the forecasting models 222.

The anomaly detector 242 may detect anomalies in demand forecasts generated by the forecasting models 222. An anomaly may be a statistically significant deviation from an expected demand forecast. Examples of anomalies may include a percentage deviation from a historical value. For instance, if a demand forecast for an item is 30% higher than a historical demand value for the item, then the anomaly detector 242 may detect this deviation as an anomaly. In some embodiments, an anomaly may be manually flagged by a user. In some embodiments, the anomaly detector 242 may determine a cause of a difference between a demand forecast and an actual demand value. In some embodiments, an indication of an anomaly may be output to a user.

The forecast consumer interfaces 246 may include interfaces for interacting with systems that receive demand forecasts from the forecasting system 102, such as the forecast consumer 122. In the example shown, the forecast consumer interfaces 246 include a GUI 248 and an application programming interface (API) 250. In some embodiments, the GUI 248 may be part of an application that is provided by the forecasting system 102 or that is communicatively coupled with the forecasting system 102. In some embodiments, a forecast consumer interface may receive an input from a user. Based on the input, various operations may be performed by subsystems of the forecasting system 102, such as components illustrated in the example of FIG. 2. Components involved in generating a response to the input may be part of a response generation system. The response generation system may comprise systems of the forecasting system 102 and components external to the forecasting system 102 that can, among other things, receive a user input, generate a response, which may include a demand forecast, and output the response. In some embodiments, the inference delivery platform 3002 is the response generation system. Depending on the embodiment, and the type of input received, the response generation system may include or deploy different subsystems. In some embodiments, the response generation system is the AI system 252.

In some instances, an input requests a demand forecast for an item. In some instances, additional operations may be performed to augment the input (e.g., determine additional data that provides context to or supplements the input) as part of generating a demand forecast, or additional operations may be performed to augment a response, such as providing not only the demand forecast but also a recommendation or data corresponding to other effects associated with a demand forecast, such as effects on other items. Based on the input, the forecast consumer interface, or another component communicatively coupled therewith, may identify one or more subsystems that may be used to process the input or data associated with the input.

The API 250 may provide one or more functions of the forecasting system 102 to other applications. For example, API 250 may enable an application to query the forecasting system 102 for a forecast of an item. Furthermore, in some embodiments, the API 250 may provide one or more subfunctions, such as operations performed by components of the forecasting system 102, to other applications.

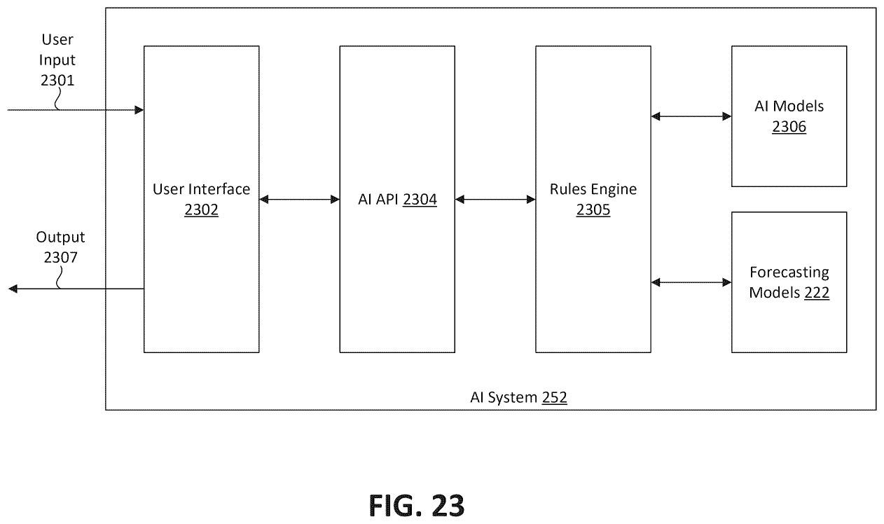

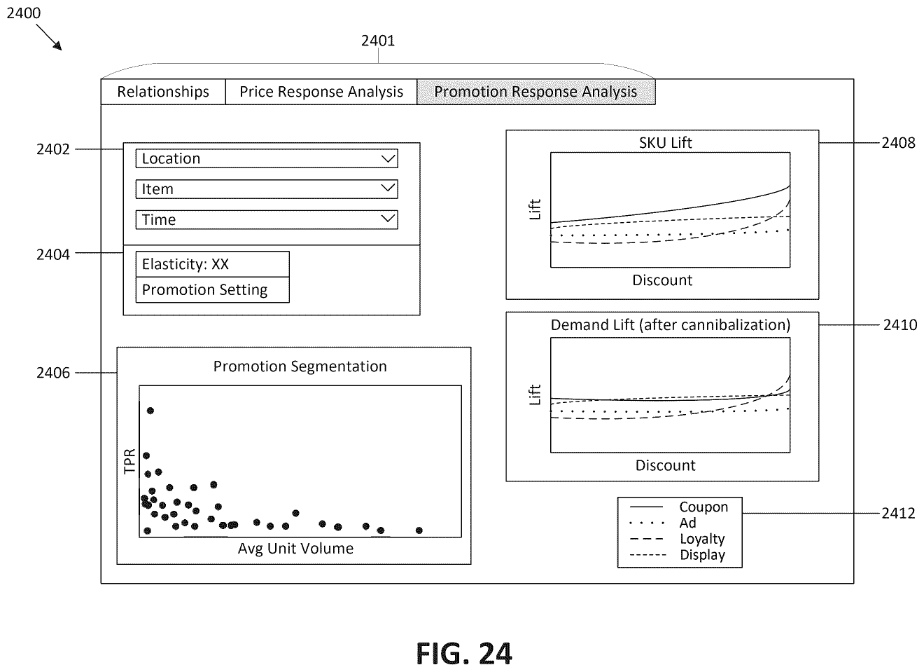

The artificial intelligence (AI) system 252 may be a system that uses components of the forecasting system 102 as part of a human-in-the-loop AI tool. In some embodiments, the AI system is a generative AI system. In some embodiments, the AI system 252 is configured to receive an input from a user. The user may be using a system associated with a retailer. For example, the AI system may receive an input corresponding to an inventory level, a price, a scenario, an event, or another input associated with data that may influence a demand forecast. In view of the input, the AI system may determine an effect on a demand forecast. As part of doing so, the AI system may use the forecasting models 222. In some embodiments, the AI system 252 may provide a recommendation based at least in part on the generated demand forecast. In some embodiments, components described in connection with the AI system 252 may be implemented in the inference delivery platform 3002, and vice-versa. Example aspects of the AI system 252 are further described in connection with FIG. 23-24.

FIG. 3 illustrates a schematic representation of aspects of a forecasting model of the forecasting models 222. In the example of FIG. 3, the forecasting model is a GAMM. FIG. 3 shows example features that may be considered by the forecasting model. In the example shown, results for the features are added. However, in other embodiments, different features may be considered, and the features may be combined in a different manner.

In the example shown, the element 302 represents a demand forecast for an item at location l during a time t. The location l may be a single location or a group of locations. The location l may be a store. The time t may be a given week, such as the second week of March, or the time t may be a different span of time, such as a particular year, or a time from the present. In some embodiments, the demand forecast corresponds to expected sales. In some embodiments, the demand forecast is a logarithm of expected sales. In the example shown, the demand forecast is a summation of the features 304-314.

The element 304 represents an intercept. In some embodiments, the intercept represents a baseline value. In some embodiments, the intercept is an average weekly sale. In some embodiments, the intercept is an average of weekly sales for group of stores to which the location l belongs.

The element 306 may represent a difference in average sales at the location l. In some embodiments, the element 30 is a random effect.

The element 308 may represent a seasonality factor. In some embodiments, the function f₁ is a cyclic spline function that models the effects of season on demand for the item.

The element 310 may represent the effect of a promotion on demand for the item. In some embodiments, the promotion lift is an offset. In some embodiments, the effect of the element 310 may be determined by the promotion system 216.

The element 312 represents holiday features. There may be a plurality of holiday features. For example, there may be a holiday features for each holiday that is considered for the item. In some embodiments, the holiday features are linear terms.

The element 314 represents a trend feature. In some embodiments, the trend feature includes a time-weighted regression for capturing recent demand trends. The trend feature may account for demand changes within a predefined amount of previous time. In the example shown, the predefined amount of previous time is represented by the variable h. As an example, h may be a number of weeks, such as 4. The functions f₂, f₃, and so on may be splines.

As shown, there may be more features than those illustrated and described in connection with FIG. 3.

FIG. 4 illustrates a schematic diagram 400 illustrating a disaggregation of a demand forecast for an item. In the example shown, a forecasting model of the forecasting models 222 may generate an aggregate demand forecast for an item, such as the item-chain-week forecast 402, which represents a demand forecast for an item across all locations of a supply chain during a week. In some embodiments, the forecast disaggregator 224 may disaggregate the item-chain-week forecast to a plurality of item-store-week forecast 404, which may represent forecasted demand for the item for the week at each store of a plurality of stores. In some embodiments, the forecast disaggregator may further disaggregate the demand forecasts. For example, for a given item-store-week forecast, the forecast disaggregator 224 may disaggregate the demand forecast into a plurality of item-store-day forecasts 406, which may represent the demand forecasts for the item at the store on each day of a week. As such, the forecasting system 102 may be configured to generate demand forecast at a desired level of granularity for each item.

In example aspects, demand forecasting models are trained using historical sales data. However, in some instances, the historical sales data may be incomplete or unavailable. For example, a new item may not have any historical sales data. As another example, historical sales data may be lower than actual historical demand because of inventory constraints. That is, in some instances, the sales data for an item may be low because the item was out of stock, not because the demand was low.

In example aspects, systems and methods for generating synthetic data that may be used to train forecasting models are disclosed. In some embodiments, an item for which synthetic data may be generated may be one or more of the following: a new item; an item that is rarely sold; an item that experience a stockout event; or another item for which historical sales data may not be predictive of future demand. For instance, for such items, the historical number of items sold may be a bad indicator of item demand. Use of sales data as being representative of demand in these situations could result in poor performance of forecasting models.

In example aspects, with respect to new items or other items for which historical sales data may be sparse, aspects of the present disclosure may generate sales data in a synthetic manner. In an example, similar items may be identified, and synthetic time series data may be generated based on data associated with the similar items. The synthetic time series data may be used to train forecasting models that forecast demand for the item. In some embodiments, once sales data associated with the item becomes available, that sales data can be analyzed to determine if it is representative of demand (e.g., lacks stockouts, is sufficiently non-sparse, etc.). The synthetic demand signal for an item may then be adjusted as needed using other statistical or machine learning models, such as forecasting models relating to price elasticity and promotion effects, at the desired granularity level (e.g., chain, region, store). In some embodiments, a combination of synthetic sales data and actual sales data may be used to train forecasting models.

In example aspects, with respect to stockout events, aspects of the present disclosure may synthetically alter the historical sales data such that it reflects what the sales would have been if there had not been stockouts. In some instances, such synthetically altered sales data may represent an unconstrained demand, which may be the metric that the forecasting models seek to forecast. Correcting for out-of-stock events may include first identifying a stockout event. For example, a statistical or machine learning approach can be used to determine a stockout event. As an example, the system may identify that the sales for an item are a threshold amount (e.g., 30%) below their typical sales amount. This may indicate that the item is out of stock. As another example, a stockout event may be identified by subtracting sales of an item from a known inventory level to identify that the inventory is sufficiently low, such that there may be a stockout. The stockout event may be identified at an item-location level of granularity or at a different level of granularity.

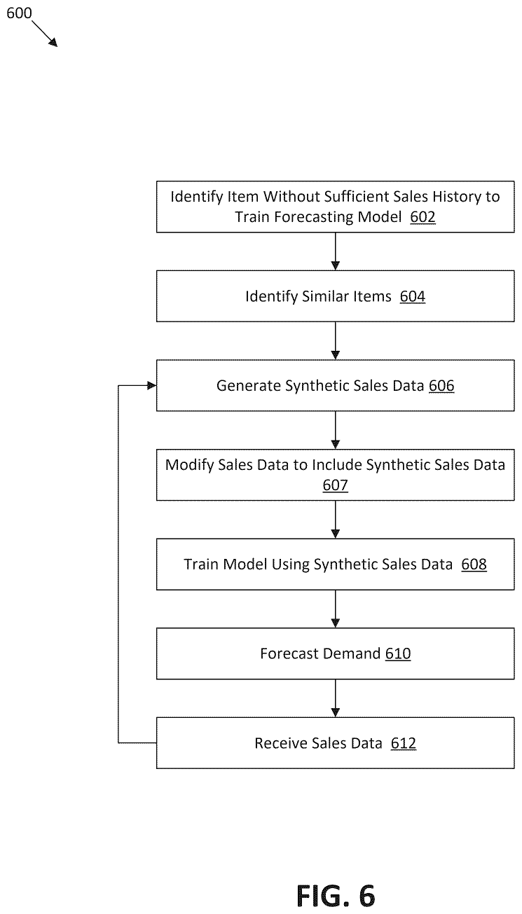

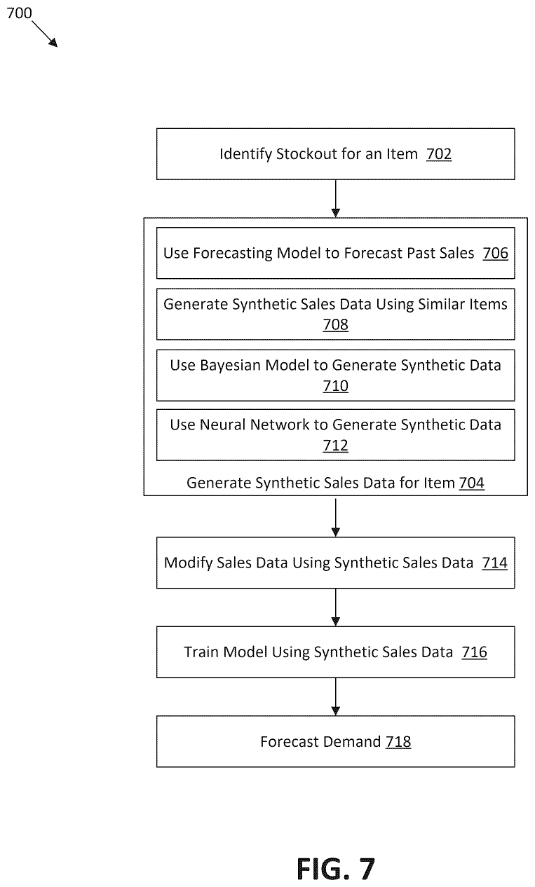

Furthermore, in example aspects, for a given item and a given time during which a stockout has been identified, the synthetic data generator 210 may generate synthetic sales data that represents the predicted sales data if the stockout had not occurred. There are various techniques for generating this synthetic sales data, as described, for example, in connection with the operation 704 of FIG. 7. Furthermore, in example aspects, the model training system 208 may update the forecasting models 222 by using data generated by the synthetic data generator 210, as described further in connection with FIG. 6-7. As such, for a given item, rather than training the forecasting models 222 using sales data for an item that was affected by stockouts, the forecasting models 222 may be trained using corrected synthetic data that reflects sales as if there were no stockouts.

In example aspects, when creating synthetic time series data, there may be multiple ways to view the problem from a technical, statistical point of view. For example, synthetic time series data can be created either on the basis of a set of input signals, generating time series data, or generating both time series data and accompanying input signals that would be associated with that time series data. In the first case, some sufficient statistics representative of a data set may be provided (e.g., mean and variance of various features), and a posterior predictive distribution may be used to generate synthetic data representative of a dataset having such features, either using independent (non-past-viewing) data generation, or with an attempt to generate a cohesive time series (e.g., considering data at time t when generating data for time t+1). In the second case, demand or sales data is generated, but also input data signals that would generate that data. Depending on the embodiments, the synthetic data generator 210 may implement one of or both of the approaches as part of generating synthetic time series data. Furthermore, depending on the embodiment, either of the two approaches may use statistical models or machine learning models.

FIG. 5 illustrates a schematic diagram 500 including components that may be used in connection with one or more of the generation or use of synthetic data. The diagram 500 includes item data 108, sales data 110, synthetic data generator 210, model training system 208, and forecasting models 222. Furthermore, the diagram 500 illustrates example data exchanges 502-510 between components of the diagram 500. In the example of FIG. 5, the data exchanges 502-510 are described as relating to a query item, which may be an item that is part of an item catalog or that may be part of an item catalog, and for which the synthetic data generator 210 may generate data. However, aspects of FIG. 5 may be applied to generate synthetic data for a plurality of different items.

In the example shown, the synthetic data generator 210 may receive query item sales data 502 from the sales data 110. The query item sales data 502 may include historical sales data for the query item. In some instances, the query item sales data 502 may be empty or sparse, because the item may be a new item. In some embodiments, query item sales data 502 may be for a particular location, for a group of locations, or for a digital sales channel. In some embodiments, the query item sales data 502 may be from a particular time, such as during a particular year or another range of time in the past. In some embodiments, the query item sales data 502 may include all available historical sales data for an item. Furthermore, the query item sales data 502 may also include sales data for items that are similar to the query item.

In the example shown, the synthetic data generator 210 may receive query item data 504 from the item data 108. The query item data 504 may include attributes or characteristics of the query item, such as, for example, an item classification, name, description, image, location, or channel. Furthermore, the synthetic data generator 210 may receive data for items that are or may be similar to items similar to the item for which sales data 502 was received.

In some embodiments, the synthetic data generator 210, having received the query item sales data 502 and the query item data 504, may determine whether to generate synthetic data. To determine whether to generate synthetic data for an item, the synthetic data generator 210 may determine whether the historical sales data, which may be part of the sales data 502, is sufficient or insufficient. In some embodiments, insufficient historical sales data may include data corresponding to historical sales data for a new item or for an item that was out of stock during a time period. An example of determining that the historical sales data for an item is insufficient in the context of a new item is described in connection with the step 602 and with FIG. 6 more generally. An example of determining that the historical sales data for an item is insufficient in the context of an item that was out of stock is described in connection with the step 702 and FIG. 7 more generally. Other examples of insufficient historical sales data can likewise be addressed using aspects of the present disclosure and may include incorrectly recorded or captured sales data, anomalous sales data, or other incorrect sales data.

In the example shown, the synthetic data generator 210 may provide query item sales data 506 and synthetic query item sales data 508 to the model training system 508. The query item sales data 506 may be actual sales data of the sales data 110 for the query item. In some instances, the query item sales data 506 is the same as the query item sales data 502. In some instances, the query item sales data 506 is a subset of the query item sales data 502, in which sales data is removed that is associated with a stockout event. The synthetic query item sales data 508 may be data generated by the synthetic data generator 210. In some embodiments, each of the query item sales data 506 and the synthetic query item sales data 508 may be time series data. In some embodiments, the query item sales data 506 and the synthetic query item sales data 508 may be non-overlapping time series data, in which the synthetic query item sales data 508 fills gaps in times of the query item sales data 506.

In the example shown, the model training system 208 may receive the data 506-508, and the model training system 208 may use the data 506-508 to train a model for forecasting demand for the query item. As shown by the element 510, the model training system 208 may add the model trained to forecast demand for the query item to the forecasting models 222. In some embodiments, the model training system 208 may update an existing model of the forecasting models 510 with the data 506-508, or only with the data 508.

FIG. 6-7 are flowcharts that illustrate example methods for generating synthetic data. Although certain operations of FIG. 6-7 are described as being performed by the synthetic data generator 210, one or more of operations of the FIG. 6-7 may be performed by a different component or combination of components. In the example of FIG. 6, the synthetic data generator 210 generates synthetic data for an item that lacks sufficient sales history, such as a new item or a slow-selling item. In the example of FIG. 7, the synthetic data generator 210 generates synthetic data for an item in response to an identification of a stockout. Furthermore, there may additional situations for which synthetic data generator 210 may generate synthetic data, such as, for example, generating synthetic data to validate or test forecasting models, generating synthetic data to supplement existing data that may not be deficient, or generating synthetic data for another reason. In some embodiments, the synthetic sales data described in connection with FIG. 6-7 may correspond to an unconstrained demand for an item during a time period. The unconstrained demand may represent hypothetical sales for an item during the time period if the item had been fully available during that time period. For example, this unconstrained demand may represent what the sales of the item would have been in the absence of an identified stockout event, or if the item had been sold by a given location during the time period.

FIG. 6 is a flowchart of an example method 600 for generating synthetic sales data. In the example of FIG. 6, synthetic sales data may be generated for a new item or for an item that otherwise lacks sufficient historical sales data to train a forecasting model.

In the example shown, the synthetic data generator 210 may identify an item that lacks sufficient sales history (step 602). In some embodiments, items that lack sufficient sales history may be items for which the associated sales history is insufficient to train a forecasting model with a threshold level of accuracy and confidence. In some embodiments, parameters for the forecasting model may not converge during training (e.g., may not be sufficiently stable or constant between training rounds) within an allocated training time or after using all available training instances, which may indicate that there is insufficient sales history to train the model. In some embodiments, an item lacking sufficient sales history may be identified after an attempt by the model training system 208 to generate a forecasting model for the item. In some embodiments, an item lacking sufficient sales history may be a new item, and it may be identified by the synthetic data generator 210 based on an indication that the item is new. In some embodiments, the synthetic data generator 210 determines a quantity of sales data available for an item and determines, based on this quantity, whether the sales data is sufficient to train a forecasting model. In some embodiments, the synthetic data generator 210 may determine a quantity of sales data for the item over time, from which a degree of data sparsity may be determined. Based on the degree of data sparsity, it may be determined whether the item has sufficient sales history.

In some embodiments, the synthetic data generator 210 may analyze historical sales data for a plurality of items, and based on this analysis, identify items lacking sufficient sales history. In some embodiments, a user may manually provide an indication to the synthetic data generator 210 that identifies items for which there is insufficient sales history. In some embodiments, the synthetic data generator 210 may determine that an item has sufficient sales data for a first location, or group of locations, but not for a second location, or second group of locations. In other embodiments, the synthetic data generator 210 may determine that there is insufficient sales data for a certain fulfillment channel (e.g., in store sales) but sufficient sales data for a different fulfillment channel (e.g., digital demand).

In the example shown, the synthetic data generator 210 may identify similar items (step 604). For instance, for an example item identified during the step 602, the synthetic data generator 210 may identify similar items. In some embodiments, the similar items may be any items for which there may be sales data that can be used as part of generating synthetic sales data for the example item. As an example, the similar items may be part of a class to which the example item belongs. As another example, the similar items may include item characteristics that are similar to characteristics of the example item, such as, for example, a similar name, a similar description, a similar feature, a similar attribute, or another similar characteristic. As another example, the similar items may be items with similar demand patterns as the example item, such as sharing similar demand changes based on season, based on price changes, based on events, or based on other features that may affect demand. In some embodiments, the synthetic data generator 210 may perform an embedding-based search to identify similar items where respective embeddings for respective items may be generated using a transformer-based model that generates embeddings using one or more of titles, descriptions, images, reviews, classifications, metadata, or other data.

In some embodiments, identifying similar items may include identifying the same item as the example item but at a different location. For example, the example item may not have any sales data at a certain location, but the example item may have sales data associated with sales at different locations. In some embodiments, the sales of the item at the different locations may be used to generate synthetic sales data for the item.

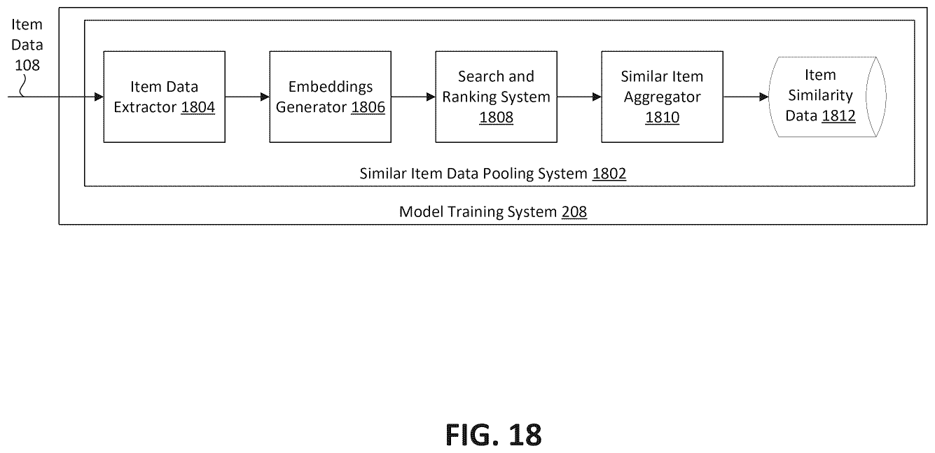

In the example shown, the synthetic data generator 210 may generate synthetic sales data (step 606). For example, the synthetic data generator 210 may generate synthetic sales data using sales data of similar items. In some embodiments, the synthetic data generator 210 may pool sales data of the similar items to generate synthetic sales data for the example item. For example, the synthetic data generator 210 may use an average, or a weighted average based on item similarity, of sales data for similar items to generate the synthetic sales data for the example item, example aspects of which are described in connection with FIG. 18.

As an example, the synthetic data generator 210 may identify five items that are similar to an example item. These five items may have sufficient data to train a forecasting model. As an example, these five items may have historical sales data for a certain week of a previous year. The sales of these five items during that week may be aggregated to generate synthetic sales data for the example item during the week. In some embodiments, aggregating the similar item sales data may include averaging the sales data or may include a weighted average of the sales data of the similar item sales, where sales data for items that are more similar to the example item are weighted more heavily than sales data for items that are relatively less similar to the example item.

As another example, the synthetic data generator 210 may generate synthetic sales data using sales data of the item at locations at which the item was available during the relevant time period. For example, if the item has insufficient sales data at a location during a time period because the item was unavailable during that time period (e.g., because it was not sold at the location during the time period, or because the item was out of stock), and if the item was sold at different location during that time period, then sales data of the item at the different location may be used to generate synthetic sales data. In some embodiments, this process may include first selecting one or more similar locations and then adjusting the sales data from the one or more similar locations to account for any differences between the location and the one or more similar locations.

In the example shown, the synthetic data generator 210 may modify the sales data 110 to include the synthetically generated sales data for the item (step 607). For example, this may consist of the synthetic data generator 210 storing the synthetic sales data in a database that tracks demand or sales for the item, thereby updating the sales data 110 to include the synthetic sales data.

In the example shown, the model training system 208 may train a forecasting model using the synthetic sales data (step 608). The forecasting model may be from the forecasting models 222 described above in connection with FIG. 2. For example, the forecasting model may be an item-specific forecasting model that generates demand forecasts, at a location or at a plurality of locations, for the item for which synthetic sales data was generated. In some embodiments, if there is already a forecasting model for the example item, then the model training system 208 may update the existing forecasting model, whereas in some embodiments, the forecasting model may be trained from scratch using at least the synthetic sales data. In some embodiments, training the forecasting model may include updating model weights or parameters. In some embodiments, multiple models may be trained using the synthetic sales data. For example, both a location-specific, item-specific forecasting model and a multi-location, item-specific forecasting model (e.g., a model that forecasts demand for an item at a group of locations or across an entire supply chain) may be trained using the synthetic data.

In some embodiments, the model training system 208 may use a combination of synthetically generated sales data and actual sales data for the example item. For example, the example item may have interrupted or intermittent sales data, and the model training system 208 may use the interrupted or intermittent sales data in combination with the synthetically generated sales data to train the forecasting model. As another example, a new item may begin with no actual sales data. As such, initially training a forecasting model for the new model may consist only of using synthetic data. However, as the item is sold, the forecasting system 102 may receive actual sales data for the item. In some embodiments, the model training system 208 may combine the actual sales data with the synthetically generated data to train the forecasting model. As more actual sales data is received for the item, the model training system 208 may progressively phase out the use of synthetically generated sales data such that, once there is a sufficient amount of data, only actual sales data is used to train the forecasting model. An example of such a series of operations is illustrated in connection with FIG. 6.

In the example shown, a forecasting model may forecast demand (step 610). For example, the model trained during the step 608 may forecast item demand. For example, the forecasting systems 102 may receive a request to forecast demand for the item. The request may originate from a forecast consumer or may be scheduled. The request may pertain to a particular time period (e.g., a certain day or week) and location, which may be a particular store or a group of stores. The request may also pertain to a plurality of time periods (e.g., each week for a year). Based on the request, the forecasting system 102 may select a forecasting model that corresponds to the request from the forecasting models 222. For example, if the request is to forecast demand for a certain item, then the forecasting system 102 may select, from the forecasting models 222, an item-specific forecasting model associated with that item. Using parameters that were trained with the synthetically generated time series data, the forecasting model may process the request to generate a demand forecast, which may be output to the requesting application.

In the example shown, the forecasting system 102 may receive sales data (step 612). In some embodiments, the sales data may be, for example, actual sales data as opposed to synthetically generated sales data. For instance, for the example item, sales data registered at retail locations 104 or the digital platform 106 may be received by received at the sales data 110 and the forecast system 102. In some embodiments, the sales data may be continuously received in real time, or in near real time, by the forecasting system 102.

In the example shown, the synthetic data generator 210 may again generate synthetic data for the example item after actual sales data has been received (returning to the step 612). In some embodiments, regeneration of synthetic sales data may occur periodically. In some embodiments, the synthetic data generator 210 may use the actual sales data for the example item as part of generating new synthetic data. For example, given the actual sales data, the synthetic data generator 210 may reassess and thereby regenerate sales quantities in the synthetic sales data. For example, if the volume of actual sales data is greater than forecasted, then the volume of sales in the synthetic sales data may be increased. Similarly, if the volume of actual sales data is less than forecasted, then the volume of sales in the synthetic sales data may be decreased.

In some embodiments, the model training system 208 may retrain the forecasting model for the example item. In some embodiments, retraining the forecasting model may use a combination of actual sales data and synthetic sales data, where the ratio of actual sales data to synthetic sales data used in training may increase as more actual sales data becomes available. For example, the model training system 208 may phase out the synthetic sales data with the actual sales data. This may include multiple iterations of retraining the forecasting model, where with each iteration, relatively more actual sales data and relatively less synthetic sales data is used to train the forecasting model. For example, at a first time of retraining the forecasting model, both actual and synthetic sales data may be used, but at a second, later time, only actual sales data may be used to train the forecasting model, thereby completing the phasing out of the synthetic training data.

FIG. 7 is a flowchart of an example method for generating synthetic data for an item that experiences a stockout. For exemplary purpose, operations of FIG. 7 are described as being performed with respect to an example item. However, as will be understood, operations of FIG. 7 may be performed for a plurality of items.

In the example shown, the synthetic data generator 210 may identify a stockout for an item (step 702). A stockout may occur when the inventory of an example item at a location is sufficiently low that may affect purchasing of the example item at the location. For example, a stockout may be a period of time during which the inventory of the example item is zero or below a threshold amount such that it cannot be fully available to purchase at the location. For instance, if a first size of a clothing item is available at a store but a second size of the clothing item is not available at the store, then this may, in some instances, be considered a stockout for the clothing item. In some embodiments, a stockout is identified for an item across a plurality of locations. In some embodiments, a stockout is identified for a period of time, such as a month, week, day, or other level of granularity.

Depending on the embodiment, a different technique may be used to identify a stockout. In some embodiments, the synthetic data generator 210 may identify a stockout by using derived inventory levels. For example, the synthetic data generator 210 may determine an initial amount of inventory of the example item at a location. Based on sales data, restock events, and an initial inventory level, the synthetic data generator 210 may determine a current level. In response to determining that the that the inventory level is below a threshold amount, or in response to determining that the inventory level is zero, the synthetic data generator 210 may determine that there is a stockout.

In some embodiments, the synthetic data generator 210 may determine a stockout by detecting an anomaly in sales data for the example item. Various techniques may be used to detect anomalies. For example, if the synthetic data generator 210 determines that the sales data for the example item is sufficiently below a forecasted amount, then this may be identified as a potential stockout. For example, based on a plurality of conditions that may affect sales (e.g., a location, trends, historical sales, a season, a price, holidays, a promotion, features of an item assortment, an external event, etc.), a demand may have been forecasted for the item during the time period. Then if the actual sales for the item during the time period are 25% (or another threshold percentage or nominal value) of the forecasted amount (or historical amount), then the synthetic data generator 210 may identify this as an anomaly and as a potential stockout that occurred during the time period.

As another example, the synthetic data generator may compare sales during the time period with sales during one or more other time periods. If the sales during the time period are lower than the sales during the one or more other time periods, this may be detected as an anomaly and a potential stockout. The threshold may be, for example, a nominal amount or a percentage. As an example, if sales for Item A are between 100 to 150 units for a plurality of weeks, and if the sales for Item A are 10 for a certain week, then it may be determined, given that the sales for the week are 10% of a normal range, that an anomaly occurred during that week, which may indicate a stockout event. In some embodiments, other statistical methods can be used to identify anomalies in sales data that may be indicative of a stockout.

In some embodiments, the synthetic data generator 210 may determine a stockout based on a user input. For example, a worker at a location may provide an indication that the example item is out of stock. As another example, a customer may provide feedback indicating that the example item is out of stock. Additionally, when the synthetic data generator 210 identifies a stockout, such as based on derived inventory levels or anomaly detection, the synthetic data generator 210 may provide data corresponding to the identified stockout to a user, who may verify that the stockout occurred. Other techniques for identifying stockouts are likewise possible.

In the example shown, the synthetic data generator 210 may generate synthetic sales data (step 704). There are various techniques that may be used by the synthetic data generator 210 for generating synthetic data for an item that is out of stock. For instance, example techniques for generating synthetic data, which may be used in the context of FIG. 7, are described above in connection with the step 606 of FIG. 6. Additionally, FIG. 7 illustrates additional example techniques that may be used to generate synthetic sales data, as illustrated by the steps of 706-712. In some embodiments, the synthetic data generator 210 may use one or more of the techniques described in connection with steps 706-712 to generate synthetic sales data. In some embodiments, the synthetic data generator 210 may use a combination of techniques for generating synthetic sales data.

In the example shown, the synthetic data generator 210 may use a forecasting model of the forecasting models 222 to generate synthetic data (step 706). In some embodiments, using the forecasting model to generate the synthetic data comprises determining quantities of sales that were most likely to have occurred during the time period given conditions (e.g., a price, location, season, event, trend, promotion, etc.) during that time period. For example, the synthetic data generator 210 may use the forecasting model trained to forecast demand for the example item to predict what the item sales would have been if there had not been a stockout event. For example, the synthetic data generator 210 may use a forecasting model to “backcast” what the sales would have been to generate synthetic sales data. In some embodiments, this may include simply using the forecasted demand for the item as the synthetic sales data. As an example, if it is determined that a stockout event occurred during the second week of March in 2024, the synthetic data generator 210 may use the forecasted demand for the example demand during the second week of March in 2024 as synthetic data.

In the example shown, the synthetic data generator 210 may generate synthetic sales data using sales data of similar items (step 708). For example, the synthetic data generator 210 may identify similar items, and based at least in part on the sales data of the identified similar items, generate synthetic data for the example item. Example aspects of generating synthetic sales data using similar items are described above in connection with steps 604-606 of FIG. 6.

In the example shown, the synthetic data generator 210 may use a Bayesian model to generate synthetic sales data. For example, the Bayesian model may generate synthetic data for the example item based at least in part on sales of the item at other locations, sales of the item during different times from the stockout period, or sales of other items. In some embodiments, the Bayesian model may use other data instead of or in addition to sales data, such as data related to pricing, events, macroeconomic conditions, or other conditions that could have affected sales of the example item. By using such data, the Bayesian model may identify potential volumes of sales for the example item during the stockout period and may identify likelihoods of the potential volumes. In some embodiments, the synthetic data generator 210 may select the sales volumes having a greatest likelihood as part of the synthetic data. In some embodiments, when using a Bayesian approach, the synthetic data generator 210 may use a different model for each item or group of items, thereby advantageously improving, in some instances, the likelihood that the synthetic data accurately represents what sales would have been in the absence of a stockout.

In the example shown, the synthetic data generator 210 may use a neural network to generate synthetic data (step 712). For example, the neural network may be trained to predict a demand for an item based on one or more factors that may influence demand, such as, for example, seasonality, price, location, promotion, trends, holidays, previous sales, or other factors. In such an embodiment, the synthetic data generator 210 may input, into the neural network, conditions that were present during the stockout event of the example item to predict what the demand would have been in the absence of a stockout. In some embodiments, the neural network may be a transformer-based neural network. In some embodiments, when using a neural network, the synthetic data generator 210 may use a common neural network for all items.

In the example shown, the synthetic data generator 210 may modify sales data using the synthetic sales data (step 714). In some embodiments, the synthetic data generator 210 may remove sales data for a time during which a stockout event occurred and replace the removed sales data with the synthetic sales data. For example, the synthetic data generator 210 may identify the time periods that were affected by the time period, such as one or more certain weeks. Then the synthetic data generator 210 may replace only the sales data for those time periods that were affected by the stockout event with the synthetic sales data while leaving other sales data for item unchanged. In some embodiments, the synthetic data generator 210 may supplement the actual sales data with the synthetic sales data without removing actual sales data, even if at least some of the actual sales data may have been affected by a stock out.

In the example shown, the model training system 208 may train the forecasting model for the example item using the synthetic data (step 716), example aspects of which are described in connection with the step 608 of FIG. 6. For example, the model training system 208 may use the sales data 110, which may have been modified to include the synthetic sales data, to train an item-specific demand forecasting model. In some embodiments, training the forecasting model includes using the synthetic data of the sales data 110 and also using data of the sales data 110 that was not synthetically generated, such as sales data during time periods for which no stockout event nor other anomalous events were detected.

In the example shown, the forecasting model may forecast demand (step 718), example aspects of which are described in connection with the step 610 of FIG. 6. Moreover, the forecasting model may process, using parameters that were trained using the synthetically generated sales data for the stockout event, a demand forecasting request to generate a demand forecast that is provided to the requesting application.

In example aspects, there may be various features that may affect demand for an item. An example of such features may include holidays. For example, there may be increased demand for toys during Christmas and turkey during Thanksgiving. As such, demand forecasting models may more accurately forecast demand by accounting for features such as holidays. However, in the case of holidays, not every item is sensitive to every holiday. For example, the demand for flowers may be sensitive to Mother's Day but not to Halloween, and the demand for toothpaste may not be sensitive to any holiday. In some instances, it could be suboptimal to consider every holiday for every item, because doing so could create model instability and noise. For example, a forecasting model could, in some instances, improperly attribute changes of sales of an item to occurrence of a holiday, even if the item is not, in fact, sensitive to the holiday. In some instances, such improper attribution could result in model overfitting issues and degradation of forecasting accuracy.

In example aspects, a feature management system 212 is disclosed that may identify which holidays to consider for which items, thereby generating a list of zero or more holidays that are to be considered when generating demand forecasts for each item. For example, for a given item, with respect to the element 312 of FIG. 3, a forecasting model of the forecasting models 222 may consider the list of zero or more holidays for the item that have been identified as having an impact on demand for the example item.

In example aspects, the feature management system 212 may acquire features of sales and promotions, and a calendar of potentially relevant holidays and pre-holiday time periods. The feature management system 212 may use this data to identify important holidays for each item by modeling and clustering historical sales data. In some instances, items are modeled and clustered separately for seasonal and non-seasonal items within a department.

In example aspects, the feature management system 212 may use one of various techniques for identifying relevant holidays for an item. For example, the feature management system 212 may use a regression model, a clustering model, a different type of model, or a combination thereof. In some instances, for a given item, the results of these techniques are combined to form a list of relevant holidays for an item. In some embodiments, the feature management system 212 may determine a list of relevant holidays for a group of items, such as an item cluster, department, or other category. In some embodiments, the list of relevant holidays is used by one or more of the forecasting model for the item or the model training system 208 used to train the forecasting model for the item. As such, the feature management system 212 may run independently from the forecasting model itself.

Aspects of the feature management system 212 may provide various technical advantages. In some embodiments, by selecting model features that are relevant on an item-by-item basis before performing inference, the forecasting models may not only be more accurate (e.g., by reducing noise associated with irrelevant features), but may also be trained faster (e.g., by training fewer features) and may also generate forecasts faster (e.g., by considering fewer features). Additionally, the feature management system 212 may expand the number of features that can be potentially considered by forecasting models 222. For example, by considering fewer, yet more relevant, holidays for each item, the number of potential holidays that may be considered can be expanded. For example, new holidays or cultural events may be potentially considered, since not every holiday is considered for every item. Yet still, in some embodiments, different features may be considered for different demand channels. For example, a given holiday may increase demand of items sold via the digital platform 106 but not for the retail locations 104, or vice-versa. Furthermore, in some embodiments, region-specific holiday impacts may be identified. For example, demand for an item at a location in a first region may receive an increased demand forecast during a given holiday than demand for that item at a location in a second, different region. As such, one or more of location-specific, region-specific, or channel-specific holiday effects may be identified and used by the forecasting models 222.

Yet still, the feature management system 212 may identify changes in demand pattern effects that may vary across different holidays. For example, changes in demand patterns due to a holiday may be defined as spanning particular weeks or days. The feature management system 212 may determine that different holidays have different time structures when it comes to how they relate to demand. For example, the feature management system 212 may determine that Christmas may cause a multi-week, progressive increase in demand but may not cause any increased demand on the day itself, whereas the Super Bowl may cause an increase in demand on only the day of the event and the day prior. As such, aspects of the feature management system 212 may refine the time periods for holidays to better reflect the holiday impact on demand.

Yet still, the feature management system 212 is not limited to identifying features that are holidays. For example, aspects of the feature management system 212 may also be used to identify which items are sensitive to other events or time periods. As an example, aspects of the feature management system 212 could be extended to identify which items are sensitive to a “back-to-school” time or which items are sensitive to certain weather events.

Yet still, aspects of the feature management system 212 may improve performance of the forecasting models 222 by identifying item-specific features to be considered by the forecasting models 222. Such improvements may include more accurate forecasting because only the most relevant holidays are considered for each item and more potential holidays may be considered. Such improvements may also include faster model execution times because fewer holidays are considered for each item. Other advantages associated with the feature management system 212 are likewise possible.

FIG. 8 illustrates a block diagram of an example architecture of the feature management system 212. In the example shown, the feature management system 212 includes components for selecting features to be considered by the forecasting models 222. As described in connection with FIG. 8, the feature management system 212 may determine holiday features for an example item at an example location. However, as will be understood, the feature management system 212 may determine other features that may impact demand apart from holiday features. Moreover, as will be understood, the feature management system may identify features for a plurality of items, for a plurality of locations, or both a plurality of items across a plurality of locations.

The feature data generator 802 may generate a plurality of features for the feature selection process or may process time series data such that it can be used to identify features for the features selection process. The plurality of features may include potential features that may be included in demand forecasting models, such as the forecasting models 222. In some embodiments, the plurality of features includes only a subset of features of the forecasting models 222. For example, the plurality of features may include features whose relevance varies by a relatively large degree across items. For such features, it may be useful for model accuracy and speed to only include the features that are sufficiently relevant for an item, rather than including all such features. For example, a forecasting model for a toy may be improved by considering a holiday feature associated with “Christmas”, whereas a forecasting model for bananas may not be improved, and in fact may be made worse, by considering a feature associated with a “Christmas” holiday. The utility from a model accuracy and speed perspective of such a feature may vary greatly between forecasting models. In some embodiments, the plurality of features include only fixed effects of a GAMM model, such as the fixed effects shown in connection with FIG. 3. Accordingly, different fixed effects may be selected for different forecasting models while a common set of other features, such as smooth terms, random effects, and other fixed effects may be included across forecasting models, although the weights and applications of such other features may vary across models due to model-specific training processes. In some embodiments, the plurality of features from which sets of features are to be selected include a certain type of fixed effects, such as holidays.

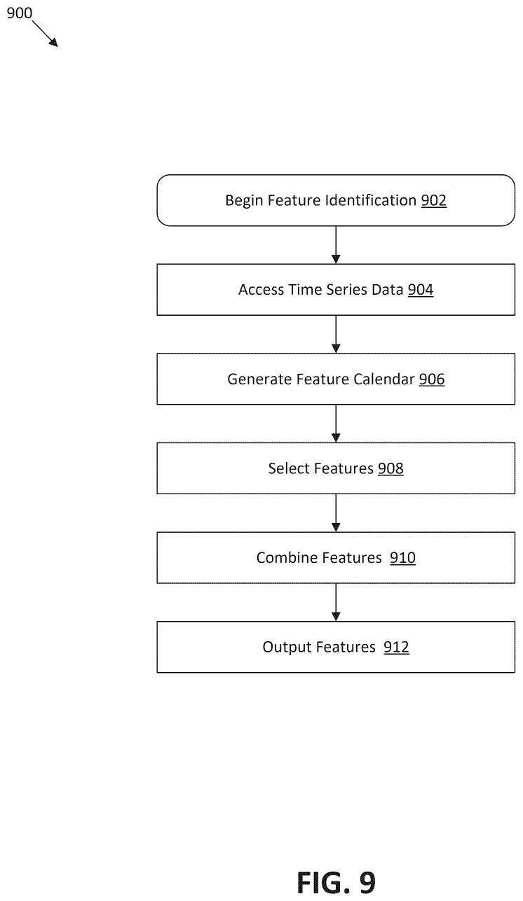

As shown, the feature data generator 802 may receive sales data 110 for the example item. Furthermore, the feature data generator 802 may receive item data 108 for the example item, such as an item profile or item attributes. Furthermore, the feature data generator 702 may receive forecast data 112. In some embodiments, the feature data generator 802 may perform scrubbing, imputation, or other adjustments to input data. In some embodiments, the feature data generator 802 may aggregate time series data across a plurality of items or locations, such that group-level or region-level features for a forecasting item may be identified. In some embodiments, the feature data generator 802 may apply the forecasting model 222. In some embodiments, the feature data generator 802 may perform aspects of the method 900 of FIG. 9.

The feature calendar generator 804 may generate a calendar of times during which a feature is applied. The features may correspond to the potential features that are generated or identified by the feature data generator 802. In some embodiments, the calendar may include a multi-dimensional array that maps a feature to a time period. During a feature's associated time period, it may be active and applied to by a forecasting model of which the feature is part. Outside of the feature's associated time period, the feature may not be active, and therefore may not be applied by a forecasting model, even if the feature is part of the forecasting model. In some embodiments, when a forecasting model includes a feature with an associated time period corresponding to a feature calendar, the forecasting model may use a flag to determine whether the feature is active. For instance, for a time-based feature, the forecasting model may check the corresponding flag. If the flag is active, the forecasting model may use the feature when forecasting demand; if the flag is not active, the forecasting model may not use the feature when forecasting demand.

As an example, the feature calendar generator 804 may generate a calendar of holidays. In some embodiments, the feature calendar generator 804 may generate a calendar that represents overlapping holidays. In some embodiments, the feature calendar generator 804 may generate holidays that can be represented as a binary (i.e., the holiday is occurring, or it is not) or as a magnitude (e.g., the effect of a “Christmas holiday” may be lower on December 22^{nd} than December 23^{rd}). Moreover, the feature calendar generator 804 may define a holiday as spanning a day, week, or another granularity of time that captures the days for which the holiday may have an effect. In some embodiments, the feature calendar generator 804 may generate a custom feature calendar for each item or for each item-location combination. In some embodiments, the feature calendar generator 804 generates a calendar of potential holidays, and the potential holidays are customized on an item-by-item basis using the feature selectors 806 and the feature combiner 812.

The feature selectors 806 may determine which features, such as holidays, to consider for an item. In some embodiments, there may be one or more feature selectors that may be used by the feature management system. In the example shown, the feature selectors 806 include a regression model 808, a machine learning model 809, and a clustering model 810. In some embodiments, the feature selectors 806 may include additional items. In some embodiments, the feature selectors 806 may receive data from the feature data generator 802 and the feature calendar generator 804. For example, the feature selectors 806 may receive one or more of time series data from the feature data generator 802, such as sales data or forecast data, or a list of potential features to select for models. Additionally, the feature selectors 806 may receive a feature calendar from the feature calendar generator 804. In some embodiments, the feature selectors 806 may identify relevant features on an item-by-item basis. In some embodiments, the feature selectors 806 may use time series data for a group of items that includes a selected item to identify group-level features. For example, the regression model 808, machine learning model 809, and the clustering model 810 may each use this aggregated time series data to determine features that are applicable for a group, and these group-level features may be included in a set of features for an item.

The regression model 808 may be used to identify the impact of features in the sales data 110, in sales data as refined by the feature data generator 802, or in demand forecasts, or demand forecast as refined by the feature data generator 802. In some embodiments, the regression model 808 includes a plurality of possible models and may execute a plurality of possible techniques for identifying feature importance. In some embodiments, the regression model 808 includes the machine learning model 809.

In some embodiments, the regression model 808 may perform one or more of a forward, backward, stepwise, or subset variable selection process. In some embodiments, the regression model 808 is a linear regression model that uses historical sales data or forecast data to identify relevant holidays for an item. The historical sales data, or a model trained using the historical sales data, may be decomposed. For example, the sales data may be decomposed to remove all variables that impact the time series data except for a set of potential features from which the feature selectors 806 are selecting features. As an example, decomposing the time series data may include removing effects such as long-term trends, pricing promotions, and other non-holiday effects. Additionally, seasonal effects and seasonal items may also be removed. As a result, the time series data may be converted such that it only reflects the effects of holidays and noise. Then, by comparing this decomposed sales data to the calendar of holidays from the feature calendar generator 804, it can be determined which holidays are responsible for the changes in demand for the item.

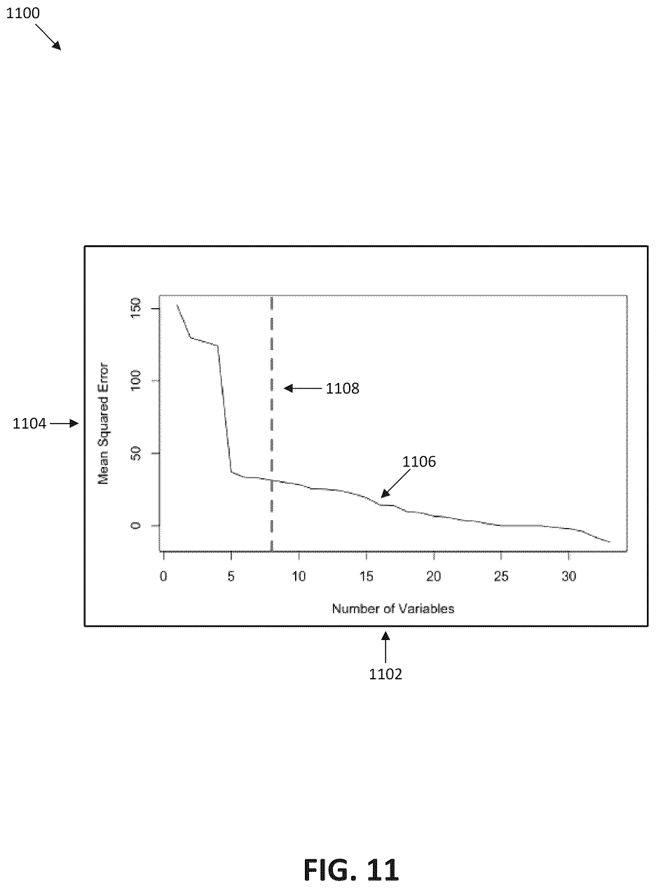

In some embodiments, the regression model 808 is a LASSO model and may shrink the coefficient of some features to zero, as controlled by lambda. In some embodiments, the LASSO model may fail if there is insufficient historical data for an item, or if the item is a slow seller with sparse sales data. In this case, a random forest algorithm may, in some embodiments, be used. The random forest algorithm may be an example of the machine learning model 809. In some embodiments, the random forest algorithm measures each feature by the percent increase in mean squared error if consideration of that feature is removed from the model. The features are then ranked by importance, and the features that may be selected are those that occur prior to an elbow in an importance curve, as shown, for example, in the example of FIG. 11.

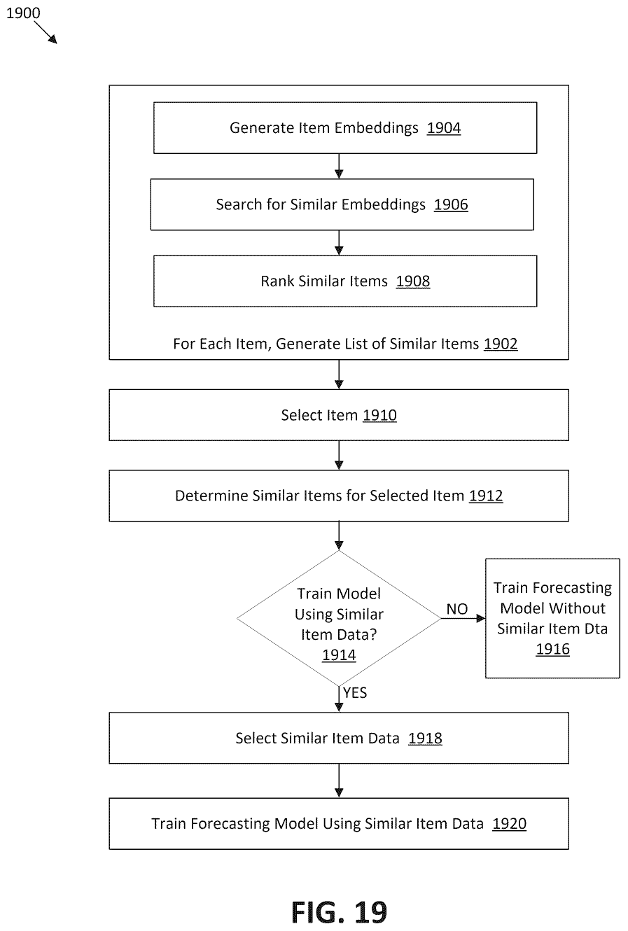

The clustering model 810 may identify features for a group of items. A group of items may be, for example, two or more items that share a common attribute. Sharing a common attribute may include belonging to a common department, class, or other pre-defined category of items. Other example techniques for determining a group of items are described at least in connection with the step 604 of FIG. 6 and in connection with FIG. 18-19. As such, if a particular item belonging to a group of items does not itself have sufficient historical sales data, a relevant feature for that item may nevertheless be identified if it belongs to a group of items that are sensitive to that feature. In some embodiments, normalized descriptive metrics for feature mean and standard deviations are calculated, and this data may be clustered. In some embodiments, a threshold parameter is applied to the clustering results, and the list of holidays with values exceeding it may be considered relevant features for the group of items. In some embodiments, clustering may be performed separately for seasonal and non-seasonal items. In some embodiments, seasonal items are sold only for a certain duration during the year. Excluding seasonal items from non-seasonal items before any clustering is performed can improve forecasting results. In some embodiments, an item may be considered non-seasonal if sold in more than ten stores for at least twenty-six weeks.

The feature combiner 812 may receive features from the feature selectors 806 that have been identified as important for the example item. In some embodiments, the feature combiner 812 performs a union of the features identified by different feature selectors 806. Additionally, in some embodiments, the feature combiner 812 may combine features identified by different passes of a single feature selector 806 using different data, such as item-specific time series data and aggregated time series data. In some embodiments, the feature combiner 812 selects a number of most important features identified by the feature selectors 806, where importance may correspond to degree of impact on a demand forecast. After selecting features, the feature management system 212 may provide the selected features to the forecasting model 222 or the model training system 208 to be included as part of the forecasting model for the example item. In some embodiments, the feature management system 212 may store the features as part of an item profile for the example item in the item data 108.

FIG. 9 is a flowchart of an example method 900 for determining model features. Although operations of the method 900 are described as being performed by the feature management system 212, one or more other components may perform operations of the method 900. Furthermore, although operations of the method 900 are described in connection with determining holiday features for an example item at a location, the method 900 may be extended to determining non-holiday features, for a plurality of items, or across a plurality of locations.

In the example shown, the feature management system 212 may begin a feature identification process (step 902). Beginning the feature identification process, which may include the steps 904-910 of FIG. 9, may occur as part of a scheduled process for identifying or updating features of the forecasting models. In some embodiments, the feature management system 212 may perform the feature identification process as part of updating forecasting models 222. The feature management system 212 may also begin the feature identification process for each new forecasting model, which may be created for each new item. In some embodiments, the feature management system 212 may periodically reperform the feature identification process. In some embodiments, the feature management system 212 may perform the feature identification process simultaneously for a plurality of items.

In the example shown, the feature management system 212 may access time series data (step 904). For example, the feature management system 212 may access time series data corresponding to an item or group of items for which a forecasting model is being generated. The time series data may include one or more of historical sales data, synthetic sales data, or forecasting data. For example, if the feature management system 212 is selecting features for an item-specific forecasting model, then the time series data may include sales data or forecasting data for that item. In addition, the feature management system 212 may also access item data for the item, such as data of the item data 108.

In the example shown, the feature management system 212 may generate a feature calendar (step 906), example aspects of which are described in connection with the feature calendar generator 804 of FIG. 8.

In the example shown, the feature management system 212 may select features for the example item (step 908). Selecting, or identifying, features for the example item may include analyzing the time series data for the item and analyzing a feature calendar. Depending on the embodiment, the feature management system 212 may use various selection approaches and models to identify features. Example techniques include applying one or more of the models 808, 809, or 810 in combination with a threshold value corresponds to feature relevance. The threshold value may be a number of features to be selected. For example, the threshold value may be five, which may indicate that the five features of a plurality features that are most predictive of item demand are selected, where different techniques may be used to determine how predictive of demand a given feature is, as described in connection with the models 808-810 and as described below. As another example, the threshold value may be a requirement of how predictive of demand a given feature is to be included as part of the forecasting model. If the predictive value of a given feature is greater than the threshold value, it may be selected; if not it is not, it may not be selected.

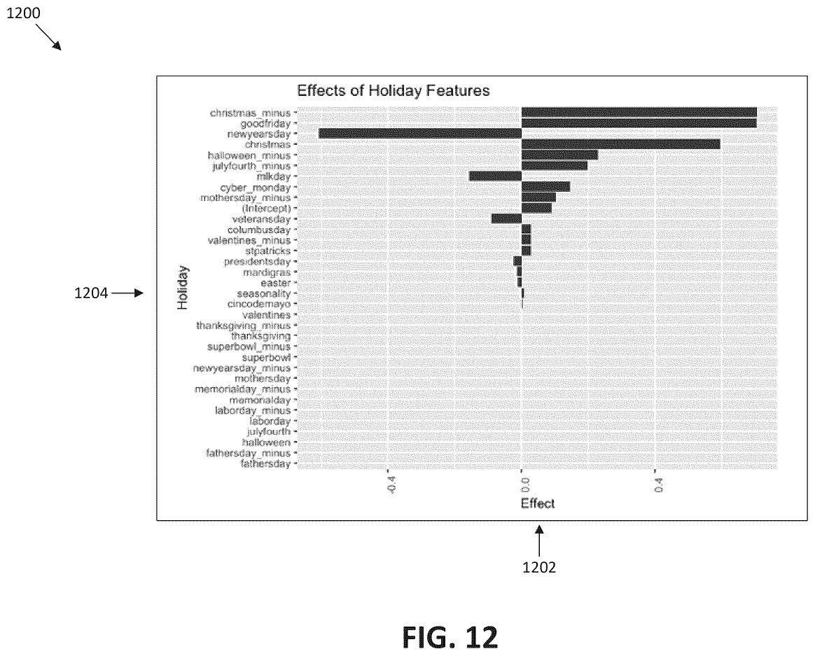

Analyzing the time series data and feature calendar may include building multiple item-chain models with selected holidays removed and comparing the goodness-of-fit of these models while penalizing the model for over-fitting. A In some embodiments, models may be compared, and therefore features may be compared to one another and to a threshold value, by using Akaike Information Criterion (AIC). In some embodiments, as part of selecting features, the feature management system 212 may measure forecast performance of various models (e.g., random forest, XGBoost, LASSO, or other models) to determine the importance of particular features in the prediction of demand for the example item. Furthermore, the feature management system 212 may test identified holiday features in a linear and GAMM models using various feature selection methods (forward, backward, stepwise and best subsets) to select the best model. By performing such a selection method, the features may be ranked, and the top X number of features may be selected, where X may correspond to a threshold value of number of features of a plurality of features to include in the forecasting model. Furthermore, the feature management system 212 may perform multiple passes to identify features of a plurality of features for a given model. For example, first item-specific features may be identified and then group-level features may be identified for a group of items that include the item. Item-specific features may be features that are identified at an item level, as opposed to a group level. Different items may share certain item-specific features, such as two items including a certain fixed effect, like a certain holiday. Additional example aspects of steps 908 are described in connection with the feature selectors 806 and feature combiner 812 of FIG. 8, and in connection with FIG. 11-12.

In the example shown, the feature management system 212 may combine features for the example item (step 910). For example, the feature management system 212 may combine features from multiple passes of feature identification for the forecasting model or may combine features from different feature selectors. In some embodiments, the feature management system 212 may determine whether to use item-specific features for the example item or to use group-level features for the example item. For example, holiday features may be determined at an item level using one or more of the regression model 808 or the machine learning model 809 and at a group level by using the clustering model 810. As another example, the regression model 808 may determine item-specific features using first time series data and may determine group-level features using aggregated time-series data.

In some embodiments, item-specific features may be determined if sufficient data is available. For example, the feature management system 212 may attempt to apply one or more of the feature selectors 806 to the item-specific time series data, and if the feature selectors fail to identify relevant features, then it may be determined that the time series data is insufficient. As another example, it may be determined that the time series data is insufficient if the item has been sold for less than least two years. Other examples of determining whether the time series data is sufficient to identify item-specific features are described in connection with step 602 of FIG. 6.

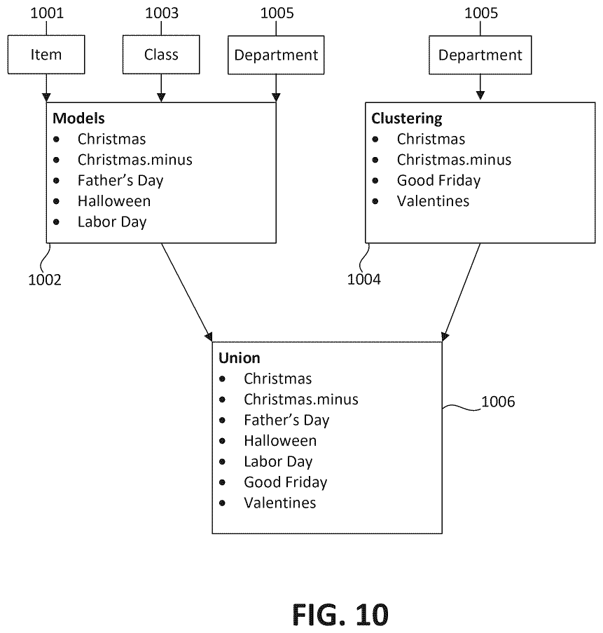

In some embodiments, selecting features at the item level may enable detection of intra-group nuances for how different items of a group may be sensitive to features. Therefore, in some embodiments, if there is sufficient data to identify features at an item level, then item-specific features will be used. If sufficient data is not available, however, then group-level features may be used. In other embodiments, a combination of item-specific features and group-level features may be used. Example aspects of combining features are described in connection with the feature combiner 812 and in connection with FIG. 10.

In the example shown, the feature management system 212 may output features (step 912). Outputting the features may include updating a forecasting model, such as by modifying one or more files associated with the forecasting model, such that the model includes the features identified for the forecasting model during the steps 910-912. The forecasting model may then be trained using the identified features and use the trained features as part of generating demand forecasts.

Although aspects of the method 900 of FIG. 9 were described in connection with identifying features for an example item, the method 900 may be used to determine features for a plurality of different items. For example, the method 900 may be used to identify features for a first item-specific forecasting model, a second item-specific forecasting model for another item, or additional forecasting models, such as chain or group-level forecasting models, location-specific forecasting models, channel-specific forecasting models, or combinations of such models. As a result, different forecasting models may include different sets of features of a plurality of features. For example, one forecasting model may include more features from a plurality of features than another model. For instance, a first item-specific forecasting model may include eight fixed effects associated with holidays, whereas a second item-specific forecasting model may include six fixed effects associated with holidays. Additionally, although there may, in some instances, be overlap between sets of features for different items (e.g., forecasting models for different items may include a common “Christmas” fixed effect), one forecasting model may include a fixed effect that is not present in another forecasting model, and vice-versa.

FIG. 10 illustrates a schematic diagram of determining holidays for an example item 1001. As an example, the item 1001 may be a particular type of a candy with a particular size, such as a 10-ounce bag of Peanut M&M's. In the example shown, the item 1001 may belong to a class 1003, which may be a group of items that includes the item 1001. Moreover, the class 1003 of items may belong to a department 1005 of items, which may be a group of items that includes the class 1003 and one or more additional classes of items. In an example, the hierarchy of the item 1001, class 1003, and department 1005 is part of a hierarchical categorization of items in a retail catalog. In the example of FIG. 10, the feature management system 212 may determine three sets of holiday features, the features 1002, the features 1004, and the features 1006.

As an example, the feature management system 212 may apply one or more of the regression model 808 or the machine learning model 809, along with a threshold value, to determine the model features 1002. In some embodiments, although the model features 1002 are determined based at least in part using data associated with one or more of the class 1003 or department 1005, the model features 1002 may also be determined at least in part using item data that is specific to the item 1001. In the example shown, the feature management system 212 may determines that the holidays of Christmas, Christmas. minus, Father's Day, Halloween, and Labor Day, are sufficiently important holidays for the item 1001. Each of these holidays may correspond to one or more dates in a feature calendar, as described in connection with the feature calendar generator 804. The holiday of “Christmas.minus” may represent, for example, a day or a week prior to the Christmas holiday.

In the example shown, the feature management system 212 may apply the clustering model 810 to determine the clustering features 1004. The clustering features 1004 may represent relevant holidays for the department 1005, which includes the item 1001. In the example shown, the clustering features 1004 include Christmas, Christmas. minus, Good Friday, and Valentines.

In the example shown, the feature management system 212 may combine the features 1002 and 1004. For example, the feature management system 212 may apply the feature combiner 812 to combine the features 1002 and 1004. In the example shown, the feature management system may take a union of the features 1002 and 1004, resulting in a list of holiday features that includes holidays from each of the features 1002 and 1004. In some embodiments, the feature management system 212 may combine the features 1002 and 1004 in a different manner, such as by selecting only features that occur in both of the features 1002 and 1004 or selecting features from the features 1002 and 1004 that have a sufficiently high impact on demand. In some embodiments, the forecasting model for the item 1001 may use the features 1006 when forecasting demand for the item 1001.

FIG. 11 illustrates an example diagram 1100 depicting an example representation of an example technique for identifying feature importance, which may correspond to a feature's impact on a demand forecast. In the example shown, a tree-based method (e.g., a random forest) is used for its by-product of feature importance shown in the diagram 1100. The x-axis 1102 of the diagram represents a number of variables (e.g., a number of holidays considered by a forecasting model). The y-axis 1104 represents a mean squared error (MSE) of the forecasting model. The line 1106 represents the mean squared error of the forecasting model with respect to the number of variables. The dashed line 1108 represents a cut-off point. In the example shown, the cut-off point is 8. The cut-off point may correspond to a threshold value used to identify features.

Using data depicted by the diagram 1100, each feature used in the forecasting model is measured by the percent increase in MSE if it is removed from the model. The most important variables may have the highest metric (e.g., may be represented by the variables on the left-hand side of the diagram 1100). In the example shown, the 8 features represented by the number 1-8 may be identified as sufficiently important for the item demand that is being forecasted to be included in the forecasting model. In some embodiments, data such as the data depicted by FIG. 11 may be used in combination with data like the data depicted by FIG. 12.

FIG. 12 illustrates an example diagram 1200 depicting holiday feature importance. In some embodiments, data of the diagram 1200 may be determined by applying one or more of the feature selectors 806 for an example item. The x-axis 1202 of the diagram 1200 represents a degree of an effect on demand for the example item based on a holiday. The y-axis 1204 represents a plurality of potential holidays to consider for the example item. In the example shown, the holidays are listed in order based on the magnitude of effect. For example, as shown, the holiday “christmas. minus” has the greater effect on demand for the example item. As shown, some relevant holidays may increase demand for the example item (e.g., “christmas.minus”), whereas other relevant holidays may decrease demand for the example item (e.g., “new year's day”).

In some embodiments, the feature management system 212 may select the top X most impactful holiday features to consider when forecasting demand for the example item, an example of which is described in connection with the diagram 1100 of FIG. 11. For example, if the feature management system 212 selects the top three holidays having the greatest impact, then in the example of FIG. 12, the feature management system 212 may select “christmas.minus”, “good friday”, and “new year's day.” In some embodiments, the feature management system 212 may select all holidays that have a sufficiently large effect on demand. For example, if the feature management system 212 selects all items having an effect of at least 0.4, then the feature management system may select “christmas.minus,” “good friday”, “new year's day,” and “christmas”. Other variations for selecting relevant features are likewise possible.

In example aspects, a hyperparameter may be a parameter that influences the output or operation of a model but is not itself a parameter of the model. In the context of demand forecasting models, an example hyperparameter may be whether a model considers a particular factor, such as a “seasonality” factor, and the weight given to such a factor. In some instances, some hyperparameters may be optimal in the context of some items but not others. For example, considering individual item seasonality may improve forecasting accuracy for a grocery department but not for a beauty department.

In example aspects, a hyperparameter tuning system 214 may optimize hyperparameters for groups of items. In some embodiments, the hyperparameter tuning system 214 may use Bayesian hyperparameter optimization to find optimal hyperparameters within a search space. The Bayesian optimization may enable identification of which hyper parameters have greater or lesser importance. In some embodiments, hyperparameters identified as more important may then be analyzed to determine whether a default value or an optimized value should be used. For example, a grid of all options of hyperparameter combinations (default and optimized for each hyper parameter determined to be important) may be created, and the overall objective may be assessed for each option combination.

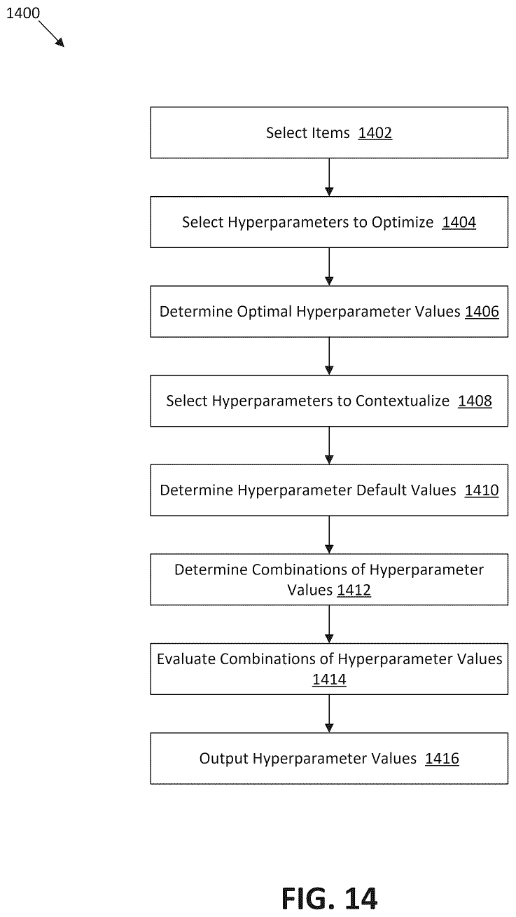

As described further in connection with FIG. 13-14, the hyperparameter tuning system 214 may, in some embodiments, generally use two operations for identifying hyperparameters and their corresponding values. For example, the hyperparameter tuning system 214 may identify a set of optimal hyperparameters for a department of items. Continuing with the example, the hyperparameter tuning system 214 may then create groups of items in the department, and for each group of items, assign a set a of hyperparameter values.

Aspects of the present disclosure related to the hyperparameter tuning system 214 may provide various technical advantages. For example, selecting and tuning hyperparameters using aspects of the hyperparameter tuning system 214 has shown to result in an average accuracy improvement of 3-4%. Furthermore, the hyperparameter tuning system 214 may enable the forecasting models 222 to more accurately predict sales of highly seasonal products with limited life spans. Furthermore, the hyperparameter tuning system 214 may efficiently select appropriate hyperparameters for groups of items, even if different items within the group have different optimal hyperparameters. It can be difficult to select appropriate hyperparameters efficiently for each group of items. Yet still, the hyperparameter tuning system 214 is not specific to any particular hyperparameters. As such, it may be extended to include additional or different hyperparameters. As will be appreciated, these are only some of the advantages provided by aspects of the hyperparameter tuning system 214.

FIG. 13 illustrates an example architecture of the hyperparameter tuning system 214. In the example shown, the hyperparameter tuning system 214 includes a hyperparameter optimizer 1302, a hyperparameter contextualizer 1304, and hyperparameter default values 1306. In some embodiments, the hyperparameter tuning system 214 may be turned on and off by a user, and a user can override an output of the forecasting model. As such, even if the tuned hyperparameter values determined by the hyperparameter tuning system 214 are not used for a given forecast or forecast model, the technology can store the following forecasts: (1) a forecast from the demand forecasting model without tuned hyperparameters; (2) a forecast from the demand forecasting model with tuned hyperparameters; and (3) a user override forecast.

The hyperparameter optimizer 1302 may receive item data 108, sales data 110, and forecast data 112. In some embodiments, for a group of items, such as a department of items, the hyperparameter optimizer 1302 may identify hyperparameters of forecasting models that forecast demand for the group of items. Moreover, the hyperparameter optimizer 1302 may determine optimal values for the identified hyperparameters. Example operations that may be performed by the hyperparameters optimizer may include the steps 1404 and 1406 of FIG. 14, which are further described below.

The hyperparameter contextualizer 1304 may receive identifications of hyperparameters and their corresponding optimal values as determined by the hyperparameter optimizer 1302. In some embodiments, the hyperparameter contextualizer 1304 may also receive hyperparameter default values 1306. In some embodiments, whereas the hyperparameter optimizer 1302 determines optimal hyperparameter values for a group of items, such as a class or department, the hyperparameter contextualizer 1304 may determine, on a more granular level, whether to use a group-level optimal value or default value for each of a plurality of hyperparameters. In some embodiments, the hyperparameter contextualizer 1304 may perform steps 1408-1412 of the method 1400, which are further described below.

The hyperparameter default values 1306 are values for the hyperparameters that may be different from the values determined by the hyperparameter optimizer 1302. In some embodiments, the hyperparameter default values 1306 are the hyperparameter values that are used prior to performing a hyperparameter tuning process. In some embodiments, the hyperparameter default values 1306 are input by a user and as such, may represent knowledge regarding the demand forecasts and the forecasting models 222 that may not be accessible to the hyperparameter optimizer 1302.

FIG. 14 is a flowchart of an example method 1400 for identifying and tuning hyperparameters. Although aspects of the method 1400 are described as being performed for an example group of items, the method 1400 may be applied to a plurality of groups of items and a plurality of items across an item catalog. Although aspects of the method 1400 are described as being performed by the hyperparameter tuning system 214, other components may also perform operations of the method 1400.

In the example shown, the hyperparameter tuning system 214 may select items (step 1402). For example, the hyperparameter tuning system 214 may select a department of items, which may be associated with one or more forecasting models of the forecasting models 222. The hyperparameter tuning system 214 may identify and tune hyperparameters for these one or more forecasting models. In some embodiments, the selected items may be identified by a user. In some embodiments, the one or more models for the selected items may be experiencing a poor forecasting performance. In some embodiments, the hyperparameter tuning system 214 may be scheduled to periodically update hyperparameter values for groups of items.

In the example shown, the hyperparameter tuning system 214 may select hyperparameters associated with the one or more forecasting models (step 1404). For example, a given forecasting model may include a plurality of hyperparameters. A hyperparameter may indicate whether a potential factor is considered by the forecasting model and may include a weight given to the factor. From the potential hyperparameters, the hyperparameter tuning system 214 may select one or more hyperparameters to be optimized. Depending on the embodiment, different hyperparameters may be used. Example hyperparameters include the following: whether each item has its own seasonality; whether each item has its own trend; a residual parameter that decides the responsiveness of forecasts to week-over-week variations; demand elasticity; an intercept value or how an intercept value is determined; a pre-processing parameter, or a post-processing parameter. Other hyperparameters are likewise possible.

In the example shown, the hyperparameter tuning system determine optimal values for the selected hyperparameters (step 1406). The optimal values may be the values that optimize an objective function, such minimizing a difference between a forecasted demand and an actual demand, when forecasting demand across the selected items. In some embodiments, to perform the optimization, the hyperparameter tuning system 214 may use an exploration-exploitation algorithm. For example, the hyperparameter tuning system 214 may execute experiments using different values for the selected hyperparameters to determine a quality of the values and to generate information that can be used to select hyperparameter values for subsequent experiments. In some embodiments, the hyperparameter tuning system 214 may use a Bayesian hyperparameter optimization algorithm. This algorithm may produce optimal values for the selected hyperparameters for the department of items.

In the example shown, the hyperparameter tuning system 214 may select hyperparameters to contextualize (step 1408). For example, the hyperparameter tuning system 214 may select hyperparameters that most impact demand forecasts. For example, the hyperparameters that most contribute to the objective value be selected. In some embodiments, the hyperparameters may be selected from the group of hyperparameters for which optimal values were determined (e.g., at the step 1406), and the degree of importance of a given hyperparameter may be determined while determining the optimal hyperparameter values.

In the example shown, the hyperparameter tuning system 214 may determine hyperparameter default values (step 1410). For example, the hyperparameter tuning system 214 may retrieve the hyperparameter default values 1306 of FIG. 13.

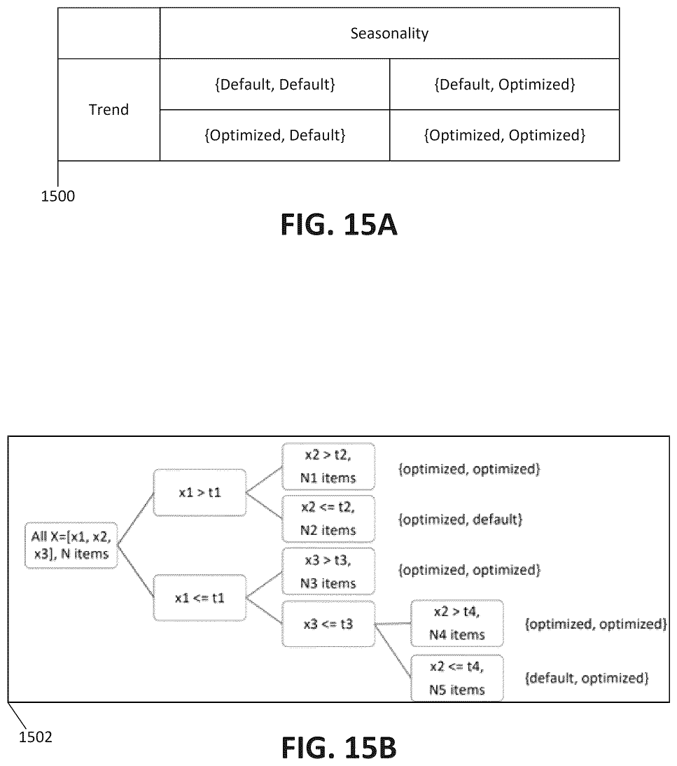

In the example shown, the hyperparameter tuning system 214 may determine combinations of hyperparameter values (step 1412). For example, using the identified most important hyperparameters, the hyperparameter tuning system 214 may create sets of possible combinations for the default and optimal values for these hyperparameters. The default values may be the values determined at the step 1410, and the optimal values may be the values determined at the step 1406. An example of combinations of hyperparameters determined by the hyperparameter tuning system 214 is illustrated in the example of FIG. 15A.

In the example shown, the hyperparameter tuning system 214 may evaluate the combinations of hyperparameter values for the selected items (step 1414). For example, the hyperparameter tuning system 214 may group items of the selected items and determine, for each item group, whether to apply an optimal or default value for the evaluated hyperparameters. For example, referring to the diagram 1500 of FIG. 15A, the hyperparameter tuning system 214 may determine which of the four quadrants (i.e., which of a combination of default or optimal hyperparameter values) are to be applied to each item of the selected items.

For example, for each item in the selected items, the hyperparameter tuning system 214 may evaluate the objective function for each combination of hyperparameter values. For example, to evaluate the objective for the cell of {default, optimized} of the diagram 1500 of FIG. 15A, the default value of item trend responsiveness and the optimized value for residual parameter may be used, and when used, the forecasting error is calculated to determine an objective value for an item for that cell.

Furthermore, for every item of the selected items, the hyperparameter tuning system 214 may create a vector Y of evaluated objectives across all combinations of hyperparameter values and fit a multivariate regression tree to explain Y with important item-level features X. The features X may include features that are deemed to be important for grouping items, such as belonging to a particular class or having a particular attribute. In some embodiments, the regression tree that is used is a machine learning model that learns how to group the items of the department based on the identified features X and the values Y of evaluated objectives across the combinations on the grid, as described further in connection with FIG. 15B. For each group identified by the regression tree, the hyperparameter tuning system 214 may pick the combination of the grid having the hyperparameter setting with the maximum (or minimum, in some embodiments) average objective.

In the example shown, the hyperparameter tuning system 214 may output hyperparameter values (step 1416). For example, once the hyperparameters for groups of items are determined, the hyperparameter tuning system 214 may provide these hyperparameters to a main forecasting model, such as the forecasting models 222 for use when generating demand forecasts. In some embodiments, the hyperparameter tuning system 214 may provide the hyperparameters to the model training system 208 for use when training the forecasting models 222. In some embodiments, the hyperparameter tuning system 214 may store the hyperparameters.

FIG. 15A illustrates a diagram 1500 depicting example hyperparameter combinations. In the example shown, the diagram 1500 shows two example hyperparameters: seasonality and trend. Seasonality may be whether and to what extent an item demand is sensitive to changes in times of a year. Trend may be whether and to what extent an item demand is sensitive to recent changes (e.g., within the last one, two, or three weeks) in the item demand. Other hyperparameters are likewise possible. In the example shown, the hyperparameter tuning system 214 may have determined default and optimized values for each of seasonality and trend. Therefore, the hyperparameter tuning system 214 may determine whether to apply a default or optimized value for each of seasonality and trend to groups of items. As would be appreciated by those having skill in the art, if there are more hyperparameters to be evaluated for a certain group of items, there may be more combinations of default and optimized values that are to be evaluated. For example, if there are three hyperparameters to evaluate, then there may be eight combinations of default and optimized values to evaluate, if there are four hyperparameters to evaluate, then there may be sixteen combinations to evaluate, and so on.

FIG. 15B illustrates an example tree 1502 for determining which combination of hyperparameter values depicted in the diagram 1500 to apply to each subgroup of items for a group of items. For example, the tree depicts a group of N items, which may be, for example, a class, department, catalog, or other group of items. For the group of N items, the hyperparameter tuning system 214 may have determined that the hyperparameters of trend and seasonality will be contextualized, such that, for subgroups of the N items, different values (e.g., a default or optimized value) of the hyperparameters of seasonality and trend may be applied.

Moreover, the hyperparameter tuning system 214, or an administrator or engineer associated with the forecasting system 102, may have determined attributes X according to which the N items are to be divided into subgroups. The attributes X may be item attributes, as described further, for example, in connection with the item data 108 of FIG. 1. As shown by the leaves of the example tree 1502, the hyperparameter tuning system 214 may have separated the items N into 5 subgroups. For each of the subgroups, the hyperparameter tuning system 214 may then evaluate the combinations of hyperparameter values of the diagram 1500 to determine which hyperparameter values are to be used when forecasting demand for items within each of the identified item subgroups of N1-N5.

In some instances, when there is a promotion for an item, it may be expected that the sales for that item will increase. However, it may be challenging to determine the extent of that increase. For example, there are different types of promotions, and the effects of different promotions may vary. Moreover, some items are more sensitive to promotions than other items because some items may be more sensitive to price changes than others. As such, it can be challenging to accurately forecast the effects of promotions on demand.

In example aspects a promotion system 216 determines an impact on a demand forecast for an item based on a promotion. For example, referring to the example of FIG. 3, when forecasting item demand, the promotion system 216 may determine a value for the promo lift factor 310. In some embodiments, when the promo lift is applied, it may increase the demand forecast for an item at a location. The promo lift factor may include a combination of an elasticity element and a price effect element.

In example aspects, for the elasticity element, the promotion system 216 may determine, on an item-by-item basis, a price elasticity, or a sensitivity to a price change, for the demand of an item. Elasticity may vary across items. For example, the demand for some items may be more sensitive to price changes than the demand for other items. For example, demand for luxury goods, such as snacks, may be more sensitive to price changes than demand for other goods, such as medicine. To determine an elasticity effect for an item, the promotion system 216 may use a demand curve model, which may be based on results of previous promotions or other price changes. In some embodiments, the greater the elasticity for an item, the greater the impact a promotion may have on demand.

In example aspects, for the price effect element, the promotion system 216 may determine a price change for an item due to a promotion. The price change may be the difference between the promotion price and a regular price. However, in some embodiments, given that some promotions have requirements, or are not available to all customers, the price change for a promotion may, in some instances, be different than a difference between a regular price and a promotion price. For example, the price change may vary depending not only on the discount amount but also on the redemption rate for the promotion. In some embodiments, the redemption rate may correspond to the percentage of item sales that receive the promotion price.

In example aspects, there may be various types of promotions. In some instances, the redemption rates may vary across different types of promotions. As such, in some embodiments, a price effect may vary across different types of promotions and the impact on demand may vary across different types of promotions.

In example aspects, the price effect for a given promotion includes its discount value and redemption rate. For example, if promotion X has a redemption rate of 50% and if the discount for promotion X is 10%, then the price effect for the promotion may be 5%. For each item to which the promotion applies, the price effect may be combined with the elasticity effect for the item to determine the promotional lift. For example, the elasticity for item Y may indicate that the demand for item Y increases by 1% for every 2.5% price decrease. If, for example, promotion X applies to item Y, then the demand boost for item Y due to promotion X may be 2% (a 1% increase for every 2.5% decrease in demand).

In example aspects, the promotion system 216 may perform additional operations associated with promotions. For example, the promotion system 216 may account for a demand increase caused by no discount promotions, which may be an advertisement. In some embodiments, the promotion system 216 may determine an effect of stacked promotions, such as a 10% member-only promotion for all items combined with a BOGO promotion for a particular item. In some embodiments, the promotion system 216 may account for a cannibalization effect. For example, if item X is on promotion and item Y is not on promotion, then a demand for item Y may decrease, because customers may purchase item X instead of item Y. In some embodiments, the promotion system 216 may account for a way in which a promotion is transmitted. For example, a promotion that is mailed to customers may have a different impact than the same promotion that is provided to customers in a circular. As will be understood, these are only some of the features that may be enabled by use of the promotion system 216.

FIG. 16 illustrates an example architecture of the promotion system 216. In the example shown, the promotion system 216 includes promotions 1602, redemption rate calculator 1604, price change calculator 1606, and elasticity models 1608. In some embodiments, the promotion system 216 may receive data from one or more other components described in connection with FIG. 1 or 2, such as, for example, item data 108, sales data 110, or forecast data 112, and the promotion system 216 may use such data as part of determining an impact of promotions on a demand forecast. The promotion system 216 may include more or fewer components than those described in connection with FIG. 16.

The promotions 1602 may include data corresponding to promotions. The promotions 1602 may include data for past, current, and future promotions. In some embodiments, each promotion may be associated with a promotion type, a discount, an item or group of items, a time, a location or group of locations, a channel, an advertisement mechanism, and other data.

In some embodiments, there may be various types of promotions. An example promotion type is a price-based offer. A price-based offer may be a discount, such as 10% off an item. In some embodiments, to qualify for a price-based offer, the customer may only need to purchase the item. Another example promotion type is a basket promotion. A basket promotion may require a customer to take an additional purchasing action to receive the promo. There may be various types of basket promotions, such as a buy-one-get-one (BOGO) promotion (e.g., “Buy 1 Get 1 50% off”), mandated multiples (“Buy 3 and receive $2 off each”), hurdle offers (“spend $50 and save $10 or get a $10 gift card”), or other types of promotions that require a customer to take an additional action to qualify for the promotion. Another example promotion type is a single-use promotion. Single-use promotions may be promotions that can only be used once by a customer, such as a coupon for 50% off a particular item. Another example promotion type is a mass promotion. A mass promotion may be a promotion that is available to every customer. Another example promotion type is a member-only promotion, which may only be available to a subset of customers, such as customers that are part of a membership program. Another example promotion type is a personalized promotion, which may only be used by a specific customer. Other promotion types, or variations of promotion types, may include the following: free item promotions, free gift card promotions, location-based promotions, and shipping promotions. Other types of promotions are likewise possible. Moreover, there may be promotions that are available in-store but not online, or vice-versa. There may also be regional or store-specific promotions. Furthermore, some promotions may overlap. For example, a given promotion can be both a member-only promotion and may also be a price-based offer.

The redemption rate calculator 1604 may be a program that determines redemption rates for promotions. For a given promotion, the redemption rate may be the percentage of items sold during a promotion period for which a promotion discount is applied. For example, if a promotion is a single-use or member-only promotion, then the redemption rate calculator 1604 may determine that not every item sold during the promotion period will qualify for a promotion price. On the other hand, the redemption rate calculator 1604 may determine that, for mass promotions that are sales-based offers, the redemption rate may be 100%, because each time that any customer purchases the item, the customer receives the discount. Therefore, 100% of the purchases result in the promotion being applied. For other promotions, however, the redemption rate may vary. For instance, the redemption rate for basket promotions may not be 100%. For example, if a customer must purchase 2 of an item to qualify for a basket promotion, then it can be inferred that not every customer purchasing the item will qualify for the promotion, because some customers may only buy 1 of the item.

There may be various data used by the redemption rate calculator 1604 to determine a redemption rate for a given promotion. In some embodiments, the redemption rate calculator 1604 may use historical promotion data, from which redemption rates from previous promotions may be derived and used as a basis for determining redemption rates for subsequent promotions. In some embodiments, the redemption rate calculator 1604 may use data input by a user.

The price change calculator 1606 may determine an effect on price for a promotion. For example, the price change calculator 1606 may use discount price of a promotion and a redemption rate to determine an estimate price change for an item on promotion. For example, if the discount for a promotion is $5 (e.g., buy 1 item and get the second item for $5 less), and if the redemption rate for the promotion is 80%, then the price change calculator 1606 may determine that the price change for item due to the promotion during the promotion is $4. In some embodiments, the price change calculator 1606 may determine a range of possible price changes for a given promotion.

The elasticity models 1608 may be models that determine a change in item demand due to a change in item price. The elasticity model 228 of FIG. 2 is an example of one of the elasticity models 1608. In some embodiments, the elasticity models 1608 include an elasticity model for each item. In some embodiments, a group of items may use a common elasticity model. In some embodiments, the elasticity models 1608 may be represented as demand curves. There may be various techniques for determining the elasticity models 1608. In some embodiments, the promotion system 216 may use data associated with historical price changes (e.g., due to a promotion or another reason) and the change of such price changes on historical sales data. In some embodiments, the promotion system 216 may use price and sales data associated with different items to estimate an effect on sales of a price change on an item. In some embodiments, the promotion system 216 may update the elasticity models 1608 in response to receiving sales data associated with new promotions or in response to a user input updating the elasticity models.

FIG. 17 is a flowchart of an example method 1700 for determining an input of a promotion. Although operations of the method 1700 are described as being performed by the promotion system 216, other components described herein may perform at least some of the operations of the method 1700. Furthermore, although the method 1700 is described in connection with an example item and an example promotion, aspects of the method 1700 may be applied to determine an impact of a plurality of promotions across a plurality of items.

In the example shown, the promotion system 216 may begin a method for determining an impact of an example promotion (step 1701). In some embodiments, the promotion system 216 may determine the impact of a promotion prior as part of training or executing forecasting models 222. In some embodiments, the promotion system 216 may determine a promotion impact when a promotion is defined (e.g., by a user) or when a promotion period begins. In some embodiments, if a promotion applies to one or more of a plurality of items, locations, or channels, then the promotion system 216 may simultaneously determine an impact of the promotions across the items, locations, and channels.

In the example shown, the promotion system may determine a price change (step 1702). As described in connection with the promotions 1602, the redemption rate calculator 1604, and price change calculator 1606, the promotion system 216 may determine an estimated aggregate price change for the example promotion. In some embodiments, determining the price change may include one or more steps, as illustrated by the example of FIG. 17.

In the example shown, the promotion system 216 may determine a discount amount (step 1704). A discount amount may be defined by the promotion as a difference between a promotion price and a regular price. For example, if an item's regular price is $20, and if the promotion price $17, then the discount amount is $3. In some instances, a promotion does not have a discount amount. In some embodiments, if a promotion applies across a group of items (e.g., save 10% on an order), then the discount amount may be proportioned across the items for which the promotion is applicable.

In the example shown, the promotion system 216 may determine a redemption rate (step 1706). Example aspects of determining a redemption rate are described in connection with the redemption rate calculator 1604 or FIG. 16.

In the example shown, the promotion system 216 may combine a discount amount and redemption rate (step 1708). In some embodiments, the promotion system 216 may multiply a discount amount and a redemption rate. Other techniques for combining the discount and redemption rate are likewise possible. In some embodiments, the promotion system 216 may execute one or more additional steps as part of determining a price change. For example, in some embodiments, the promotion system 216 may combine a plurality of price changes from a plurality of promotions that may be applied to the example item.

In the example shown, the promotion system 216 may determine an elasticity for the example item (step 1710). In some embodiments, the promotion system 216 may input one or more of a regular price, promotion price, or price change into an elasticity model for the example item to determine the item's elasticity at the promotion price. In some embodiments, the elasticity may be a ratio that represents a degree to which item demand is changed by a change in price.

In the example shown, the promotion system 216 may determine a promotion impact (step 1712). In some embodiments, the promotion impact is the marginal increase of demand for the example item due to the example promotion. In some embodiments, determining the promotion impact includes multiplying an elasticity and price change. In some embodiments, the promotion impact may be determined in a different manner. In some embodiments, the promotion system 216 may determine not only an increase to demand for an example item on promotion, but the promotion system 216 may determine a secondary effect on demand for other items, such as items that are not on promotion and that may be complementary or substitute items to the items on promotion.

In the example shown, the promotion system 216 may output the promotion impact (step 1714). For example, the promotion system 216 may output the promotion impact to a forecasting model of the forecasting models 222. For example, the promotion system 216 may output the marginal increase to an item demand due to the promotion as the promo lift 310.

In example aspects, sets of potentially overlapping collections of similar items are generated for a given base item. From the similar items, data may be pooled that can be used to train a forecasting model for the given base item. For example, in a collection of six items denoted item A, item B, item D, item E, item F, and item G, the most similar items to item A may include a cluster of item A, item D, item B, and item F. The most similar items to item B may include item B, item D, item F, and item G. Similarly, other groups of items may be formed for others of the items. When building a model for item A, data may be pooled from its group of similar items. Such data pooling may provide more data when training forecasting models, which may result more accurate and precise forecasting models.

FIG. 18 illustrates an example architecture of a similar item data pooling system 1802. In the example shown, the model training system 208 may use data of the similar item data pooling system 1802 as part of training forecasting models 222. However, the similar item data pooling system 1802 need not be part of the model training system 208. In some embodiments, the similar item data pooling system may determine a list of similar items for each item of a catalog, or for at least some items of an item catalog. In the example shown, the similar item data pooling system 1802 includes an item data extractor 1804, an embeddings generator 1806, a search and ranking system 1808, a similar item aggregator 1810, and item similarity data 1812. The similar item data pooling system 1802 may include more or fewer components than those illustrated in the example of FIG. 18.

The item data extractor 1804 may receive item data 108 and extract data from the item data 108. For example, the item data extractor 1804 may select item data that is to be used as part of generating item embeddings. In some embodiments, the item data extractor 1804 may select, for an item, an item title, description, categorization within an item catalog hierarchy, image, sales history, review, location availability, or other data.

The embeddings generator 1806 may generate embeddings associated with items. In some embodiments, the embeddings generator 1806 may include one or more machine learning models that generates embeddings. In some embodiments, the machine learning models may be transformer-based models. In some embodiments, the embeddings generator 1806 may generate embeddings based on one or more of text or image data. For example, for each item, the embeddings generator 1806 may generate embeddings for the item by inputting data extracted by the item data extractor 1804 into a machine learning model.

The search and ranking system 1808 may determine a group of similar items for an item and rank the similar items. In some embodiments, the search and ranking system 1808 determines similar items by searching for embeddings that are similar to embeddings generated for an item. In some embodiments, the search and ranking system 1808 may use a K-nearest neighbors algorithm to determine similar items. In some embodiments, similar items may be ranked based on embedding distances or similarities.

The similar item aggregator 1810 may create lists of similar items for each item of a plurality of items. In some embodiments, the lists of similar items may be ranked. In some embodiments, the similar item aggregator 1810 may store the lists of similar items as part of the item similarity data 1812, which may be used by the model training system 208 as part of training forecasting models 222.

FIG. 19 is a flowchart of an example method 1900 that may be part of training forecasting models using similar item data. Although described as being performed by the similar item data pooling system 1802 and the model training system 208, one or more other components may perform aspects of the method 1900.

In the example shown, the similar item data pooling system 1802 may generate a list of similar items for an item. In some embodiments, the similar item data pooling system 1802 may, for each item of an item catalog, generate a list of similar items (step 1902). In the example shown, generating a list of similar items for an item may include a plurality of steps. In some embodiments, the similar item data pooling system 1802 may use components of FIG. 18 as part of generating lists of similar items.

In the example shown, the similar item data pooling system 1802 may generate item embeddings for items (step 1904). In some embodiments, the similar item data pooling system 1802 may use the embeddings generator 1806. In some embodiments, the similar item data pooling system 1802 may determine whether embeddings have already been generated for a token for which embeddings are to be generated. A token may be, for example, a title, sentence, word, or group of words. If so, the similar item data pooling system 1802 may use the embeddings that were already generated. In some embodiments, embeddings for an item may be generated as new items are added to an item catalog.

In the example shown, the similar item data pooling system 1802 may search for similar embeddings for items (step 1906). For example, for each item, the similar item data pooling system 1802 may apply the search and ranking system 1808 to search for similar items. In some embodiments, the similar item data pooling system 1802 may, for a given item, limit the universe of items for which similar items are searched. For example, the similar item data pooling system 1802 may search for items belonging to a same group as the item. Other search optimizations are likewise possible.

In the example shown, the similar item data pooling system 1802 may rank similar items for the items (step 1908). For example, for a set of similar items to an item, the set of similar items may be ranked based on similarity to the item. In some embodiments, the ranking is performed by using a Cosine or Euclidean similarity between embeddings for the item and embeddings for the similar items.

In the example shown, the model training system 208 may select an item (step 1910). For example, the model training system 208 may select an item for which a forecasting model of the forecasting models 222 is to be trained.

In the example shown, the model training system 208 may determine similar items for the selected item (step 1912). For example, the model training system 208 may select a list of similar items generated by the similar item data pooling system 1802.

In the example shown, the model training system 208 may determine whether to train a forecasting model for the selected item using similar item data (step 1914). In some embodiments, the model training system 208 may determine whether there is historical sales data associated with the selected item to train the forecasting model. If not, the model training system 208 may elect to use similar item data as part of training the forecasting model. In some embodiments, the model training system 208 may determine how many similar items to use as part of training the forecasting model. For example, the model training system 208 may elect to use three similar items, and then the model training system 208 may select a top three similar items from the list of similar items to the selected item. In some embodiments, the more historical sales data associated with the selected item is available, the fewer number of similar items and amount of similar item data may be used as part of training the forecasting model for the selected item.

In response to determining to not train the model using similar item data (e.g., taking the “NO” branch), the model training system 208 may proceed to train the forecasting model for the selected item without similar item data (step 1916). In response to determining to train the model using similar item data (e.g., taking the “YES” branch), the model training system 208 may proceed to select similar item data (step 1918).

In the example shown, the model training system 208 may select similar item data (step 1918). For example, the model training system 208 may select sales data for a determined number of similar items to the selected item. In some embodiments, the model training system 208 may select sales data for the top-ranked similar items. In some embodiments, however, the model training system 208 may select sales data for certain similar items. For example, the model training system 208 may first determine whether a given similar item itself has sufficient sales data. If not, the model training system 208 may not select sales data associated with the given similar item. In some embodiments, the model training system 208 may select similar items that are sufficiently different from one another. As such, the model training system 208 may select sales data that corresponds to different aspects of the selected item.

In the example shown, the model training system 208 may train a forecasting model for the selected item by using the selected similar item data (step 1920). In some embodiments, the model training system 208 may use a combination of sales data associated with the selected item and sales data of the similar items. In some embodiments, operations of the method 1900 may be repeated. For example, the model training system 208 may repeats the steps 1910-1920 as part of retraining a forecasting model. In some embodiments, as a selected item accumulates more historical sales data as time passes, the model training system 208 may use progressively less data from similar items as part of training a forecasting model for the selected item.

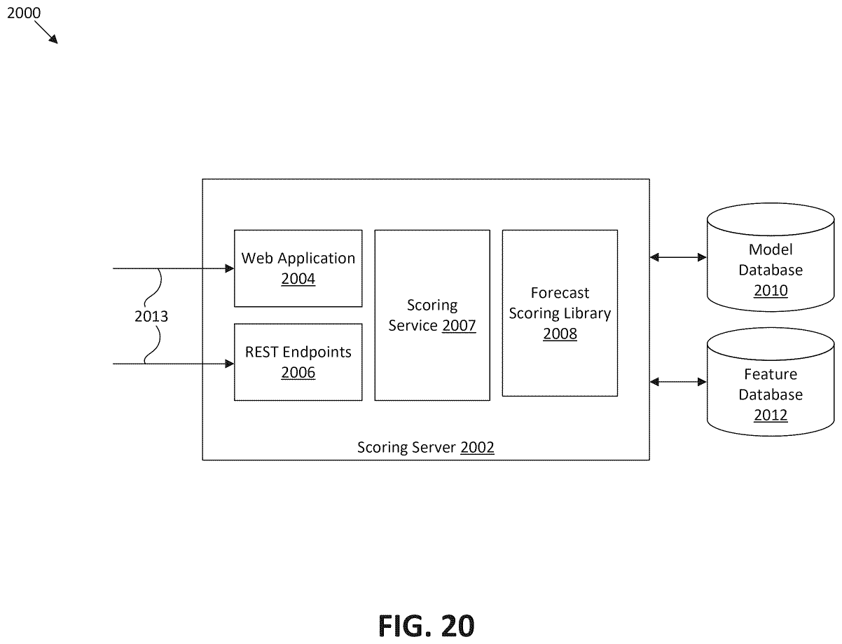

FIG. 20 illustrates an example network environment in which a scoring server 2002 may be implemented. In example aspects, the forecasting system 102 includes a forecasting API that enables an external program to access the forecasting models 222. In some embodiments, the forecasting API is available on demand and implemented using the scoring server 2002, such that an external program can call the forecasting API to receive a demand forecast for an item or a group of items. In some embodiments, the forecasting API allows an external program to use the forecasting models 222 to generate scenario-based demand forecasts. For example, by using the forecasting API, a user may change one or more of a price, time frame, availability, assortment etc., of an item or group of items and generate a demand forecast in view of the change. The forecasting API may be an example of the forecast consumer interfaces 246. Example aspects of the scoring server 2000 that may include the forecasting API are illustrated in the example of FIG. 20.

The scoring server 200 includes a web application 2004, REST endpoint 2006, a scoring service 2007, and a forecast scoring library 2008. The scoring server 200 may also include or be communicatively coupled with a model database 2010 and feature database 2012. The scoring server may provide both a web application and HTTP/JSON endpoints associated with a forecasting API. The web application 2004 may be an application that allows users to directly query the scoring server 2002. The REST endpoints may parse requests, such as JSON requests, and return results provided by the scoring service 2007 and forecast scoring library 2008. The web application 2004 and REST endpoints 2006 may receive requests 2013 for demand forecasts and return results to a sender of the requests 2013. The requests 2013 may correspond to inputs of a user via the graphical user interface 248.

The scoring service 2007 may receive requests from the web application 2004 and REST endpoints 2007 using a unified API for generating forecasts for various granularities of item, location, and time combinations. In some embodiments, the scoring service 2007 may route a request for a demand forecast for an item to an API corresponding to the item from among a plurality of APIs exposed by the forecast scoring library 2008. The forecast scoring library 2008 may generate demand forecast responsive to the requests received from the scoring service 2007. In some embodiments, the forecasting scoring library 2008 retrieves a model from the model database 2010 and features from the feature database 2012 corresponding to an item for which demand is to be forecasted responsive to the request 2013. In some embodiments, the forecast scoring library 2008 includes a plurality of model-specific APIs that are called by the scoring service 2007, or another application, for generating item-specific demand forecasts.

The model database 2010 may store data corresponding to the forecasting models 222. For example, the model database 2010 may store, for each model, parameters, learned weights, and data corresponding to features for the model. The feature database 2012 may include features of the forecasting models 222. For example, for each model stored in the model database 2010, the feature database 2012 may store features for the model. The features may include an identification of features used by the forecasting model and values for the features. In some embodiments, the request 2013 may override one or more of the feature values stored in the features database 2012.

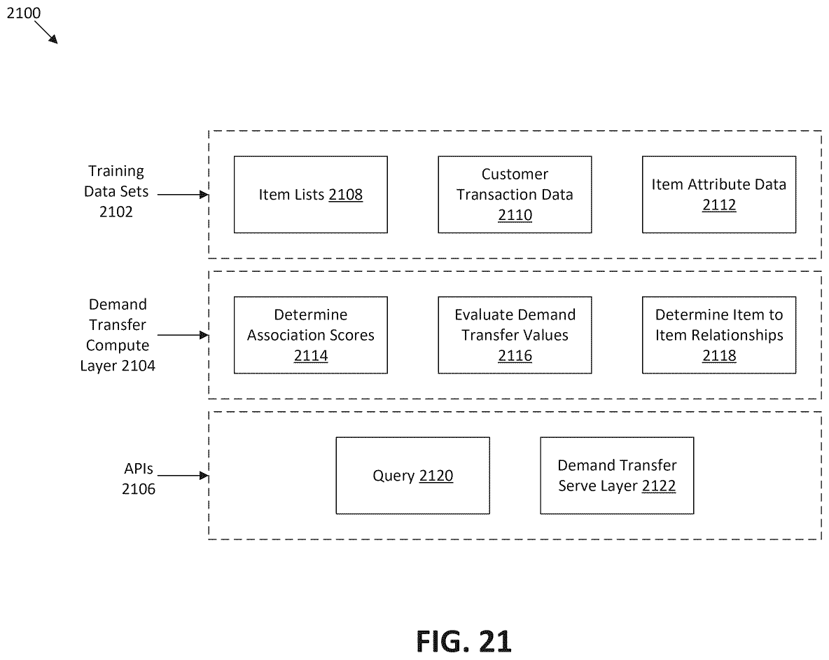

In some embodiments, the forecasting API enables a user to remove an item from an assortment and to generate demand forecasts for remaining items in the assortment. As such, the forecasting API may enable a user to predict a percentage of demand that is transferred to other items, a percentage of demand that is lost, and an identity of items to which demand is transferred. In some embodiments, to support the capability to forecast demand transfers in response to interactions with the forecasting API, the forecasting system 102 may include a demand transfer engine. Example aspects of a demand transfer engine 2100, which may be part of the forecasting system 102, are illustrated in the example of FIG. 21.

The demand transfer engine 2100 may measures the relative portion of demand that can transfer to other items when an item is removed from the assortment. In some embodiments, given a list of items and data from customers buying those items, the demand transfer engine 2100 may generate a graph with nodes representing items and the edge weights capturing the degree of substitutability between pairs of items. Larger edge weights may indicate that the pair of items are more likely to be substitutable than pair of items with smaller edge weights. In some embodiments, the demand transfer engine 2100 uses scores between pairs of items to determine groups of substitutable items. These groups of substitutable items may be used to add a new or orphan item to the existing graph of substitution groups, such as by matching an attribute of a new or orphan item to an attribute determined for a group of substitutable items. Additionally, the demand transfer engine 2100 may use a substitution graph to generate demand transfer coefficients for pairs of items, thereby converting the undirected graph to directed graph. In the example of FIG. 21, the demand transfer engine 2100 includes training data sets 2102, a demand transfer compute layer 2104, and demand transfer APIs 2106. In some embodiments, the AI system 252 queries the demand transfer engine 2100 as part of generating a response to a user query.

The training data sets 2102 include data may be used by the demand transfer engine 2100 to, among other things, determine demand transfers among items, such as by generating substitutability graphs. In some embodiments, data of the training data sets 2102 may be retrieved from one or more of the item data 108 or the sales data 110. In the example shown, the training data sets 2102 include an item lists 2108, customer transaction data 2110, and item attribute data 2112. The item lists 2108 may include lists of items for which the demand transfer engine determines demand transfer values, such as by generating a substitutability graph for items in the list of items. The customer transaction data 2110 may include sales data, such as from the sales data 110, corresponding to items in the item lists 2108. The item attribute data 2112 may include attributes, such as text attributes, image attributes, item metadata, or other data corresponding to items in the list of items.

The demand transfer compute layer 2104 includes operations that may be performed by the demand transfer engine 2100. In some embodiments, the demand transfer engine 2100 may perform one or more of the steps 2114, 2116, or 2118 for items in a list of items.

In the example shown, the demand transfer engine 2100 may determine association scores (step 2114). For example, the demand transfer engine 2100 may determine association score for pairs of items in an item list. In some embodiments, an association score corresponds with a similarity score. There may be various techniques for determining an association score between a first item and a second item. As one example, the demand transfer engine 2100 may divide a probability that a customer bought both the first item and the second item by the probability that a customer bought the first item with the probability that the customer bought the second item. As another example, the demand transfer engine may determine a Jaccard Similarity between the first item and the second item.

In the example shown, the demand transfer engine 2100 may evaluate demand transfer values (step 2116). For example, the demand transfer engine 2100 may evaluate a plurality of association scores determined at the step 2114. In some embodiments, evaluating the demand transfer values includes normalizing edge weights in the substitutability graph. In some embodiments, the normalized demand transfer is calculated by dividing the edge weight between a pair of items by the sum of all scores between pairs of items in the same group. Additionally, evaluating the demand transfer values may include determining item groups. For example, if an association score is less than or equal to one, then the demand transfer value may be set to zero. The graph 2200 illustrates an example substitutability graph with example association scores and groups of items.

In the example shown, the demand transfer engine 2100 may determine item to item relationships (step 2118). Among other things, this may include one or more of the following operations: determining substitutability groups in a similarity graph; determine attributes of items in substitutability graphs; assign orphan items, such as items for which one or more association scores were unable to be determined, to substitution groups; and assign new items to a group and impute demand transfer values linking the new item to existing items in the substitutability graph.

The APIs 2106 may define communication interfaces between the demand transfer engine 2100 and other components, such as other components of the forecasting system 102. In the example shown, the APIs 2106 include a query API 2120, which enables a calling application to determine demand transfer values for a particular item, or for a particular pair of items. The APIs 2106 may include a demand transfer serve layer 2122, which may enable a calling application to determine demand transfer values for a collection of items. For example, the demand transfer serve layer 2122 may provide demand transfer values for items of an item list or for a pre-defined category of items.

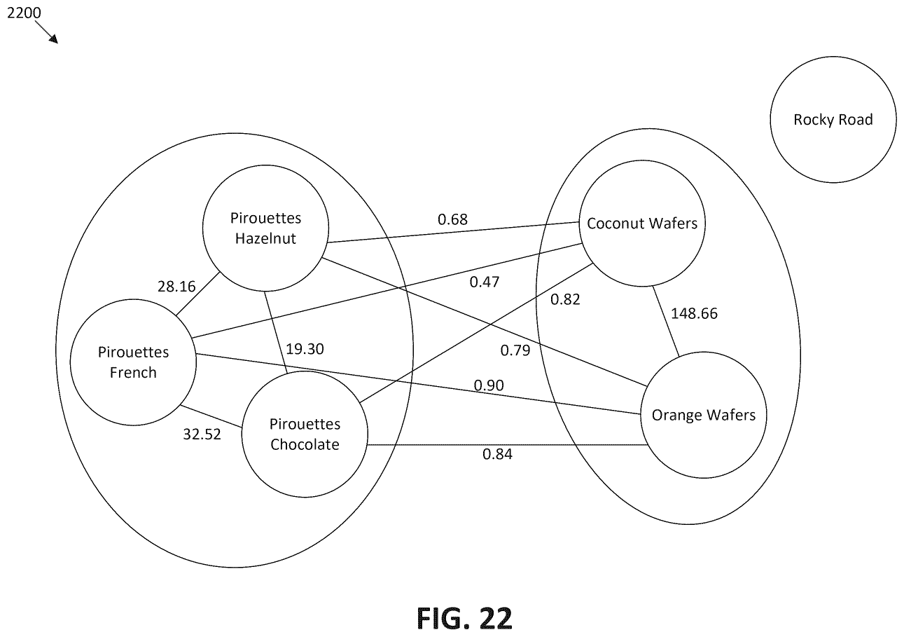

FIG. 22 illustrates an example substitutability graph 2200 generated by the demand transfer engine 2100. The graph 2200 includes nodes representing items and edge weights between nodes that represent a degree of substitutability between pairs of items. In some embodiments, substitutability groups may be determined in the graph, and for the substitutability groups, key attributes may be defined. In some embodiments, the edge weights may be determined by analyzing historical sales data to determine probabilities that items were purchased together or substituted for one another. In some embodiments, the forecasting API enables a user to compare demand forecasts of different items and may enable a user to compare demand forecasts of different items in view of potential changes to data associated with the items.

In some instances, it may be challenging for a forecasting system to model certain types of hypothetical scenarios. For example, in the case of weather events or other seasonal effects, these may affect demand forecasts for certain items, but these scenarios may also affect other supply chain systems, and it can be challenging, in some instances, for a forecasting system to recognize and determine the effects of such scenarios on other supply chain systems.

In example aspects, an improved human-in-the-loop AI system for demand forecasting is disclosed. For example, the AI system may be configured to receive a user input associated with one or more of promotions, inventory levels, customized similar item groupings, changed future average base prices, long-term trends, assortment updates, business decisions, scenario planning, and other data that may affect demand. In some embodiments, the user input may correspond to a future time. Additionally, users may adjust future hypothetical scenarios by intervening with particular events, such as weather events, competitor store openings or closings, sentiment analysis on trending items, and the like. As an example, a user may input one or more of a selection of a class or modification of future store counts, base prices, or adjustments in pricing, and the AI system may respond with a demand forecast that may be impacted by the user input.

In some embodiments, the AI system may assist humans when making inventory-related decisions. The AI system may generate recommendations to the user based on information of which the user may not be aware, or based on secondary or tertiary effects of the user's proposed action that the user may not appreciate. For example, when a user submits an inventory override, the user may first provide the proposed override to the AI system, which can generate a recommendation, such as to alter the override or to take another action. The AI system may use the forecasting models 222 as part of generating recommendations.

The AI system may be communicatively coupled with many different systems. For example, the AI system may be configured to communicate with different databases and platforms that may communicate using different formats. Therefore, the AI system may have access to data that a human user may not have access to, or may not have the skills to access. Therefore, the AI system may detect issues or opportunities that would not be apparent to a user. Moreover, the AI system, unlike a human, has the memory and processing capability to assess information from the different system when evaluating a decision in a manner that is distinct from analogous human capability. Additionally, the AI system may operate in a loop with a human user in which the human inputs improve outputs of the AI system, and the outputs of the AI system are used to make inventory decisions. The results of the inventory decisions are then used to improve the AI system.

As example applications, the AI system could be used in connection with one or more of the following applications: scenario planning; assortment planning and cannibalization assessment; promotion planning; generating inventory recommendations based on external events, such as weather, store closures, or sporting events; integrating with a supply chain simulator; generating confidence levels for supply and demand; sentiment analysis; parameter tuning; guest behavior analysis; vendor negotiation; and others.

One application of the AI system is as part of assortment planning. The AI system may serve as a middle layer between a user, an assortment planning tool, and other systems, such as systems of the forecasting system 102. For example, the AI system may generate scenarios for different item assortments. Depending on items in the assortment, different demand forecasts are generated for different items. A user may also adjust prices as part of generating scenarios. The AI system may make simultaneous calls, for example, to the forecasting models 222, the demand transfer engine 2100, or to other systems. Additionally, another example application of the AI system is as part of new item assessments. Forecasting new items may include using the forecasting models 222 to forecast demand for similar items, and the AI system may assist with selecting these similar items.

FIG. 23 illustrates an example architecture of the AI system 252. The AI system 252 may be used to perform some of the operations described herein. For example, the AI system 252 may enable one or more of the features described in connection with the use cases of the AI system 252 further described below. In the example shown, the AI system 252 includes a user interface 2302, an AI API 2304, a rules engine 2305, AI models 2306, and forecasting models 222.

The user interface 2302 may receive the user input 2301. In some embodiments, the user interface 2302 may be part of the forecasting system 102, such as the GUI 248. In some embodiments, the user interface 2302 may be part of an application that is communicatively coupled with the forecasting system 102. In some embodiments, the user interface 2302 may be a plurality of different user interfaces that are configured to interact with the AI API 2304.

The AI API 2304 may be an application programming interface for interacting with the AI system 252. In some embodiments, the AI API 2304 is configured to receive an input corresponding to one or more of the use cases described below. In some embodiments, the AI API 2304 may be configured to receive data corresponding to a user input associated with an action, hypothetical scenario, event, or other occurrence that may affect a retail enterprise. Moreover, the AI API 2304 is configured to receive parameters or other data associated with such a user input.

The rules engine 2305 may be a middle layer that receives data from the AI API 2304 and that determines one or more models to be used as part of responding to the user input. For example, the rules engine 2305 may select one or more models of the AI models 2306 or the forecasting models 222, and the rules engine 2305 may provide data associated with the user input to the one or more selected models. In some embodiments, the rules engine 2305 may select a model based at least in part on a configuration of the user interface 2302 or a selection in the user interface 2302. In some embodiments, the rules engine 2305, or another component, may facilitate repeated data exchanges with a plurality of AI models 2306 or forecasting models 222 as part of generating the output 2307 to respond to the user input.

The AI models 2306 may include one or more models that can be used as part of generating a response to the user input 2301. In some embodiments, the AI models 2306 include different models that are trained to process different types of data or to process data belonging to different domains.

In an example, the AI models 2306 include a supply chain forecasting model. The supply chain forecasting model may be used to generate predicted states of a supply chain for a multi-location organization, such as a large retail organization. For example, the supply chain forecasting model may generate a simulated forecast of a supply chain state based on replenishment assumptions into a supply chain. An example model is described in U.S. Patent Pub. No. 2021/0334829, entitled “User Interface for Visualizing Output from Supply Chain Replenishment Simulation”, the disclosure of which is hereby incorporated by reference in its entirety.

In an example, the AI models 2306 include a promotion forecasting model. The promotion forecasting model may optimize targeted promotional programs for items based on past promotions and performance. Examples of such a promotional optimization model are described in U.S. Pat. No. 11,403,668, entitled “Multitask Transfer Learning for Optimization of Targeted Promotional Programs”, the disclosure of which is hereby incorporated by reference in its entirety.

In an example, the AI models 2306 include external effects models. The external effects models may include one or more models indicating effects on demand or on supply chain operations induced by external effects. For example, various external effects may be introduced by such a model, such as goods shortages, weather condition effects, seasonality models, and the like. Such models may be separate from the above forecasting models or integrated therein, for example as described in U.S. Pat. No. 11,182,808, mentioned above.

In some embodiments, there may be various use cases for the AI system 252. Some example use cases are set forth below.

In example aspects, the AI system 252 may interact with a user to generate one or more types of forecasts or recommendations for scenario planning purposes. Accordingly, in some example implementations, a user input may be introduced as part of a scenario planning process, which applies different sets of business rules and desired outcomes to model particular planning processes. This may allow for planning of promotions in future time periods, and allow users to change the timing or extent of promotions in those time periods, while enabling the AI system 252 to accommodate the user adjustments to timing or promotion detail to achieve the desired outcomes. Additionally, user inputs may be received into a modeling process that may adjust baseline assumptions made by the model. Example assumptions include, for example, a future average base price of an item, or a long-term trend at an item or class level for sales of such items. Additionally, a user may provide inputs that's change underlying assumptions such as store account for an item (e.g., the number or selection of stores that are designated to carry a given item).

In example aspects, user inputs may be introduced to define an impact of anticipated assortment planning changes on forecasts for individual items. For example, in a default scenario, forecasted sales of an item assume that the item will be carried forward in future planning periods. User inputs may indicate that another item is planned to be sold during a future time, which may cannibalize sales of the item. In some embodiments, the AI system 252 may detect the cannibalization effect, predict a degree of the cannibalization, and provide a recommendation. As another example, a plan may be in place to reduce footprint for a given item within physical retail locations, or other changes may be anticipated that could change item demand but which are not well accounted for by existing forecasting models. An example modeling process that may receive user inputs to address anticipated changes in assortment plans and that may be utilized by the AI system 252 is described in U.S. patent application Ser. No. 18/100,257, entitled “Incremental Value Assessment Tool and User Interface”, the disclosure of which is hereby incorporated by reference in its entirety.

In example aspects, a modeling system for planning promotional activities by a retail enterprise may be improved by receiving user inputs before a modeling process occurs. The user inputs may be used to modify model output based on one-time business circumstances that are in place at the time of the anticipated promotion. For example, a user may provide input regarding potential cross-promotion impact or cross-elasticity impact on sales of an item, for example if a competitor retail organization is currently promoting or will promote that same item for sale. Such competitive promotional activity may affect item demand in a way not otherwise readily captured by model activities. In some embodiments, the AI system 252 may ingest data relating to such planned promotional activities and determine what impact, if any, such activities may have on other processes.

In a still further example, item demand forecasts or sales forecasts may be adjusted based on user inputs indicating changes in conditions at one or more physical retail locations, or within an overall retail supply chain network. For example, weather events, such as hurricanes, floods, wildfires, major sporting events, or other unanticipated events (e.g., limited time store closures and the like) may be ingested by the AI system 252, such that modeling may automatically reflect changes in item demand in response to such events. For example, in the case of user inputs identifying a potential hurricane event, the AI system 252 may cause demand for water or nonperishable goods may increase in days prior to the event at stores within a predetermined distance from a forecasted event location.

Additionally, in response to user input regarding such an event, changes to overall supply chain response may be determined by the AI system 252, which may indicate a time of reallocation of items to areas in need (e.g., where demand may be greatly increased). In other examples, events such as store closures of competitor stores may change overall demand for items at a given store. For example, a competitor store going out of business that is located in geographic proximity to one or more retail locations of a retail enterprise may results in at least short-term increases in demand for items carried by both the retail location and the closed competitor store. Similarly, competitor store openings may result in changes in demand. Such events may be ingested by the AI system 252, which may detect the likely downstream effects and provide one or more of a recommendation or demand forecast to a user that corresponds to the downstream effects. Such downstream effects may include decreases in demand for similarly situated stores, or increases in demand in the case of complementary stores (e.g., warehouse or club type stores, which may increase overall foot traffic at the retail location).

In example aspects, in addition to improved demand forecasting, user input prior to execution of models may provide improvements in the context of supply chain simulation. Such user inputs may enable “what if” scenario simulations based on then-current supply chain states and supply chain constraints (e.g., vendor constraints, shipping constraints, back-room space at retail locations, and the like) to determine a real life sales forecast based on both demand and realistic supply or stocking levels.

In the context of forecast demand, the forecasting system 102 may utilize user input to better indicate, on a customized item by item basis, confidence levels for individualized item forecasts. This is particularly useful in the case of new items, seasonal items, or items that otherwise have low sales history. In some cases, confidence in a forecast may be higher based on a high level of similarity between the item for which a forecast is generated (e.g., the new item) and another item for which more history is available, and therefore forecast confidence is greater. In other cases, confidence in a forecast may be lower based on the uniqueness of the item, the user perceived variability in potential outcomes in terms of sales demand, and the like. By allowing a user to individually provide input regarding confidence in a demand forecast, downstream systems may be able to automatically adjust for that variable confidence level by adjusting stocking levels, and the like.

In example aspects, user inputs to the AI system 252 may be allowed to define adjustments to demand based on sentiment analysis regarding individualized, trending items. For example, a user may be able to identify a particular item that is offered for sale which may be associated with a short-term trend as reflected online, for example in social media. A trend identification tool may be available to individual users, who may in turn identify items associated with a trend. The items associated with the trend be adjusted in accordance with a response expected for that trend, for example adjustments to short-term demand. These adjustments may result in changes to stocking level forecasts, item level purchases of individual items, supply chain adjustments to accommodate additional capacity, and the like.

In a further example, the AI system 252 may be used to generate text recommendations to a user based on the user's actions. For example, if the user is creating a scenario, the user may input hypothetical data pertaining to the scenario. The forecasting system 102 may determine a demand forecast for the scenario and may also determine side effects or secondary effects, such as on other items or other aspects of a retail enterprise, related to the user's scenarios. In some embodiments, the AI system 252 generates a text recommendation that notifies the user of the demand forecast for the item and also of the other effects that the user's modification may have. To do so, in some embodiments, the AI system 252 uses a pre-trained large language model that is provided additional context when generating a response, where the additional context may include the demand forecast for the item and the side effects or secondary effects of the user's proposed changed.

In some examples, user inputs may be received to define a segmentation of a customer population. In such a case, an optimal assortment may be modeled for each defined segment of the customer population, rather than across the entire collection of enterprise customers.

In further examples, user inputs may be utilized to either model vendor support for promotional programs, or to expose certain models to vendors for purposes of receiving user input from those vendors. Regarding modeling of vendor support, a user may provide information regarding the extent of funds a vendor may provide to be featured on promotional literature created and distributed by the retail enterprise. Such inputs may either be user entered or modeled based on historical data. Regarding exposure of models to vendors, in some instances, forecasting models may be exposed to a vendor via a portal or API. Each vendor may submit requests to the portal or API, and receive promotion forecasts, thereby allowing each vendor to determine potentially valuable promotions the vendor may be able to offer for its items via the retail enterprise.

In still further examples, beyond use of user inputs as affecting downstream AI models, it is recognized that a combination of upstream AI models and user inputs may be utilized. In one example, a downstream model used to forecast guest demand may be used, but an upstream ordering process may combine the downstream demand for goods with additional factors, such as spoilage for perishable items. For example, a separate algorithm to predict spoilage rates based on past history of spoilage on a per item basis (e.g., rates of spoilage of individual types of produce items) may be combined with downstream demands to determine an upstream ordering requirement so that an individual retail location may order an appropriate amount of items to fulfill customer demand.

In further examples, an upstream assortment item recommendation process may be used to determine items to be carried within an overall online or in-store assortment. In example implementations, such a model may generate recommendations on items or item types to be carried within a given assortment. Such a model may generate recommendations based on existing enterprise data, and may determine trends in demand and correlations between demand and item attributes such that additional items may be identified as recommended to be carried within an item assortment. In other examples, received data, such as queries for recommendations or comments from enterprise customers may be included within training data, such that recommendations for new items to include in an item assortment may reflect current item assortment, trends in demand, and explicit customer feedback. An example of a system for generating recommendations for new items is described in U.S. Provisional Ser. No. 63/507,779, and entitled “System for Recommending Items and Item Designs Based on AI-Generated Images”, the disclosure of which is hereby incorporated by reference in its entirety.

In still further examples, additional models may be used to modify demand forecasts based on display factors. In particular, a location of an item within a retail organization, or its prominence on a retail website, may affect the extent to which the item is purchased. In some examples, a model of display effects may be provided as to physical display changes (end cap, check lane displays, and the like) may be used to adjust individual item demand at a particular retail location based on the selected location of the item.

Still further, in some types or classes of items (e.g., apparel) there is a fixed inventory and that inventory is required to be allocated across a plurality of retail locations. In such instances, rather than modeling only demand for the item, the desired modeling would involve generation of recommendations regarding the specific retail locations at which the item should be stocked, a timeframe that the item can be expected to be carried at the retail location, as well as expected revenue and/or margin from sales of the item at that location. Such modeling may allow a retail enterprise to make better assortment decisions, because the limited shelf space at a particular location combined with the shelf space required to carry and display individualized items may be considered in determining the opportunity cost of the shelf space. This allows for better assortment decision-making.

FIG. 24 illustrates an example user interface 2400 that may be utilized to provide some level of user input into demand forecasting models is illustrated in FIG. 24. In some embodiments, the user interface 2400 is communicatively coupled with the AI system 252. The AI system 252 may, for example, process data or a request input via the user interface 2400 or generate data that is output via the user interface 2400. The user interface 2400 depicts a set of tabs 2401 that allow a user to view relationships among items for among item stocking factors (supply chain effects, seasonality, and the like) a tab allowing the user adjustment of price response for individual items or for classes of items, and a tab (as displayed) showing promotion response analysis.

In the example of FIG. 24, the promotion response analysis tab is selected. The user interface 2400 displays options 2402 for selecting one or more of a location, item, and time. These options may be selected at different levels of granularity. As examples, for location, a particular store, group of stores, digital fulfillment channel, or supply chain-wide level may be selected. For item, a particular item or group of items may be selected. For time, a day, week, month, quarter, or year may be selected. In some embodiments, the AI system 252 will generate a response that is specific to the location-item-time selection input via the options 2402. Additionally, the user interface 2404 may include promotion options 2404, which may be used by a user to select settings for a hypothetical promotion. For example, the user may input a hypothetical elasticity of the selected item or items, and the AI system 252 or other systems may use the input elasticity as part of generating a response. Other examples of promotion systems may include types of promotions and their corresponding features. For example, a promotion may be indicated to be a display promotion, in which the selected item is displayed on an end cap, or on a certain area of a website for a certain period of time. Other promotion types and corresponding features are likewise possible, as described above.

Upon selection, in this example, of a location-item-time via the options 2402 and a selection of promotion characteristics, series of analyses may be performed and displayed. The user interface 2400 illustrates examples of such displays. For example, the user interface 2400 includes a region 2406 showing a promotion segmentation of target rating points across average unit volume for a plurality of items, a region 2408 showing sales lift for an item based on a discounts across example promotions, and a region 2410 showing demand lift for a group of items based on a discount across example promotions (after all cross-item cannibalization of demand has been accounted for). In some embodiments, the demand transfer engine 2100 may be used as part of determining intra-group cannibalization illustrated by the region 2410. The key 2412 indicates example promotions. In some embodiments, one or more displays in the user interface 2400 may be updated in real time as the AI system 252 generates a response.

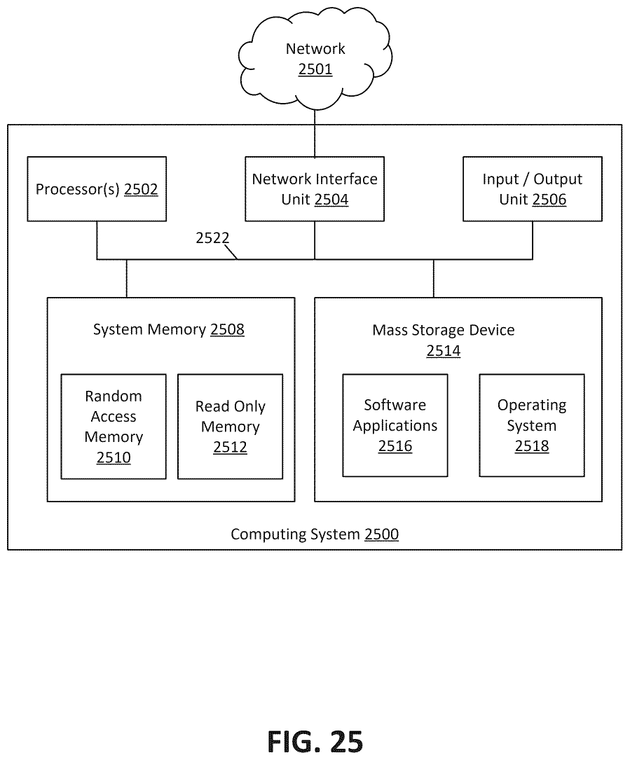

FIG. 25 illustrates an example block diagram of a virtual or physical computing system 2500. One or more aspects of the computing system 2500 can be used to implement the system and processes described herein.

In the embodiment shown, the computing system 2500 includes one or more processors 2502, a system memory 2508, and a system bus 2522 that couples the system memory 2508 to the one or more processors 2502. The system memory 2508 includes RAM (Random Access Memory) 2510 and ROM (Read-Only Memory) 2512. A basic input/output system that contains the basic routines that help to transfer information between elements within the computing system 2500, such as during startup, is stored in the ROM 2512. The computing system 2500 further includes a mass storage device 2514. The mass storage device 2514 is able to store software instructions and data. The one or more processors 2502 can be one or more central processing units or other processors.

The mass storage device 2514 is connected to the one or more processors 2502 through a mass storage controller (not shown) connected to the system bus 2522. The mass storage device 2514 and its associated computer-readable data storage media provide non-volatile, non-transitory storage for the computing system 2500. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 2500.

According to various embodiments of the invention, the computing system 2500 may operate in a networked environment using logical connections to remote network devices through the network 2501. The network 2501 is a computer network, such as an enterprise intranet and/or the Internet. The network 2501 can include a LAN, a Wide Area Network (WAN), the internet, wireless transmission mediums, wired transmission mediums, other networks, and combinations thereof. The computing system 2500 may connect to the network 2501 through a network interface unit 2504 connected to the system bus 2522. It should be appreciated that the network interface unit 2504 may also be utilized to connect to other types of networks and remote computing systems. The computing system 2500 also includes an input/output controller 2506 for receiving and processing input from a number of other devices, including a touch user interface display screen, or another type of input device. Similarly, the input/output controller 2506 may provide output to a touch user interface display screen or other type of output device.

As mentioned briefly above, the mass storage device 2514 and the RAM 2510 of the computing system 2500 can store software instructions and data. The software instructions include an operating system 2518 suitable for controlling the operation of the computing system 2500. The mass storage device 2514 and/or the RAM 2510 also store software instructions, that when executed by the one or more processors 2502, cause one or more of the systems, devices, or components described herein to provide functionality described herein. For example, the mass storage device 2514 and/or the RAM 2510 can store software instructions that, when executed by the one or more processors 2502, cause the computing system 2500 to receive and execute managing network access control and build system processes.

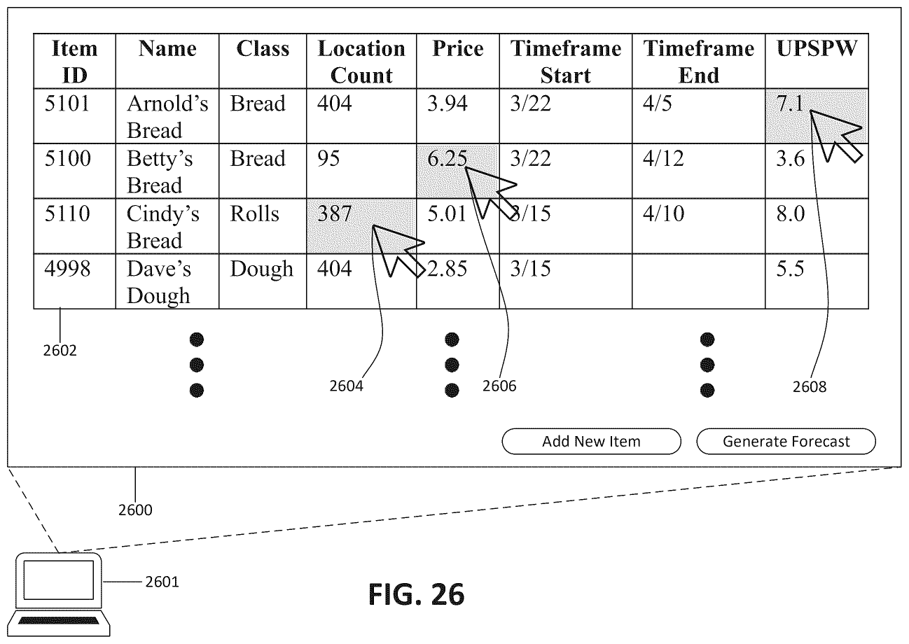

FIG. 26 illustrates an example user interface 2600. In some embodiments, the user interface 2600 is an example of a graphical user interface 248. In some embodiments, the AI system 252 may process data received or output via the user interface 2600. In the example shown, the user interface 2600 is displayed by the computing device 2601, which may be, for example, a demand forecast consumer or a device of the administrator 120.

In some embodiments, the user interface 2600 provides an interactive demand forecasting system that, among other things, displays demand forecasts for items and enables a user to override a demand forecast or generate hypothetical demand forecasts. In the example shown, the user interface includes item forecast data 2602, which includes a plurality of example items and associated attributes of the items. For example, the item forecast data 2602 may display data from the item data 108. Additionally, the item forecast data 2602 may display forecasts generated by the forecasting models 222. For example, for the item “Arnold's Bread,” data from a demand forecast from March 22 to April 5 is displayed. For example, the item forecast data 2602 displays a forecasted units per store per week (“UPSPW”) for each of the items. The user interface 2600 may include other data pertaining to demand forecasts, such as an indication of whether a demand forecast was generated for a particular store or group of stores, or a fulfillment channel for the forecasted demand. The user interface 2600 may also display historical sales data and other features used by the forecasting models 222 to generate demand forecasts. In the example shown, the user interface 2600 includes an add new item button and a generate forecast button. For example, the user may provide an input (examples of which are illustrated by the inputs 2604-2608) and may select the generate forecast button, which may cause a demand forecast to be generated based at least in part on the input.

In the example shown, a user may edit data of the user interface 2600 to generate updated demand forecasts. For example, the input 2604 depicts a user editing a “Location Count” for an example item. For example, the item “Cindy's Bread” may have been forecasted to be sold at 387 locations, but this feature may be altered via the user interface 2600 to generate an updated demand forecast. For example, the user may input more, fewer, or different locations at which to sell the item, and in response, the forecasting system 102 may generate an updated forecast, which may, in the example shown, result in a different UPSPW for “Cindy's Bread.” In some embodiments, the AI system 252 may receive data corresponding to the input 2604 and orchestrate operations of communicatively coupled systems to generate a response, which may include a recommendation based on the user's input. For example, in response to receiving data of the input 2604 that reduces a number of locations at which “Cindy's Bread” is sold, the AI system 252 may determine that such a reduction may reduce the supply of other items at the location, thereby necessitating large purchase orders for such items, or that such a reduction may affect the effectiveness of a promotion that requires a customer to purchase rolls. In some embodiments, the AI system 252 causes a display on the user interface 2600 informing the user of such downstream effects that may occur if the user were to alter the location count for “Cindy's Bread.” In a similar manner, the AI system 252 may generate recommendations in response to received data associated with the inputs 2606 and 2608.

In the example shown, the input 2606 illustrates a hypothetical modification of price for “Betty's Bread.” For example, the user may increase or decrease the price for the associated forecasting period, and a forecasting model associated with “Betty's Bread” may generate an updated demand forecast. Additionally, the AI system 252 may process and generate recommendations in response to the hypothetical modified price. For example, the AI system 252 may determine that another item, such as “Arnold's Bread” is affected by the input 2606 adjusting a price of the “Betty's Bread.” For example, if the price for “Betty's Bread” is increased, then the demand forecast for “Arnold's Bread” may likewise increase.

In the example shown, the input 2608 illustrates an override of a demand forecast. For example, a user may increase or decrease the demand forecast for “Arnold's Bread.” In some embodiments, an inventory management system communicatively coupled with the user interface 2600 may receive the edit to the demand forecast and may alter purchase orders accordingly. For example, if the demand forecast is increased, then then the inventory management system may generate purchase orders so supply for “Arnold's Bread” is sufficient to meet the increased demand. In some embodiments, overriding the demand forecast may affect subsequent demand forecasts for the item. For example, if the demand forecast is increased, then subsequent demand forecasts may likewise be increased. Additionally, demand forecasts for other items may be impacted. For example, if the demand forecast is increased, then demand forecasts for complementary items may likewise be increased while demand forecasts for substitute items may be decreased. In some embodiments, when a user overrides the demand forecast, the override may not be committed to other components of the forecasting system or to an inventory management system until the user receives a response generated by the override via the user interface, and until the user subsequently commits the override, such as selecting a button on the user interface.

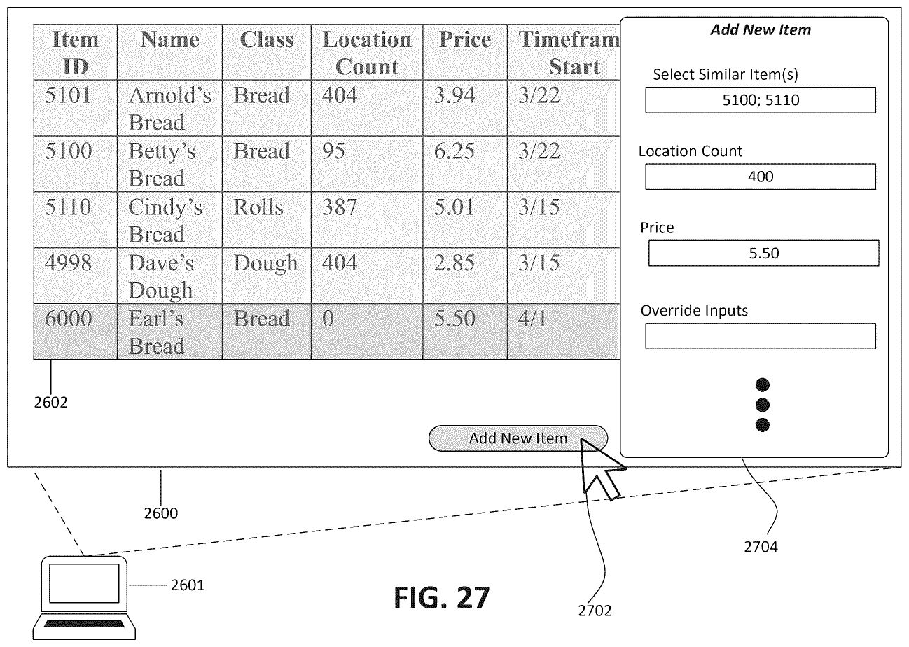

FIG. 27 illustrates an example of the user interface 2600. In the example shown, the user selects the add new item button to add a new item to the item forecast data 2602. For example, the new item may be a new item of an item catalog or an existing item of a catalog to be added to the item forecast data 2602. The user may provide an input 2702 to add the new item. In the example shown, the user adds “Earl's Bread” to the item forecast data 2602.

In some embodiments, as part of adding a new item, a user may input new item data 2704, which includes a plurality of input fields via which the user may input data corresponding to the new item. The new item data 2704 includes input fields for similar items, location count, price, and overrides, such as overrides of defaults feature values used by a forecasting model to forecast demand for the new item. In some embodiments, a forecasting model may use the new item data 2704 to generate demand forecasts for the new item.

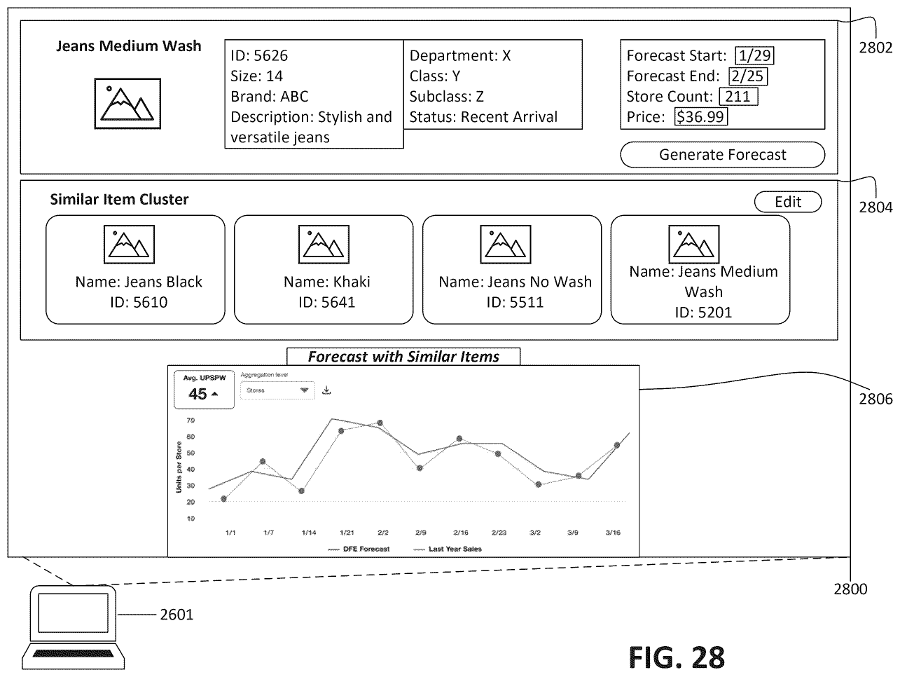

FIG. 28 illustrates an example user interface 2800. The user interface 2800 may be an example of the graphical user interface 248. In some embodiments, the user interface 2800 is an alternative to the user interface 2600, and vice-versa. For example, operations and features described in connection with the user interface 2800 may be implemented in the user interface 2600, and vice-versa.

The user interface 2800 includes forecasting data 2802 for an example item, which in the example shown is “Jeans Medium Wash.” The forecasting data 2802 may display data from the databases 108-112 pertaining to the example item. Additionally, the forecasting data 2802 may include input fields via which the user may input data to generate demand forecasts for the example item. For example, the forecasting data 2802 includes input fields to input a forecast start, a forecast end, a store count, and a price. In the example shown, the example item is a new item, or an item with limited sales history. However, the user interface 2800 and features associated therewith are not limited to new items.

The user interface 2800 further includes a similar item cluster 2804. The similar item cluster 2804 includes a plurality of similar items to the example item. In some embodiments, data of the similar items may be used to forecast demand for the example item, such as by performing similar item forecasting operations described herein, such as in connection with FIG. 18-19. There may be different techniques for determining the plurality of similar items. In some embodiments a user may manually select similar items. In some embodiments, the plurality of similar items may automatically be determined upon selection of the example item in the user interface 2800. For example, the AI system 252 may identify the plurality of items, such as by using operations described above in connection with FIGS. 18-19. In some embodiments, a plurality of candidate similar items may be determined by an AI system, and the user may select the plurality of items from among the plurality of candidate similar items.

The user interface 2800 further includes a demand forecast 2806. The demand forecast is illustrated as a time-series demand forecast for the example item. As shown, the demand forecast includes both forecasted sales for a plurality of time periods and past sales data for the plurality of sales. The demand forecast 2806 includes a demand forecast that is generated based at least in part on data associated with the plurality of similar items displayed in the similar item cluster 2804. For example, a weighted aggregation of demand forecasts for the plurality of items may be used to generate the demand forecast 2806, such as by supplementing a forecast from an item-specific model for the example item from the forecasting models 222, or by replacing an item-specific forecasting model if it has insufficient training data. In some embodiments, the demand forecast 2806 is dynamically updated in response to a user providing an input into the forecasting data 2802 or an input modifying a similar item in the similar item cluster 2804. For example, the demand forecast 2806 may include an initial demand forecast, such as demand forecast using a first set of similar items or first values for features. When the user updates, for example, the plurality of similar items or feature values, the initial demand forecast may be replaced with updated values.

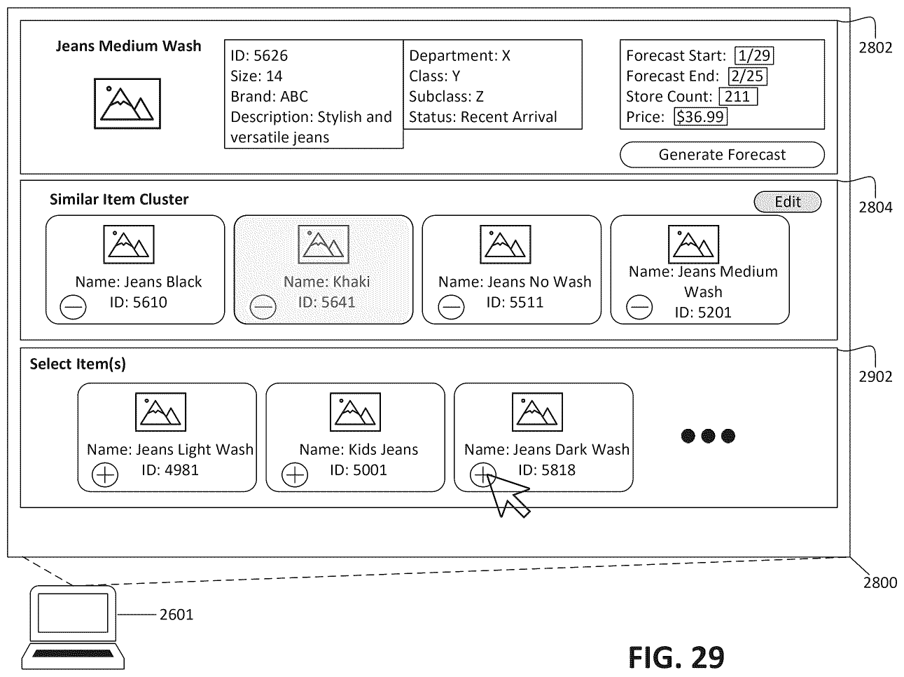

FIG. 29 illustrates a further example of the user interface 2800. According to the example of FIG. 29, the user may edit the plurality of similar items. The user interface 2800 includes a plurality of candidate items 2902. In some embodiments, the AI system 252, or another application, may identify and rank similar items to the example item, in this case “Jeans Medium Wash.” The most similar items, such as the X most similar items to the example item, may be initially included in the similar item cluster 2804, and remaining similar items may be included in the plurality of candidate similar items 2902. Advantageously, this provides a baseline of similar items that may be refined by the user, thereby combining deep learning techniques to identify candidate similar items from across a vast catalog of items with a user's judgment with respect to a final determination of similar items. For example, in the example shown, the user may remove the item “Khaki” from the plurality of items and replace it with the item “Jeans Dark Wash.” After doing so, the forecasting system 102 may regenerate the demand forecast 2806, which may be displayed by the user interface 2800. Additionally, the forecasting system 102 may regenerate the plurality of candidate similar items based at least in part on the user's modification of the plurality of similar items.

In example aspects, forecasting systems disclosed herein may generate batch forecasts. For example, for batch forecasting, the demand forecasting system 102 may use trained models (e.g., the forecasting models 222) and feature data (e.g., prices, promotions, holidays, trend data, etc.) to generate demand forecasts, which can be provided to the forecast consumer 122. In some instances, batch forecasting is performed in an offline environment. For example, batch forecasting may not, in some instances, allow a user to request that the forecasting models 222 generate demand forecasts in real time using inputs provided by the user. Additionally, although a user may be able to edit an output of the batch forecasting, certain users may not, in some instances, be able to modify an input feature value for the forecasting. However, delivering real-time model inferences, such as real time demand forecasts generated by the forecasting models 222, can be a challenge. For example, delivering real-time model inferences presents challenges related to latency, because responses must be generated quickly, and scalability, because there may be many applications requesting demand forecasts, many models to execute, and many models to manage.

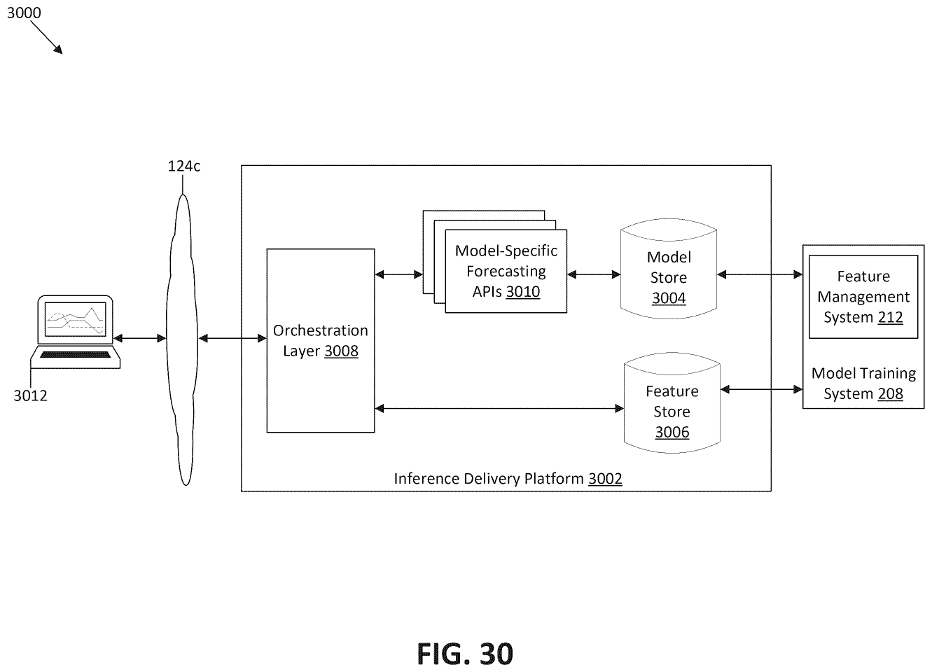

A platform that delivers model inferences in real time is disclosed herein. The platform enables a user to modify feature values of the forecasting models to generate, in real time, demand forecasts that incorporate the modified feature values. In some embodiments, the platform includes a containerized architecture in which a user can generate forecasts without necessarily committing them to supply chain systems or other systems. An example architecture of the inference delivery platform is illustrated in FIG. 30.

In example aspects, the inference delivery platform may include an orchestration layer, model-specific forecasting APIs, forecasting models, and model features. A forecast consumer 122 may interact with the inference delivery platform to generate demand forecasts for hypothetical scenarios. The scenarios may be for different item, location, and time granularities. Additionally, the scenarios may indicate different demand channels, such as an in-store or a digital fulfillment channel. To generate demand forecasts for the scenarios, the forecast consumer 122 may submit a request to the orchestration layer. The request can include a modified feature value, such as a value for a hypothetical price, item elasticity, promo, or other value used by a forecasting model to generate a demand forecast. In some embodiments, the user of the forecast consumer 122 is able to override some model features but not others. For example, the user may be able to override future features, such as a price for an upcoming week, but may not be able to override historical features, such as a trend of how the item has been selling.

In example aspects, the orchestration layer receives the user request and performs various operations. In some embodiments, the orchestration layer can combine the modified feature value with feature values that were not overridden, thereby creating a full set of feature values for a forecasting model to make a forecast. For example, if the user provided a new price for a certain week, but otherwise did not modify prices for other weeks, did not modify holidays or elasticity, and could not modify historical features like trend, then the orchestration layer could combine the existing feature values for all these features with only the new price for the certain week.

In example aspects, the orchestration layer routes the request and feature values to a model-specific forecasting API corresponding with the forecasting model that is to generate the demand forecast. In some embodiments, the inference delivery platform includes a model-specific forecasting API for each model that is made available for real-time inferencing via the inference delivery platform. The model-specific forecasting API may receive the request and may input the received feature values into its corresponding trained forecasting model to generate a demand forecast. The model-specific forecasting API may then return the generated demand forecast to the orchestration layer, which provides it to the forecast consumer.

The inference delivery platform provides various technical advantages. For example, the inference delivery platform improves the technical field of machine learning operations (MLOps) by enabling real-time model inference across different models that may use different feature sets. Moreover, by establishing model-specific forecasting APIs and a common orchestration layer, the architecture of the inference delivery platform is easily extendible to onboard new models.

Additionally, certain previous real-time inference platforms assume that features and models are stored in a common system, whereas the inference delivery platform disclosed herein enables real-time inference even when the trained models and feature data are managed by different systems, thereby extending the availability of real-time model inferencing and thereby providing a technical contribution to the technical field of MLOps. Additionally, the inference delivery platform exposes components of the forecasting system 102, such as the forecasting models 222, to the forecast consumer 122 or other components of the forecasting system 102 in real time. Additionally, the inference delivery platform enables near instantaneous demand forecast generation, allowing a user of the forecast consumer 122 to, in some embodiments, iteratively adjust features that affect demand, view the effect on demand forecasts, readjust features, view updated effects on demand forecasts, and so on—all in real time. Real-time inferencing may also allow for continuous learning and adaptation, where models can be updated or fine-tuned based on fresh data in production without, in some instances requiring batch processing.

Additionally, the inference delivery platform advantageously enables a human-in-the-loop modeling approach in which the user's knowledge, combined with iterative, incremental feature modifications and real-time model inferencing results in a more robust and accurate modeling system that leverages not only the accuracy and knowledge of the forecasting models but also the flexibility and nuance of a human user's knowledge. Additionally, the inference delivery platform enables a human user to modify not only the output of the forecasting models 222 but also an input used to perform inference, and enables the user to commit each of the modified output and input.

Additionally, by enabling real-time model inferencing that incorporates specific feature value modifications, the forecasting models 222 may be made more transparent to human users. For example, if a user modifies a certain feature, such as, for example, a price from a first value to a second value, such a modification may unexpectedly have a disproportionate impact on the result generated by a forecasting model, indicating that the model has been trained to recognize a drop-off point or a steep upswing point at that value for the price feature. As another example, modification of a feature may result in unexpected forecasts with respect to time, such as a feature modification in a first week having an impact on a model result in a different week, indicating that the model has learned time-dependent effects of feature modification. As another example, modification of a combination of features may have unexpected effects, such as, for example, increasing the price and exposure of an item on a website may increase, not decrease, the forecasted demand, indicating that that the forecasting model has learned not only the effects of single feature modification but also effects of different permutations of feature modification. Such model transparency may not, in some instances, be possible without real-time inference delivery, because a user may not be able to see, in real time, the incremental effects of specific modifications. Accordingly, the inference delivery platform enables better understanding of how the forecasting models 222 perform inference and how they were trained, thereby further demonstrating improvements to the technical fields of MLOps, computer model development, and computer model management.

FIG. 30 illustrates an example network environment 3000 in which an inference delivery platform 3002 may be implemented. The environment 3000 includes the inference delivery platform 3002, a computing device 3012, the model training system 208, the feature management system 212, and network 124c.

The inference delivery platform 3002 may include a combination of software and hardware for delivering model inference in real-time to a forecast consumer. The inference delivery platform 3002 and components thereof may be part of the forecasting system 102. For example, the inference delivery platform 3002 may be part of the model deployment system 204. In some embodiments, the inference delivery platform 3002, or one or more components thereof, is hosted in a cloud environment. In the example shown, the inference delivery platform 3002 includes a model store 3004, a feature store 3006, an orchestration layer 3008, and model-specific forecasting APIs 3010.

The model store 3004 may be a data storage system or a database that stores models. In some embodiments, the model store 3004 stores trained models. For example, the model store 3004 may store models trained by the model training system 208, as shown by the example of FIG. 30. For example, the model store 3004 may store the forecasting models 222. In some embodiments, the model store 3004 stores a plurality of forecasting models that are a subset of the forecasting models 222. For example, only a subset of the forecasting models 222 may be made available for real-time inference, and this subset may be stored by the model store 3004.

In some embodiments, a model stored by the model store 3004 may comprise one or more components As examples, a model may comprise a model artifact, which may be generated by the model training system 208 during training. The model artifact may include learned parameters, such as weights or coefficients, that are to be applied during inference with the model. In some embodiments, one or more of these learned parameters may correspond respectively to one or more features of a feature set associated with the model, such that when a value for a given feature is received during inference, the corresponding learned parameter may be applied to the given feature. Additionally, the model artifact may include a scoring logic, configuration files, and other data.

The feature store 3006 may be a data storage system or a database that stores features. In some embodiments, the feature store 3006 stores features of the forecasting models 222. For example, the feature store 3006 may store features of the models stored by the model store 3004. In some embodiments, the feature store 3006 stores sets of features, where each set of features corresponds with a model. For example, for a given model stored in the model store 3004, that model may have been trained on or configured to receive data corresponding to a set of features. That set of features may be store by the feature store 3006, for example. In some embodiments, a feature stored by the feature store 3006 may include the feature (e.g., “price”), a data type of the feature (e.g., “number”), and one or more values for the feature (e.g., “18.10” and “1.02”).

In some instances, feature sets may vary between forecasting models. For example, a forecasting model that forecasts digital demand may include a feature associated with a digital search or display, whereas a forecasting model that forecasts in-store demand may not include such a feature. As another example, a forecasting model for a group of items may include an average item price, whereas a forecasting model for a single item may not. As another example, different forecasting models may have different holiday features. Additional ways in which different forecasting models may be associated with different feature sets are described above in connection with the forecasting models 222.

In some embodiments, the feature store 3006 stores features and associated values The associated values may include one or more of values used to train a model or values to be used during inference with the model, which may be default feature values. With respect to future or present features, the default feature values may be expected or planned values associated with the features. For example, for a price feature, the default values may be planned prices for the forecasted one or more items for upcoming time periods. As another example, the default values may include a planned promotion, a derived elasticity, a holiday, a number or identity of locations at which the one or more items will be sold, or other feature values. With respect to historical features, the default feature values may include historical data, such as past sales, past demand, and the like. In some embodiments, the default feature values may be received from a user, another component of the forecasting system 102, or an external system. In some embodiments, some default features may be synthetically generated. In some instances, some features may have associated values whereas other features may not, and some features may be mandatory for a forecasting model to generate a demand forecast whereas others may be optional.

Example features, and characteristics thereof, are described above in connection with the forecasting models 222, the feature management system 212, and the item data 108. The feature store 3006 may receive feature data from one or more of the model training system 208, such as following training of the forecasting models 222, the feature management system 212, the item data 108, or another system.

In some embodiments, the model store 3004 and the feature store 3006 reside in different data storage platforms. For example, whereas the model store 3004 may be implemented using a first database type or first data management system, the feature store 3006 may be implemented in a second, different database type or a second, different data management system. Advantageously, even though the model store 3004 and the feature store 3006 reside, in some embodiments, in different data storage platforms, the inference delivery platform 3002, using the orchestration layer 3008, may nevertheless manage feature retrieval, modification, and routing to the models in real time, such that real-time inferencing can be performed, despite the disjointed storage of models and features. In some instances, however, the model store 3004 and the feature store 3006 may reside in a common data storage platform.

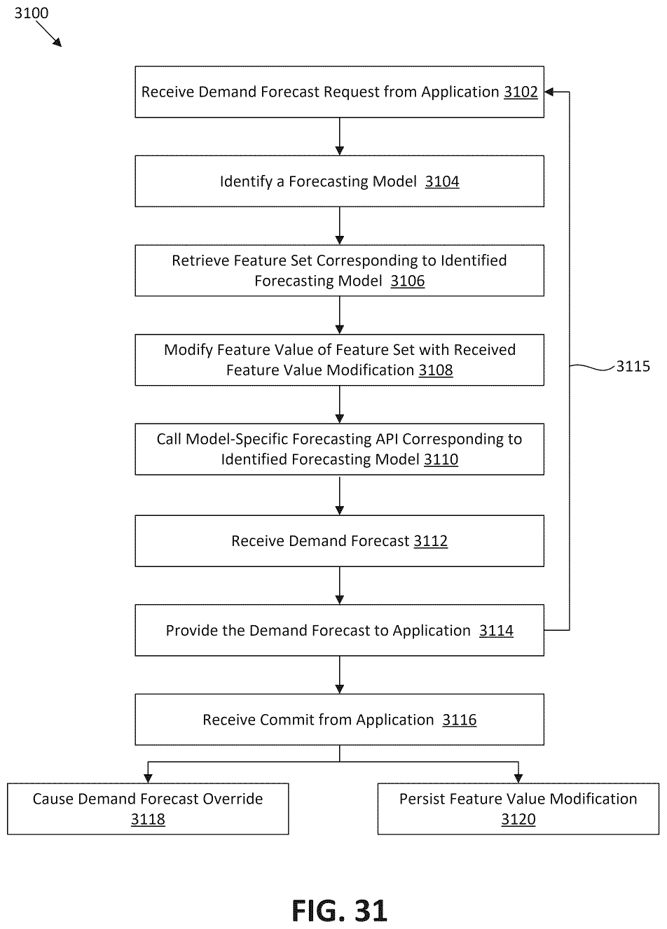

The orchestration layer 3008 may receive requests sent to the inference delivery platform 3002 and respond to such requests. In the example shown, the orchestration layer 3008 is communicatively coupled with the feature store 3006 and the model-specific forecasting APIs 3010. In some embodiments, the orchestration layer 3008 performs network communication, routing, and load balancing tasks for a plurality of incoming requests received from a plurality of different forecast consumers 122. The orchestration layer 3008 may, for example, receive a demand forecast request, orchestrate the routing of feature data and application execution to generate a demand forecast responsive to the request, and output the demand forecast request. In some instances, all incoming requests are processed by the orchestration layer 3008. Example operations of the orchestration layer 3008 are further described below, such as in connection with FIG. 31. In some embodiments, operations described herein as performed by the orchestration layer 3008 may be performed by one of the model-specific forecasting APIs 3010, and vice-versa.

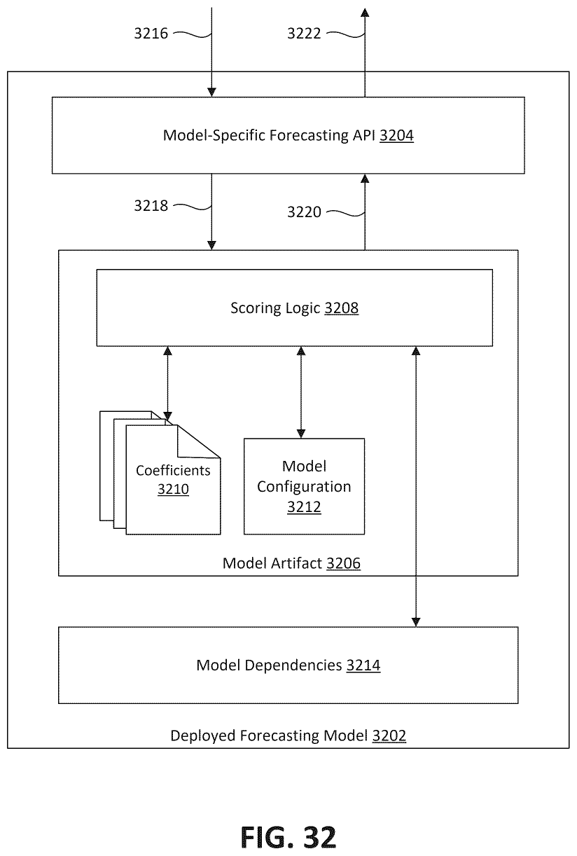

The model-specific forecasting APIs 3010 include a plurality of APIs for accessing forecasting models, such as the forecasting models stored by the model store 3004. In some embodiments, each model-specific forecasting API of the model-specific forecasting APIs 3010 exposes a respective forecasting model of a plurality of forecasting models stored in the model store 3004. In some embodiments, a given model-specific forecasting API is deployed with its corresponding forecasting model. For example, the model-specific forecasting API and the corresponding forecasting model may be deployed in a container. In some embodiments, the orchestration layer 3008 calls a model-specific forecasting API and provides the model-specific forecasting API with feature data for the forecasting model associated with the model-specific forecasting API to generate a demand forecast. Example aspects of the model-specific forecasting APIs 3010 are further described in connection with FIGS. 32-34.

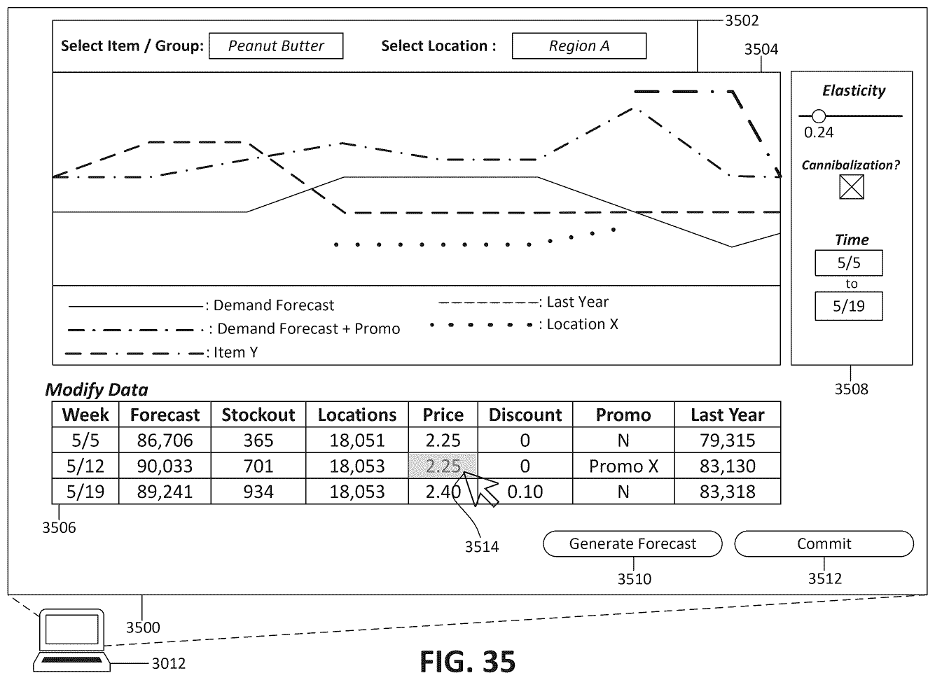

The computing device 3012 is an example of a forecast consumer 122. For example, the computing device 3012 may include an application, example aspects of which are described above in connection with the forecast consumer 122 and with the computing device 2106, that is communicatively coupled with the inference delivery platform 3002. The application may provide a demand forecast request to the inference delivery platform 3002 and may receive, in real time, a demand forecast provided by the inference delivery platform 3002. An example user interface of the computing device 3012 is further described below in connection with FIG. 35.

FIG. 31 is a flowchart of an example method 3100. As described herein, steps of the method 3100 are performed by the orchestration layer 3008 to facilitate real-time generation of a demand forecast in response to a user request. However, one or more steps of the method 3100 may be performed by a different component or combination of components.

In the example shown, the orchestration layer 3008 may receive a demand forecast request from an application (step 3102). For example, the orchestration layer 3008 may receive a demand forecast request from an application of the computing device 3012. The demand forecast request may include data that is used by the inference delivery platform 3002. For example, the demand forecast request may indicate an item or a group of items for which a demand forecast is requested. For example, the item may be a particular item of a catalog, such as “16 Oz. Peanut Butter Brand X.” As another example, the group of items may be “Peanut Butter” or “Spreads.” Additionally, the demand forecast request may include a location or group of locations for the demand forecast request. For example, the location may be “Store ABC”, or the group of locations may be all locations or locations within a geographical region. Further, the demand forecast request may indicate a demand channel, such as a digital demand, an in-store demand, or a ship-from-store demand. Additionally, the demand forecast request may include one or more times for the demand forecast request. The times may be future times, such as one or more future days, weeks, months, and the like. In some embodiments, the demand forecast request may explicitly include an identification of a model to be used to generate a demand forecast, whereas in some instances, the orchestration layer 3008 may infer the model to be used based on data associated with the demand forecast request.

In some embodiments, the demand forecast request includes a feature value modification. In some embodiments, the feature value modification is a value for a feature. For example, the feature value modification may be that a price for the forecasted item or group of items is to be “$6.25” during the week starting August 3. In some embodiments, the feature value modification may include modifications to multiple feature values, such as a price during multiple time periods, or modifications for two different feature values, such as modification of a price and elasticity, or a modification of a price and number of locations.

In some embodiments, the feature value modification is input by a user of the application. In some instances, the input value is an override of a default value for the future. For example, the application may display a demand forecast using, among other things, a first planned price, and the user may modify the first price to a second price and request that the inference delivery platform 3002 generate an updated demand forecast using the second price.

In some embodiments, the feature value modification may be for certain features but not others. For example, as described in connection with the forecasting models 222 and feature management system 212, the forecasting models 222 may include various feature types. Some features may correspond to historical data, such as previous demand or sales data. Other features may correspond to future data, such as a promotion or price during a forthcoming time period for which a demand forecast is requested. In some embodiments, the feature value modification is only permitted for future data, not historical data, thereby ensuring that the user receives accurate and realistic demand forecasts. Accordingly, the inference delivery platform 3002 or the application of the computing device 3012 may provide immutable historical features and mutable future features. In some instances, data corresponding to both an immutable historical feature and a mutable future feature may be displayed by the application, but the application may only include an input field to modify a value of the mutable future feature and may not provide an input field to modify a value of the immutable historical feature. Examples of immutable historical features include past sales, past demand, past trends, past events (e.g., past promotions, stockouts, cultural events, weather events, and the like), and other data corresponding to the past that may be used by the forecasting models 222 to forecast demand. Examples of mutable future features may include, for a forthcoming time period, a regular price, a discount price, a promotion, a display feature, a holiday, an elasticity, a number or identity of locations, an item categorization, or other data corresponding to present or future data that may be used by the forecasting models 222 to forecast demand.

Though described in the example of FIG. 31 as a single request, the orchestration layer 3008 may receive a plurality of demand forecast requests. For example, the orchestration layer 3008 may receive different requests from different forecast consumers 122 and may, in some instances, process such requests in parallel.

In the example shown, the orchestration layer 3008 may identify a forecasting model (step 3104). For example, based on the demand forecast request, the orchestration layer 3008 may identify, from among the plurality of forecasting models of the model store 3004, a forecasting model to generate a demand forecast. For example, as described in connection with the forecasting models 222, there may be different forecasting models trained for demand forecasts for different levels of granularity with respect to one or more of items (e.g., a single item or a group of items), locations (e.g., a single location, a group of location, or all locations), and channel (e.g., digital, in-store, or ship-from-store). Accordingly, the orchestration layer 3008 may identify the forecasting model that matches the demand forecast request.

For example, if the demand forecast request is for “Rocking Chairs” across the full supply chain and all channels, then the orchestration layer 3008 may identify the forecasting model of the forecasting models 222 that is trained to forecast demand for “Rocking Chairs” across the full supply chain and all channels, if that model has been made available for providing real-time demand forecasts. For example, the orchestration layer 3008 may parse data received from the application to identify the data useable to identify the appropriate model. In some embodiments, multiple forecasting models may be identified and used to generate a demand forecast responsive to the demand forecast request. In some instances, the application sending the demand forecast request may identify the forecasting model and provide an identification of the model to the inference delivery platform 3002.

In the example shown, the orchestration layer 3008 may retrieve a feature set corresponding to the identified forecasting model (step 3106). For example, the orchestration layer 3008 may retrieve, from the feature store 3006, the feature set that corresponds to the model identified at the step 3104, which may be the set of features that was used to train the identified forecasting model, or that may be used by the identified forecasting model to generate a demand forecast. In some embodiments, the orchestration layer 3008 retrieves an identification of the features of the feature set. In some embodiments, the orchestration layer 3008 further retrieves feature values of the feature set. For example, the orchestration layer 3008 may retrieve default values for one or more features of the feature set. In some embodiments, not only the selection of the feature set retrieved from the feature store 3006, but also the feature values of the feature sets retrieved from the feature store 3006 may depend on the demand forecast request. For example, if the demand forecast request is for a certain time period, such as a given week or month, then only feature values for that given week or month may be retrieved.

In the example shown, the orchestration layer 3008 may modify a feature value in the retrieved feature set using the demand forecast request (step 3108). For example, the orchestration layer 3008 may modify data of the retrieved feature set using data of the feature value modification in the demand forecast request received at the step 3102. To do so, the orchestration layer 3008 may determine a feature that is associated with the feature value modification. For example, the orchestration layer 3008 may determine that an example modification is a modification of a base price from a first value to a second value during a certain week. Further, the orchestration layer 3008 may override a default feature value for the feature with the feature value modification. As an example, the planned or predicted price of an item may be “$4.50” for the next three weeks, and the feature value modification may include a change of that price to “$2.25” for the first of those weeks. In such an example, the orchestration layer 3008 may change the price for the first of those weeks from “$4.50” to “$2.25.” If there is no default feature value, then there may be no value to override, and the feature value modification may simply be inserted into the feature set. In some instances, the orchestration layer 3008 overrides a plurality of default values corresponding to a plurality of changes in the feature value modification.

In some embodiments, the orchestration layer 3008 does not modify all values of the feature set. For example, if a value is not modified in the feature value modification, then the orchestration layer 3008 may not modify its corresponding default feature value. Additionally, the orchestration layer 3008 may combine the modified feature value with the other default values of the retrieved feature that have not been modified to create a feature set and corresponding values that can be used by the identified forecasting model to generate a demand forecast. For example, the orchestration layer 3008 may combine a price modification for a certain week with the default prices for other weeks, with default promotions, with default elasticity, with values for historical features, and so on, such that a full feature set may be provided to the identified forecasting model, thereby enabling a user to selectively modify certain feature values and receive a real-time demand forecast.

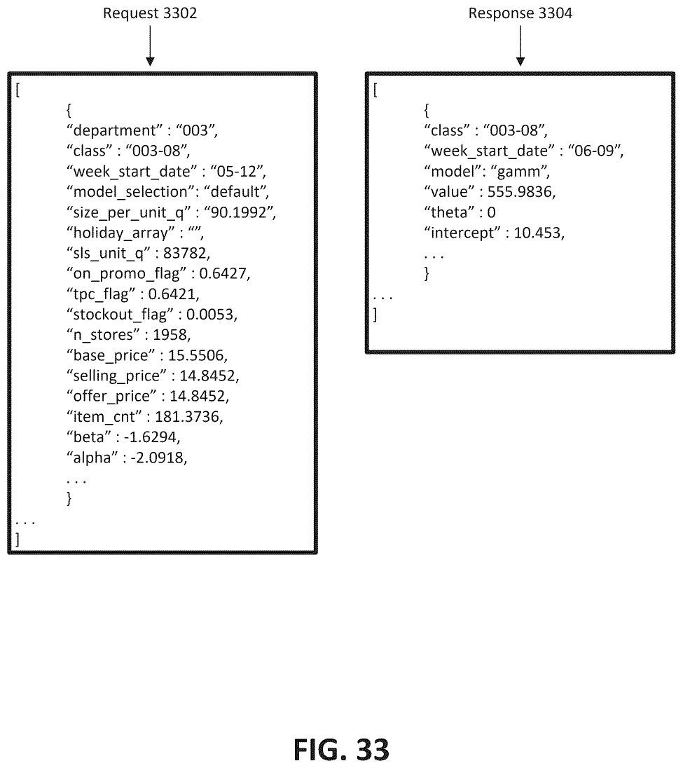

In the example shown, the orchestration layer 3008 may call a model-specific forecasting API corresponding to the forecasting model identified at the step 3104 (step 3110). For example, the orchestration layer 3008 may include a lookup table that maps the forecasting models to their respective model-specific forecasting APIs, and the orchestration layer 3008 may lookup the model-specific forecasting API corresponding to the identified forecasting model. Calling the model-specific forecasting API may include providing a request to generate a demand forecast to the model-specific forecasting API. The request may include the retrieved feature set associated with the identified forecasting model with the modified feature value, as described in connection with the step 3108. Example data of an example of such a request is shown in connection with FIG. 33. After the orchestration layer 3008 calls the model-specific forecasting API, the model-specific forecasting API may facilitate inference of the identified forecasting model to generate a demand forecast, example aspects of which are described in connection with FIG. 32.

In the example shown, the orchestration layer 3008 may receive a demand forecast (step 3112). For example, the response from the model-specific forecasting API may include the demand forecast. The demand forecast may include a forecasted quantity of demand over time, where the time may be determined according to data of the demand forecast request. In some instances, the demand forecast has a future start date that corresponds to a future start date specified in the demand forecast request. Additionally, the demand forecast may include time-series data comprising a forecasted quantity of item demand over time beginning at the future start date of the demand forecast request.

In the example shown, the orchestration layer 3008 may provide the demand forecast to the application (step 3114). For example, the orchestration layer 3008 may provide the demand forecast received from the model-specific forecasting API at the step 3112 to the application that provided the demand forecast request at the step 3102. The application may then display the demand forecast. For example, the application may display the demand forecast via a user interface to a user that input the demand forecast request, an example of which is described in connection with FIG. 35.

As illustrated by the element 3115, the application may submit an additional demand forecast request, and the method 3100 may thereby return to the step 3102. For example, the user may submit a demand forecast request with an additional or different feature value modification than the previous demand forecast request, and then receive a real-time demand forecast orchestrated by the orchestration layer 3008 and generated by one of the forecasting models 222. For instance, if the first demand forecast request modified a price for a given week, then the subsequent demand forecast request may modify a promotion or other feature for that week or a different week, and receive a real-time demand forecast in response. In this way, the inference delivery platform 3002 advantageously enables iterative experimentation with features of the forecasting models 222 to view, in real time, incremental impacts of feature modifications on generated demand forecasts and to create a human-in-the-loop modelling approach.

In the example shown, the orchestration layer 3008 may receive a commit from the application (step 3116). For example, rather than submitting a follow-up demand forecast request (as illustrated by the element 3115), the user of the application may commit the demand forecast provided by the orchestration layer at the step 3114 and submit the committed demand forecast to the inference delivery platform 3002. Committing the demand forecast may also include providing one or more of the feature values that were used to generate the demand forecast to the orchestration layer 3008. For example, the application may provide the feature value modification to the orchestration layer 3008. In response to receiving the commit from the application, the orchestration layer 3008 may, in some embodiments, perform one or more of the step 3118 or the step 3120.

In the example shown, the orchestration layer 3008 may cause a demand forecast override (step 3118). For example, the orchestration layer 3008 may persist the commit of the demand forecast request received by the application to another system. For example, a demand forecast for the item or group of items may have been generated by the identified model during a batch forecast. That demand forecast may, in some instances, be used by one or more of an inventory management or supply chain management system, such as part of determining when and how to allocate or order the one or more items. In response to receiving the commit from the application, the orchestration layer 3008 may provide the demand forecast generated using the modified feature value to the inventory management or supply chain management system to override the demand forecast that was previously generated. In this way, this enables the user to generate demand forecasts in real time using modified feature values and then optionally commit that demand forecast to other systems if the user thinks that the newly generated demand forecast will be more accurate. Such other systems may take automated action in response to receiving the demand forecast request, such as modifying a purchase order or reallocating items.

In the example shown, the inference delivery platform 3002 may persist the feature value modification (step 3120). For example, in response to receiving the commit from the application, the orchestration layer 3008 may provide the feature value modification to another system. For example, the orchestration layer 3008 may provide the modified feature value to one or more of the feature store 3006, the item data 108, the feature management system 212, or another system to store the feature value modification. In some embodiments, the feature value modification may thereby override a default feature value. In some embodiments, the modified feature value may be used to retrain the identified forecasting model.

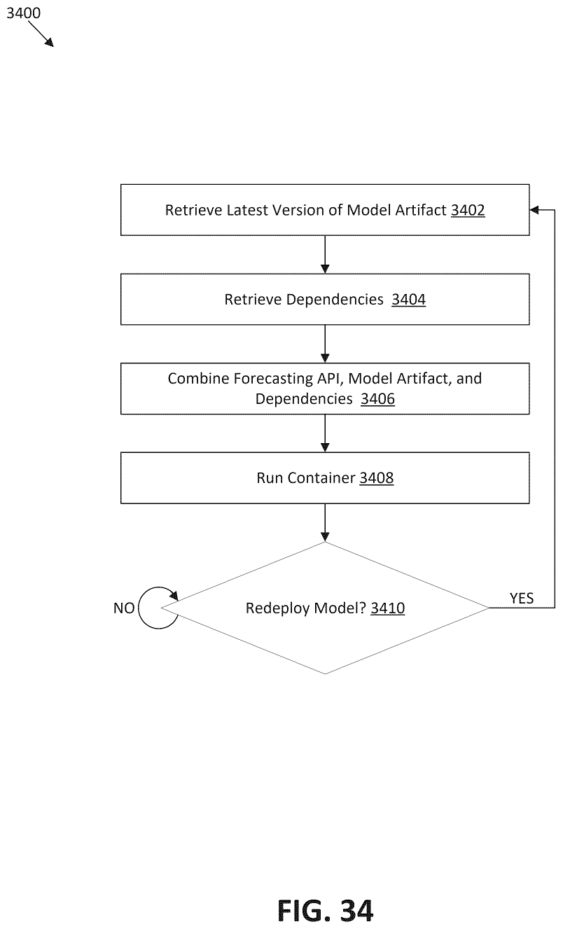

FIG. 32 illustrates a schematic diagram of a deployed forecasting model 3202. In the example shown, the deployed forecasting model 3202 includes a model-specific forecasting API 3204, a model artifact 3206, and model dependencies 3214. Components of the deployed forecasting model 3202 are described above in connection with the model-specific forecasting APIs 3010 and the model store 3004 of FIG. 30. Example operations for deploying the deployed forecasting model 3202 are described in connection with FIG. 34.

The deployed forecasting model 3202 is an example of one of a plurality of forecasting models deployed as part of the inference delivery platform 3002. The deployed forecasting model 3202 may correspond to a particular forecasting model of the forecasting models 222 stored in the model store 3004. In some embodiments, the deployed forecasting model 3202 is deployed in a container. For example, the deployed forecasting model 3202 may include the code, configurations, and other data required to receive a request to generate a demand forecast using its respective forecasting model, generate that demand forecast request, and return a result. The deployed forecasting model 3202 may operate in a sandbox environment, in which operations performed by the deployed forecasting model 3202 and forecasts generated by the deployed forecasting model 3202 may not be persisted or committed to other systems unless the user later commits them, as described, for example in connection with the steps 3116-3120 of FIG. 31.

The model-specific forecasting API 3204 may be one of the plurality of model-specific forecasting APIs 3010 described in connection with FIG. 30.

The model artifact 3206 may correspond to a certain forecasting model of the forecasting models 222 stored by the model store 3004. For example, the model artifact 3206 may include components that make up a trained forecasting model of the forecasting model 222. In some embodiments, the model artifact 3206 is created by the model training system 208 when training a forecasting model.

In the example shown, the model artifact 3206 includes a scoring logic 3208, coefficients 3210, and a model configuration 3212. The scoring logic 3208 may be a program that applies the coefficients, the model configuration 3212, and the model dependencies to a model input, such as a feature set, received during inference. The coefficients 3210 may be learned parameters or weights that were determined when training the forecasting model. In some instances, one or more of the coefficients 3210 correspond to certain features of a feature set associated with the forecasting model. Depending on a feature type, such as whether the feature is a fixed effect, smooth term, or other possible feature of the forecasting model, the coefficients 3210 associated with the feature may vary or the manner in which the coefficients are applied by the scoring logic 3208 may vary. The model configuration 3212 may be a file that describes an architecture of the forecasting model. For example, the model configuration 3212 may include one or more of a list of model features, types of model features, how the model features are applied and combined, and other data that may be used to apply the forecasting model during inference. The scoring logic 3208 may further apply the model dependencies 3214 as part of generating a demand forecast. The model dependencies 3214 may include software packages or other data that is used by the forecasting model to generate demand forecasts.

FIG. 32 further illustrates example operations 3216-3222 that may be performed by the deployed forecasting model 3202.

In the example shown, the model-specific forecasting API 3204 may receive a request to generate a demand forecasting (step 3216). For example, the model-specific forecasting API 3204 may be called by the orchestration layer 3008, as described in connection with the step 3110. The call may include a request to generate a demand forecast and may further include a feature set with the modified feature value for use by the forecasting model to generate a demand forecast. Example data of an example of such a request is illustrated in connection with FIG. 33.

In the example shown, the model-specific forecasting API 3204 may apply the model artifact 3206 to generate a demand forecast (step 3218). For example, the model-specific forecasting API 3204 may provide the feature values received from the orchestration layer 3008 to the scoring logic 3208 or another interface component of the model artifact 3206, such that the trained model may perform inference on the received feature values to generate a demand forecast in real time.

In the example shown, the model-specific forecasting API 3204 may receive, from the model artifact 3206, the generated demand forecast (step 3220). The generated demand forecast may include, for example, time-series data with forecasted demand over time.

In the example shown, the model-specific forecasting API 3204 may output a response (step 3222). For example, the model-specific forecasting API 3204 may output a response to the orchestration layer 3008. The response may include the demand forecast generated by the model artifact 3206. Example data of an example of such a response is illustrated in connection with FIG. 33.

FIG. 33 illustrates example data of an example request 3302 and response 3304. The request 3302 illustrates example data that may be received by the model-specific forecasting API 3204 from the orchestration layer 3008. Additionally, the request 3302 illustrates example data that may be received by the orchestration layer 3008 from an application that requests a demand forecast. The request 3302 includes example features and associated feature values that may be used by the forecast model to generate a demand forecast. One or more of the feature values of the request 3302 may be a modified feature value that was input by a user of an application calling the inference delivery platform 3002. For example, one or more of the values for size per unit, holiday array, promo flag, stockout flag, number of stores, base price, selling price, offer price, or item count may have been modified by and input by a user requesting a real-time demand forecast. The request 3302 may include more or less data, such as more features and associated values, than illustrated in the example of FIG. 33.

The response 3304 illustrates example data that may be output by the model-specific forecasting API 3204 to the orchestration layer 3008. Additionally, the response 3304 illustrates example data that may be output by the orchestration layer 3008 to the application that requested a demand forecast. The response includes, for example, a value that corresponds to a demand forecast generated by the forecasting model, which in the example shown, is 555.9836 for the week starting on June 9th. The response 3304 may include more or less data than illustrated in the example of FIG. 33.

FIG. 34 is a flowchart of an example method 3400 for deploying a forecasting model. For example, aspects of the method 3400 may be used to deploy the deployed forecasting model 3202 described in connection with FIG. 32. In some embodiments, the method 3400 may be performed by a deployment pipeline or service of the inference delivery platform 3002. Although the method 3400 is described as being performed to deploy a single forecasting model of the forecasting models 222, it may be applied to deploy a plurality of forecasting models as part of the inference delivery platform 3002.

In the example shown, the latest version of the model artifact for the forecasting model may be retrieved (step 3402). For example, when the model training system 208 trains the forecasting model, a model artifact may be generated and subsequently stored in the data storage system. For example, the model artifact may be stored in the model store 3004. When the model training system 208 retrains the forecasting model, an updated model artifact may be generated and likewise stored. Accordingly, the model artifact for the forecasting model may be periodically updated, and the most recent version of the model artifact may be retrieved for model deployment.

In the example shown, model dependencies may be retrieved. For example, the latest versions of the model dependencies 3214 may be retrieved (step 3404). This may include fetching software packages and configurations to be used by the forecasting model during inference.

In the example shown, code for the model-specific forecasting API, the retrieved model artifact, and the retrieved dependencies may be combined (step 3406). Combing these components may comprise, in some embodiments, creating a template of a container that is to include these components. In some embodiments, combining the model-specific forecasting API, the model artifact, and the dependencies comprises building a Docker image.

In the example shown, a container comprising the model-specific forecasting API, the model artifact, and the dependencies may be run (step 3408). As a result, the forecasting model may be deployed and responsive to requests from, for example, the orchestration layer 3008.

In the example shown, it may be determined whether to redeploy the model (step 3410). In response to determining to redeploy the model (e.g., taking the “YES” branch), the method 3400 may return to the step 3402. In response to determining not to redeploy the model (e.g., taking the “NO” branch), the method 3400 may not return to the step 3402 and may determine again at a later time whether to redeploy the model. In some embodiments, it is determined to redeploy the model based on training of the model. For example, it may be determined to redeploy the model when the model training system retrains the model and creates an updated model artifact. As another example, it may be determined to periodically redeploy the forecasting model on a schedule basis, such as, for example, every week or month.

In some embodiments, the determination of whether and when to deploy the forecasting model is made independently of any request received by the inference delivery platform 3002. For example, in some embodiments, rather than, in response to receiving a demand forecast request, retrieving the latest version of the trained model from a model store, the inference delivery platform 3002 may have already deployed the model. In some instances, this may result in the latest version of the forecasting model not being used to generate the demand forecast. However, because the latest version of the model need not be retrieved, the inference delivery platform 3002 may generate and provide faster real time forecasts in response to user requests, and the availability of the inference delivery platform 3002 may not depend on the availability of an updated model artifact.

FIG. 35 illustrates an example user interface 3500 displayed by the computing device 3012. The user interface 3500 may be part of an application that is communicatively coupled with the inference delivery platform 3002. Via the user interface 3500, a user may provide data to the inference delivery platform 3002, such as a demand forecast request with a feature value medication, and via the user interface 3500, data provided by the inference delivery platform 3002 may be displayed, such as real-time demand forecasts. Other examples of user interfaces that may be similarity communicatively coupled with the inference delivery platform 3002 for providing demand forecast requests and receiving real time demand forecasts include, in some embodiments, the user interfaces illustrated in FIGS. 24 and 26-29. Additionally, the user interface 3500 may include one or more of the features described in connection with the FIGS. 24 and 26-29. In the example shown, the user interface 3500 includes an input field 3502, a display field 3504, data 3506, options 3508, a generate forecast button 3510, and a commit button 3512.

Via the input field 3502, the user may select one or more of the following: an item or group of items for which a demand forecast is to be generated; a location or group of locations at which the item or group of items a demand forecast is to be generated; and a channel for a demand forecast. In some embodiments, the orchestration layer 3008 may identify the forecasting model for generating the demand forecast based on data input via the input field 3502, as described in connection with the step 3104 of FIG. 31.

Via the display field 3504, the user interface 3500 may display data received from the inference delivery platform 3002. For example, the display field 3504 may display a graph with item quantity on the y-axis and time on the x-axis that shows demand forecasts for an item over time. For example, the display field 3504 may display a real-time demand forecast received from the inference delivery platform 3002. Additionally, as shown by the example of FIG. 35, the display field 3504 may display different variants of the demand forecast, such as at a certain location or with certain input features, or a demand forecast of a complementary or substitute item. The display field 3504 may also show actual historical sales.

The data 3506 may include data used to generate demand forecasts. For example, the data 3506 may display features and associated feature values used by the forecasting model to generate the demand forecast. For example, in the example shown, the data 3506 illustrates 3 upcoming weeks and some default values for features for those 3 upcoming weeks, such as a planned price, discount, promotion, and other features. The data 3506 may further illustrate a tabular view of the demand forecast values received from the inference delivery platform 3002. Additionally, the data 3506 may also display other data that is derived by or retrieved from the forecasting system 102, such as historical sales and stockouts. As described below in connection with the element 3514, some values of the data 3506 may be modifiable whereas others may not be.

The options 3508 may include modifiable parameters that may be used by the forecasting system 102 when generating a demand forecast. Some of the parameters may correspond to features of one or more of the forecasting models 222. In the example shown, the options 3508 include an elasticity value, which may be selected to be a value between 0 and 1 and which may be implemented, for example, as a slider. In the example shown, the options 3508 further include a flag of whether to consider item cannibalization and a time period for a demand forecast.

The generate forecast button 3510 may be selected by a user to transmit a demand forecast request to the inference delivery platform 3002, example aspects of which are described in connection with the step 3102 of FIG. 31. For example, when selected, the application may transmit portions of the data received via the input field 3502, the data 3506, or the options 3508 to the inference delivery platform 3002. For example, the application may transmit a modified feature value that includes a modification made to the data 3506 or the options 3508. In response to selecting the generate demand forecast button 3510, the application may receive a demand forecast from the inference delivery platform 3002, and the demand forecast may automatically be displayed in the display field 3504. The commit button 3512 may be selected by a user to transmit a commit of a demand forecast to the inference delivery platform 3002, example aspects of which are described in connection with the step 3120 of FIG. 31. In some embodiments, when the commit button 3512 is selected, this may cause the demand forecasts in the data 3506 and other values in data 3506 to be committed to the forecasting system 102.

The element 3514 illustrates an example of modifying a feature value. For example, the user may, in the data 3506, modify a price for an upcoming time period, such as by changing the price from “2.25” to a different value. When the generate forecast button 3510 is selected, the modification will be captured and provided to the inference delivery platform 3002. Some of the data in the data 3506 may include an input field for modifying the values, but some of the data 3506 may be immutable. In some embodiments, values of future features may be modified while values of historical features may not be modified. For example, the user interface 3500 may include input fields for modifying, in the example of FIG. 35, the locations, price, discount, and promo values, but the user interface 3500 may not include input fields to modify the data corresponding to previous sales.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A real-time inference delivery platform, the platform comprising:
a model store comprising a plurality of forecasting models;
a feature store comprising a plurality of features, the plurality of features including a plurality of feature sets, wherein each forecasting model of the plurality of forecasting models is trained using a respective feature set of the plurality of features sets;
a plurality of model-specific forecasting application programming interfaces (APIs), wherein each model-specific forecasting API of the plurality of model-specific forecasting APIs exposes a respective forecasting model of the plurality of forecasting models;
an orchestration layer communicatively coupled with the feature store and the plurality of model-specific forecasting APIs, wherein the orchestration layer is configured to:
receive a demand forecast request from an application, the demand forecast request comprising a feature value modification;
based on the demand forecast request, identify a forecasting model from the plurality of forecasting models;
from the feature store, retrieve a feature set corresponding to the identified forecasting model;
modify a feature value in the retrieved feature set using the feature value modification of the demand forecast request; and
call a model-specific forecasting API corresponding to the identified forecasting model using the retrieved feature set with the modified feature value.

2. The real-time inference delivery platform of claim 1,
wherein retrieving, from the feature store, the feature set corresponding to the identified forecasting model comprises retrieving default feature values for the retrieved feature set;
wherein modifying the feature value in the retrieved feature set comprises:
determining a feature associated with the feature value modification; and
overriding a default feature value of the feature with the feature value modification without modifying other default values of the retrieved default feature values; and
wherein calling the model-specific forecasting API comprises providing the feature value modification and the other default feature values to the model-specific forecasting API.

3. The real-time inference delivery platform of claim 1,
wherein the identified forecasting model comprises a model artifact comprising a plurality of learned coefficients associated with the feature set corresponding to the identified forecasting model; and
wherein the model-specific forecasting API is configured to:
receive a request from the orchestration layer comprising the retrieved feature set with the modified feature value;
apply the model artifact to the retrieved feature set with the modified feature value to generate a demand forecast; and
output the demand forecast to the orchestration layer.

4. The real-time inference delivery platform of claim 1,
wherein the identified forecasting model is deployed in a container accessible via the model-specific forecasting API corresponding to the identified forecasting model;
wherein deploying the identified forecasting model occurs independently from receiving the demand forecast request from the application; and
wherein deploying the identified forecasting model comprises retrieving a latest version of a model artifact of the identified forecasting model, wherein the model artifact is periodically updated when the identified forecasting model is retrained.

5. The real-time inference delivery platform of claim 1,
wherein the feature set corresponding to the identified forecasting model comprises a mutable future feature and an immutable historical feature;
wherein a user interface of the application includes an input field to modify a value of the mutable future feature; and
wherein the user interface of the application does not provide an input field to modify a value of the immutable historical feature.

6. The real-time inference delivery platform of claim 5, wherein the immutable historical feature is past sales and wherein the mutable future feature is price.

7. The real-time inference delivery platform of claim 1, wherein the orchestration layer is further configured to:
receive, from the model-specific forecasting API, a demand forecast generated by the identified forecasting model using the retrieved feature set with the modified feature value; and
provide the demand forecast to the application.

8. The real-time inference delivery platform of claim 7, wherein the orchestration layer is further configured to:
receive a commit of the demand forecast from the application; and
in response to receiving the commit of the demand forecast, provide the demand forecast to an inventory management system to adjust a purchase order or an item allocation based on the demand forecast.

9. The real-time inference delivery platform of claim 7,
wherein the demand forecast request includes a future start date; and
wherein the demand forecast is time-series data comprising a forecasted quantity of item demand over time beginning at the future start date of the demand forecast request.

10. The real-time inference delivery platform of claim 1, wherein the feature store resides in a first data storage platform and the model store resides in a second data storage platform different from the first data storage platform.

11. The real-time inference delivery platform of claim 1, wherein the feature value modification comprises a modification of a location.

12. The real-time inference delivery platform of claim 1, wherein the orchestration layer is configured to:
receive the demand forecast request from the application in real time;
call the model-specific forecasting API corresponding to the identified forecasting model in real time;
receive, from the model-specific forecasting API corresponding to the identified forecasting model, a demand forecast generated by the identified forecasting model in real time; and
output the demand forecast to the application in real time.

13. The real-time inference delivery platform of claim 1, wherein the feature value modification comprises a modified price and a modified date.

14. The real-time inference delivery platform of claim 1,
wherein the identified forecasting model is trained to forecast demand for a specific group of items; and
wherein a second forecasting model of the plurality of forecasting models is trained to forecast demand for a different group of items.

15. The real-time inference delivery platform of claim 1, wherein the identified forecasting model forecasts demand for a specific item of a catalog of items.

16. The real-time inference delivery platform of claim 1, wherein the identified forecasting model is trained to forecast only digital demand.

17. A method for facilitating real-time inference delivery, the method comprising:
receiving a demand forecast request from an application, the demand forecast request comprising a feature value modification;
based on the demand forecast request, identifying a forecasting model from a plurality of forecasting models;
retrieving, from a feature store, a feature set corresponding to the identified forecasting model, wherein the feature store comprises a plurality of features, the plurality of features including a plurality of feature sets, wherein each forecasting model of the plurality of forecasting models is trained using a respective feature set of the plurality of features sets;
modifying a feature value in the retrieved feature set using the feature value modification of the demand forecast request;
selecting a model-specific forecasting API from a plurality of model-specific forecasting APIs, wherein the model-specific forecasting API is communicatively coupled with the identified forecasting model; and
calling the model-specific forecasting API using the retrieved feature set with the modified feature value.

18. The method of claim 17,
wherein the identified forecasting model is a generalized additive mixed model comprising a smooth term and a fixed effect;
wherein the feature set corresponding to the identified forecasting model comprises a price feature or an elasticity feature; and
wherein the feature value modification is a modification of a price value for the price feature or an elasticity value for the elasticity feature.

19. An inference delivery platform, the inference delivery platform comprising:
a processor; and
memory storing instructions that, when executed by the processor, cause the inference delivery platform to:
receive a demand forecast request comprising a feature value modification;
based on the demand forecast request, identify a forecasting model from a plurality of forecasting models;
retrieve, from a feature store, a feature set corresponding to the identified forecasting model, wherein the feature store comprises a plurality of features, the plurality of features including a plurality of feature sets, wherein each forecasting model of the plurality of forecasting models is configured to receive values for a respective feature set of the plurality of features sets;
modify a feature value in the retrieved feature set using the feature value modification of the demand forecast request;
select a model-specific forecasting API that exposes the identified forecasting model; and
calling the model-specific forecasting API using the retrieved feature set with the modified feature value.

20. The inference delivery platform of claim 19,
wherein retrieving, from the feature store, the feature set corresponding to the identified forecasting model comprises retrieving default feature values for the retrieved feature set;
wherein modifying the feature value in the retrieved feature set comprises:
determining a feature associated with the feature value modification; and
overriding a default feature value of the feature with the feature value modification without modifying other default values of the retrieved default feature values;
wherein calling the model-specific forecasting API comprises providing the feature value modification and the other default feature values to the model-specific forecasting API;
wherein the identified forecasting model comprises a model artifact comprising a plurality of learned coefficients associated with the feature set corresponding to the identified forecasting model; and
wherein the model-specific forecasting API is configured to:
receive a request comprising the retrieved feature set with the modified feature value; and
apply the model artifact to the retrieved feature set with the modified feature value to generate a demand forecast.
